(19) United States
(12) Patent Application Publication
(10) Pub. No.: US 2016/0164748 A1
(43) Pub. Date: Jun. 9, 2016

(54) IDENTIFYING AND RESOLVING NETWORK DEVICE RULE CONFLICTS AND RECURSIVE OPERATIONS AT A NETWORK DEVICE

(71) Applicant: Belkin International, Inc., Playa Vista, CA (US)

(72) Inventor: Ryan Yong Kim, Rolling Hills Estates, CA (US)

(73) Assignee: Belkin International, Inc., Playa Vista, CA (US)

(21) Appl. No.: 14/959,220

(22) Filed: Dec. 4, 2015

Related U.S. Application Data
(60) Provisional application No. 62/087,697, filed on Dec. 4, 2014.
(60) Provisional application No. 62/088,229, filed on Dec. 5, 2014.

(51) Int. Cl. H04L 12/24; G06N 5/04

(52) U.S. Cl. CPC H04L 41/16; G06N 5/046

(57) ABSTRACT

Techniques for identifying and resolving network device rules conflicts and recursive operations are provided. In some embodiments, a method may include receiving an existing rule corresponding to the operation of a network device. Input corresponding to a new rule corresponding to operation of the network device may be detected. In some embodiments, the existing rule and the new rule may be analyzed, wherein the analysis includes determining that a conflict exists between the existing rule and the new rule and/or determining that the new rule and the existing rule are associated with a recursive operation of the network device. In some embodiments, the operations are analyzed, wherein the analysis identifies that the operations of the network device include a recursive operation. An indication of the conflict between the existing rule and the new rule, or an indication of the recursive operation, may be provided.

### CROSS-REFERENCE TO RELATED APPLICATIONS

This application claims the benefit of and priority to U.S. Provisional Application No. 62/087,697, filed Dec. 4, 2014, and U.S. Provisional Application No. 62/088,229, filed Dec. 5, 2014. These applications are hereby incorporated by reference in their entireties for all purposes.

### FIELD

The present disclosure generally relates to network devices, wireless control over electrical devices and sensors and to wireless communication between network devices. Specifically, various techniques and systems are provided for identifying and resolving network device rule conflicts and recursive operations and for notifying users of events or conditions.

### BACKGROUND

Residences, offices, and other locations may have electronic devices (e.g., lamps, fans, heaters, televisions, motion sensors, and the like). Some electronic devices may be controlled by network devices (e.g., outlets, switches, and the like) within a network environment. For example, an automation network may allow a user to provide rules to schedule or otherwise automate functionalities of network devices connected to the network. For example, a network device such as an outlet may be assigned a rule that causes an electrically connected lamp to be powered on daily at 8 PM to provide light to a living room. However, when network devices can be assigned more than one rule, rule conflicts and/or recursive operations may arise. For example, although the first rule instructs the outlet to turn the lamp on at 8 PM, a second conflicting rule may instruct the outlet to turn the lamp off at 8 PM. In another example, the first rule instructs the outlet to turn the lamp on at 8 PM and may include one or more criteria that activate a second rule. The second rule may instruct the outlet to turn the lamp off at 8 PM and may further include one or more criteria that cause the first rule to be activated again, causing a recursive operation (e.g., a loop). The network device may be unable to identify, let alone resolve, such a conflict or recursive operation.

In addition, systems and tools are available for generating notifications when events or conditions occur. For example, the If This Then That (IFTTT) service allows users to generate a “recipe” that results in a user defined action occurring upon detection of a user specified triggering event. These user generated recipes provide, for example, for a wide variety of events to trigger a wide range of actions. The available triggers range from network-based services, such as email, RSS, etc., to hardware-based sensors, such as smartphone GPS sensors, motion sensors, temperature sensors, etc., to schedule- or time-based triggers. The available actions also range from network-based actions, such as sending emails or text messages, uploading a file or photo to a cloud storage service, creating a calendar entry, etc., to hardware-based actions, such as changing a power state on a network connected power switch or light bulb, adjusting a temperature setting on network connected thermostat, dialing a phone number or sending a text message with a smartphone, etc.

The variety of triggers also enables the generation of notifications, such as a notification on a smartphone or sending of an email or text message alert. The triggers that can be utilized by IFTTT and similar systems are currently limited, however, to devices and services which interface with the systems. If conflicting rules are triggered recursively, this may result in a cascade of notifications and/or actions.

### SUMMARY

Techniques, systems and devices are described for identifying and resolving network device rule conflicts and recursive operations. Also described are devices, systems and methods for informing users of the occurrence of events or conditions. Sensors are optionally used to determine the occurrence of an event or condition and a notification is transmitted to an access device, for example, to provide information about the event or to request a response to the occurrence of the event. The systems and methods may include a promotion scheme for identifying a single device for transmitting a notification to be displayed on an access device in order to minimize repeated sending of notifications relating to a single event and to enable prompt delivery.

In some embodiments, a computer-implemented method may be provided. The method may include receiving, by a computing device, an existing rule corresponding to operation of a network device. Input may be detected. The input may correspond to a new rule corresponding to operation of the network device. The existing rule and the new rule may be analyzed, including determining that a conflict exists between the existing rule and the new rule. An indication of the conflict between the existing rule and the new rule may be provided.

In some embodiments, a system may be provided. The system may include one or more data processors and a non-transitory computer readable storage medium containing instructions that, when executed on the one or more data processors, cause the one or more processors to perform operations including receiving an existing rule corresponding to operation of a network device. Input may be detected. The input may correspond to a new rule corresponding to operation of the network device. The existing rule and the new rule may be analyzed, including determining that a conflict exists between the existing rule and the new rule. An indication of the conflict between the existing rule and the new rule may be provided.

In some embodiments, a computer-program product tangibly embodied in a non-transitory machine-readable storage medium may be provided. The computer-program product may include instructions configured to cause a data processing apparatus to receive an existing rule corresponding to operation of a network device. Input may be detected. The input may correspond to a new rule corresponding to operation of the network device. The existing rule and the new rule may be analyzed, including determining that a conflict exists between the existing rule and the new rule. An indication of the conflict between the existing rule and the new rule may be provided.

In some embodiments, a computer-implemented method may be provided. The method may include receiving, by a computing device, an existing rule corresponding to operation of a network device. Input may be detected. The input may correspond to a new rule corresponding to operation of the network device. The existing rule and the new rule may be analyzed, including determining that the new rule and the existing rule are associated with a recursive operation of the network device. An indication of the recursive operation may be provided.

In some embodiments, a system may be provided. The system may include one or more data processors and a non-transitory computer readable storage medium containing instructions that, when executed on the one or more data processors, cause the one or more processors to perform operations including receiving an existing rule corresponding to operation of a network device. Input may be detected. The input may correspond to a new rule corresponding to operation of the network device. The existing rule and the new rule may be analyzed, including determining that the new rule and the existing rule are associated with a recursive operation of the network device. An indication of the recursive operation may be provided.

In some embodiments, a computer-program product tangibly embodied in a non-transitory machine-readable storage medium may be provided. The computer-program product may include instructions configured to cause a data processing apparatus to receive an existing rule corresponding to operation of a network device. Input may be detected. The input may correspond to a new rule corresponding to operation of the network device. The existing rule and the new rule may be analyzed, including determining that the new rule and the existing rule are associated with a recursive operation of the network device. An indication of the recursive operation may be provided.

In some embodiments, a computer-implemented method may be provided. The method may include receiving, by a computing device, multiple rules corresponding to operations of a network device. Operations of the network device in accordance with the multiple rules may be detected. The operations of the network device may be analyzed, including identifying that the operations of the network device include a recursive operation. An indication of the recursive operation may be provided.

In some embodiments, a system may be provided. The system may include one or more data processors and a non-transitory computer readable storage medium containing instructions that, when executed on the one or more data processors, cause the one or more processors to perform operations including receiving multiple rules corresponding to operations of a network device. Operations of the network device in accordance with the multiple rules may be detected. The operations of the network device may be analyzed, including identifying that the operations of the network device include a recursive operation. An indication of the recursive operation may be provided.

In some embodiments, a computer-program product tangibly embodied in a non-transitory machine-readable storage medium may be provided. The computer-program product may include instructions configured to cause a data processing apparatus to receive multiple rules corresponding to operations of a network device. Operations of the network device in accordance with the multiple rules may be detected. The operations of the network device may be analyzed, including identifying that the operations of the network device include a recursive operation. An indication of the recursive operation may be provided.

In some embodiments, the methods and systems described herein are useful for generating notifications for virtually any event that can be detected or that generates, in some way, a detectable signal. These events vary from events that are detectable by physical sensors, such as motion sensors, light sensors, sound sensors, temperature sensors, electrical sensors, position sensors, flow sensors, pressure sensors, proximity sensors or touch sensors, to virtual events, such as receipt of an email, changing of a digital file or changing of a bank account balance, to other events, such as switching of a light switch, receipt of a telephone call or sending of a text message.

In one aspect, methods are provided, such as computer implemented methods that are performed by a computing device, for example a computing device on a network. A specific method of this aspect comprises receiving, such as at a computing device on a network, a detection signal indicating detection of an event, transmitting a communication relating to the event within the network, generating a query for ascertaining whether the computing device is selected for transmitting a notification of the event, determining that the computing device is selected for transmitting the notification of the event and transmitting the notification of the event. Optionally, for some embodiments, the detection signal indicating detection of the event is the notification of the event.

Methods of this aspect are useful for transmitting notifications both within a network and outside of a network. In this way, notifications can be received at a device, such as an access device like a smartphone, that is not present on a local network at which the event is detected, but is otherwise connected to and reachable via a cloud network, like the Internet. This allows uses who are away from their home or work network to receive notifications about events that are detected by devices on their home or work network.

In an exemplary embodiment, another method of the above aspect comprises receiving, such as at a computing device on a network, a detection signal indicating detection of an event, transmitting a communication relating to the event within the network, generating a query for ascertaining whether the computing device is selected for transmitting a notification of the event, determining that an alternate device is selected for transmitting the notification of the event, and transmitting a signal within the network indicating the alternate device is selected for transmitting the notification of the event. Optionally, this method further comprises receiving the notification of the event. Optionally, determining that an alternate device is selected for transmitting the notification of the event includes determining that the computing device is not selected for transmitting the notification of the event.

In a specific embodiment, the detection signal indicating detection of an event is generated by a sensor, such as a sensor that is a component of a computing device. As described above, virtually any sensor which generates a detectable signal is useful for generating the signal indicating detection of the event. For example, useful sensors include, but are not limited to an electromagnetic sensor, an optical sensor, a sound sensor, a temperature sensor, a position sensor, a level sensor, a motion sensor, a feed sensor, a distance sensor, a proximity sensor, a rotation sensor, an accelerometer, a force sensor, a torque sensor, a velocity sensor, a vibration sensor, a time sensor, a voltage sensor, a current sensor, a power sensor, a capacitance sensor, a resistance sensor, a chemical sensor, a mass sensor, a pressure sensor, a touch sensor, a particle sensor, a smoke detector, a hygrometer, a magnetic sensor, a rain sensor, a flow sensor, any multiples of these and any combinations of these. In addition, detectable signals can be generated by a computing device, such as in response to changes in a digital data set.

In embodiments, the query for ascertaining whether the computing device is selected for transmitting a notification of the event includes a request for device metrics for one or more devices on the network, such as to allow for comparing of the device metrics to determine which device to select for transmitting the notification of the event. Optionally one or more devices on the network can request to transmit the notification of the event or request not to transmit the notification of the event. For example, in a specific embodiment, the query includes a request for selection of a computing device for transmission of the notification of the event. In one embodiment, a method of this aspect further comprises receiving a response to the query indicating that the computing device is selected for transmitting the notification of the event. In another embodiment, a method of this aspect further comprises receiving a response to the query indicating that an alternate device on the network is selected for transmitting the notification of the event. Optionally, determining that a device is selected for transmitting the notification of the event includes receiving the device metrics and comparing the device metrics to determine which device to select for transmitting the notification of the event.

In an exemplary embodiment, device metrics are compared to determine which device is appropriate, available or to be selected for transmitting the notification of the event. A variety of device metrics are useful for determination of which device is best suited for transmitting a notification of the event, including, but not limited to, a wireless network signal strength, a processor load, a device uptime, a time and date stamp for sensing of the event, a confidence level for the event, a susceptibility to the event, a power state, a battery state, a network connection speed, a network connection type, a number of network connections, a random number, a sensor signal level, a sensor noise level, a sensor type, a notification type, a device reach level, an event reach level, a user defined variable, a device identifier, a device location and any combination of these. Nearly any parameters can be used for determination of which device to select for transmitting a notification of the event. In a specific embodiment, a random number is assigned to each device on the network and the device with the highest random number is selected to transmit the notification of the event.

Optionally, the device metrics are intelligently evaluated to determine which device to select for transmitting the notification of the event. For example, a device that has an idle processor may be more preferred for transmitting a notification than a device that has a processor with a high load. Similarly, a device that has available network bandwidth may be more preferred for transmitting a notification than a device that has little available bandwidth. Optionally, it may be desirable to have the first device that detects an event transmit a notification of the event. In one embodiment, a device that is more susceptible to an event, such as a device that is in closer proximity to a destructive event, like a fire, is less desirable for transmitting a notification of the event than a device that is less susceptible to the event. In some embodiments, a device that includes a battery power supply may be more preferable for transmitting a notification of an event than a device that is solely powered by AC power from a power outlet. Optionally, devices that include redundant network connections are preferred for transmitting the notification of an event, as such as configuration can provide a failsafe mechanism in the event that one connection fails.

As described above, methods of this aspect optionally provide for minimizing the repeating of transmitting notifications. In order to achieve this, some embodiments of the methods and systems described herein use communications between devices on a network to notify each other of the detection of events, to notify each other of receipt of signals and notifications, to notify each other of acknowledgments to notifications, and to notify each other of queries and responses to queries that are received. In a specific embodiment, a method of this aspect comprises transmitting a communication relating to a detected event within the network. In one embodiment, the communication relating to the event includes the detection signal. In one embodiment, the communication relating to the event includes an acknowledgment signal indicating receipt of the detection signal.

Methods and systems described herein optionally allow for the retransmission of notifications, such as notifications that may not have been received, to ensure that all events that are detected are properly handled. In one embodiment, a method of this aspect further comprises determining that the transmitted notification was not received, for example by receiving a signal expressly indicating that the transmitted notification was not received or by receiving no signal indicating that the transmitted notification was affirmatively received. In an exemplary embodiment, the notification of the event is retransmitted by the selected device. Optionally, the selected device transmits a signal indicating that the notification of the event is to be re-transmitted by an alternate device on the network. In this way, if one device is having difficulty transmitting and/or retransmitting a notification, another device can attempt to transmit the notification. An additional selection process is optionally undertaken to determine which alternate device to select for retransmitting the notification, such as by recomparing or reevaluating device metrics.

Optionally, it is desirable to determine or control where a notification is transmitted to or to determine or control which devices that receive a transmitted notification will generate a display of the notification. In this way, notifications can be as unintrusive as possible while still performing their desired goal, which is to inform a user about an event. A specific method embodiment further comprises assigning a notification reach level to the notification of the event. This optionally provides an access device that receives the notification of the event the ability to determine whether it should generate a display of the notification or not. For example, each access device is optionally assigned a device reach level and in methods of this aspect receiving the notification at an access device having a device reach level within a specified range of the notification reach level optionally generates a display of the notification. Alternatively, or in addition, this optionally provides a computing device selected to transmit a notification the ability to determine which access devices it should direct the notification to. The use of reach levels like this, for example, allows users to establish which devices should always generate a display of a notification, which devices should never generate a display of a notification or otherwise control or dictate the circumstances in which a device, such as an access device, generates a display of the notification.

For certain circumstances, it may be desirable to change the notification reach level or to change a device reach level, such as by transmitting a signal indicating a change to the notification reach level or to one or more device reach levels. For example, a user may not wish to receive notifications on a smartphone during certain hours of the day, but may find notifications on the smartphone acceptable during other times. Accordingly, the smartphone may be assigned one device reach level during certain times, such as a reach level that places it outside the boundaries for generating a display of a notification, but changed to a second device reach level at other times. Similarly, it may be desirable to only receive certain types of notifications, such as emergency notifications on some devices, while minimizing the display of all other notifications. Other devices, however, may be suitable for displaying all notifications or only notifications within certain reach level bands.

Another useful parameter that is optionally assigned to a notification is a notification type. A variety of conditions can dictate the type of a notification, but for some embodiments, a notification type optionally indicates the required acknowledgment to the notification. For example, in some embodiments a notification may be of a type that is informational only, and thus requires no acknowledgment. Some notifications may be of a query type that require or request user input, such as to confirm an action to be taken in response to the occurrence of an event. Other notifications may be of a type that dictate which access devices they are to be displayed on and/or sent to, such as emergency notifications that may be displayed on all devices and may require an acknowledgment or other responsive action. In some embodiments, a user acknowledgment that a notification is displayed may be sufficient. In other embodiments, a notification may require that a user undertake some specific action, such as to require that the user make a phone call or enter a passcode or some other specific action, before the notification can be dismissed. In certain embodiments, the notification type is changed, such as to escalate the severity of a notification or to reduce the severity of a notification or to require a different acknowledgement. In specific embodiments, a method of this aspect further comprises transmitting a query requesting the required acknowledgment and/or receiving a query providing the required acknowledgment.

In another aspect, provided herein are systems, such as systems for performing the methods described herein. A specific system embodiment comprises one or more data processors; and a non-transitory computer-readable storage medium containing instructions that, when executed on the one or more data processors, cause the one or more data processors to perform operations including: receiving a detection signal indicating detection of an event; transmitting a communication relating to the event, wherein the communication is transmitted within a network; generating a query for ascertaining whether the system is selected for transmitting a notification of the event; determining that the system is selected for transmitting the notification of the event; and transmitting the notification of the event. In one embodiment, the operations further comprise receiving a response to the query indicating that the system is selected for transmitting the notification of the event.

Another system embodiment comprises one or more data processors; and a non-transitory computer-readable storage medium containing instructions that, when executed on the one or more data processors, cause the one or more data processors to perform operations including: receiving a detection signal indicating detection of an event; transmitting a communication relating to the event within a network; generating a query for ascertaining whether the system is selected for transmitting a notification of the event; determining that an alternate device is selected for transmitting the notification of the event; and transmitting a signal within the network indicating the alternate device is selected for transmitting the notification of the event. Optionally, the operations further include receiving the notification of the event. Optionally, determining includes determining that the system is not selected for transmitting the notification of the event.

Optionally, the notification is transmitted outside of the network. In embodiments, the detection signal indicating detection of the event is the notification of the event. Optionally, the system further comprises a sensor, such as positioned in data communication with the one or more data processors, and wherein the sensor generates the detection signal indicating detection of the event. Optionally, the communication relating to the event includes the detection signal. Optionally the communication relating to the event includes an acknowledgment signal indicating receipt of the detection signal.

In embodiments, the query includes a request for device metrics for one or more devices. Optionally, determining that the system is selected for transmitting the notification of the event includes receiving the device metrics and comparing the device metrics to determine which device to select for transmitting the notification of the event. Optionally, the query includes a request for selection of the system for transmission of the notification of the event.

In various embodiments, additional operations may be included. For example, in one embodiment, the operations further comprise determining that the transmitted notification was not received and re-transmitting the notification of the event or transmitting a signal indicating that the notification of the event is to be re-transmitted, such as by an alternate device. Optionally, the operations further comprise assigning a notification reach level to the notification of the event, wherein receiving the notification of the event at an access device having a device reach level within a specified range of the notification reach level generates a display of the notification. Optionally, the operations further comprise transmitting a signal indicating a change to the notification reach level or to one or more device reach levels. In an embodiment, the operations further comprise assigning a notification type to the notification of the event, wherein the notification type establishes a required acknowledgment to the notification of the event and wherein transmitting the notification includes transmitting a query requesting the required acknowledgment. Optionally, the operations further comprise transmitting a signal indicating a change to the notification type.

In another aspect, provided is a computer-program product tangibly embodied in a non-transitory machine-readable storage medium. For example, in one embodiment a computer-program product includes instructions configured to cause a computing device to: receive, a detection signal indicating detection of an event; transmit a communication relating to the event within a network; generate a query for ascertaining whether the computing device is selected for transmitting a notification of the event; determine that the computing device is selected for transmitting the notification of the event; and transmit the notification of the event.

Another embodiment comprises a computer-program product tangibly embodied in a non-transitory machine-readable storage medium, including instructions configured to cause a computing device to: receive a detection signal indicating detection of an event; transmit a communication relating to the event within a network; generate a query for ascertaining whether the computing device is selected for transmitting a notification of the event; determine that an alternate device is selected for transmitting the notification of the event; and transmit a signal within the network to indicate the alternate device is selected for transmitting the notification of the event. Optionally, the instructions further cause the computing device to receive the notification of the event. Optionally, instructions configured to cause the computing device to determine that an alternate device is selected for transmitting a notification of the event includes causing the computing device determine that the computing device is not selected for transmitting the notification of the event. Optionally, the instructions further cause the computing device to receive a response to the query indicating that the alternate device is selected for transmitting the notification of the event.

Optionally, the detection signal indicating detection of the event is the notification of the event. In some embodiments, the computing device includes a sensor and the sensor generates the detection signal indicating detection of the event. Optionally, an instruction configured to cause a computing device to transmit the notification causes the computing device to transmit the notification outside the network. In embodiments, the communication relating to the event includes the detection signal. In embodiments, the communication relating to the event includes an acknowledgment signal indicating receipt of the detection signal.

In embodiments, for example, the query includes a request for device metrics for one or more devices and the instructions configured to cause the computing device to determine that the computing device is selected for transmitting the notification of the event include causing the computing device to receive the device metrics and compare the device metrics to determine which device to select for transmitting the notification of the event. Optionally, the query includes a request for selection of the computing device for transmission of the notification of the event.

In various embodiments, a computer-program product includes further instructions. For example, in one embodiment, a computer-program product includes instructions further configured to cause the computing device to receive a response to the query indicating that the computing device is selected for transmitting the notification of the event. In some embodiments, a computer-program product includes further instructions configured to cause the computing device to determine that a transmitted notification was not received and re-transmit the notification of the event or transmit a signal indicating that the notification of the event is to be re-transmitted by an alternate device. In embodiments, a computer-program product includes instructions further configured to cause the computing device to assign a notification reach level to the notification of the event, such that, when the notification of the event is received at an access device having a device reach level within a specified range of the notification reach level, a display of the notification is generated. Optionally, the computer-program product further includes instructions further configured to cause the computing device to transmit a signal indicating a change to the notification reach level or to one or more device reach levels. In some embodiments, a computer-program product includes instructions configured to cause the computing device to assign a notification type to the notification of the event, wherein the notification type establishes a required acknowledgment to the notification of the event and wherein the instruction configured to cause the computing device to transmit the notification includes causing the computing device to transmit a query requesting the required acknowledgment. Optionally, the computer-program product includes instructions configured to cause the computing device to transmit a signal indicating a change to the notification type.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

Illustrative embodiments of the present invention are described in detail below with reference to the following drawing figures:

FIG. 1 is an illustration of an example of a network environment, in accordance with some embodiments.

FIG. 2 is a flowchart illustrating an embodiment of a process for registering one or more network devices, in accordance with some embodiments.

FIG. 3 shows a process for providing a visual interface module for controlling a device in a wireless network, in accordance with some embodiments.

FIG. 4 is an illustration of an example of a network environment, in accordance with some embodiments.

FIG. 5 is an illustration of an example of a network environment, in accordance with some embodiments.

FIG. 6 is an illustration of an example of a network environment, in accordance with some embodiments.

FIG. 7 is an illustration of an example of a front view of a network device, in accordance with an embodiment.

FIG. 8 is an illustration of an example of a side view of a network device, in accordance with an embodiment.

FIG. 9 is an example of a block diagram of a network device, in accordance with an embodiment.

FIG. 10 is a schematic illustration of a local area network including a network device that includes an appliance, in accordance with an embodiment.

FIG. 11 is an example of a block diagram of a network device including an interface device attached to an appliance, in accordance with an embodiment.

FIG. 12 depicts an example interface for controlling network devices, in accordance with some embodiments.

FIG. 13 shows an example interface for establishing a new rule assigned to a network device, in accordance with some embodiments.

FIG. 14 shows example interfaces for establishing a new rule that conflicts with an existing rule assigned to a network device, in accordance with some embodiments.

FIG. 15 shows an illustration of a data store including existing rules assigned to network devices, in accordance with some embodiments.

FIG. 16 shows an illustration of an example interface for providing an indication of a conflict between an existing rule and a new rule assigned to a network device, in accordance with some embodiments.

FIG. 17 shows an illustration of an example scheduling interface for providing an indication of a conflict between an existing rule and new rule assigned to a network device, in accordance with some embodiments.

FIG. 18 shows an example interface for establishing a new rule assigned to a network device that relates to an interaction between the network device and another network device, in accordance with some embodiments.

FIG. 19 shows example interfaces for establishing a new rule that conflicts with an existing rule assigned to a network device, in accordance with some embodiments.

FIG. 20 shows an illustration of a data store including existing rules assigned to network devices, in accordance with some embodiments.

FIG. 21 shows an illustration of an example interface for providing an indication of a conflict between an existing rule and a new rule assigned to a network device, in accordance with some embodiments.

FIG. 22 shows an illustration of an example scheduling interface for providing an indication of a conflict between an existing rule and new rule assigned to a network device, in accordance with some embodiments.

FIG. 23 is a flowchart illustrating a process for identifying and resolving network device rule conflicts, in accordance with some embodiments.

FIG. 24 an example interface for controlling network devices, in accordance with some embodiments.

FIG. 25 shows an illustration of a data store including existing rules assigned to network devices and a new rule, in accordance with some embodiments.

FIG. 26 shows an illustration of a recursive operation, in accordance with some embodiments.

FIG. 27 shows an illustration of providing an indication of a recursive operation, in accordance with some embodiments.

FIG. 28 shows an illustration of providing an indication of a recursive operation, in accordance with some embodiments.

FIG. 29 is a flowchart illustrating a process for identifying and resolving recursive operations with a network device, in accordance with some embodiments.

FIGS. 30A and 30B show illustrations of a counter associated with a recursive operation, in accordance with some embodiments.

FIG. 31 shows an illustration of a third party computing device associated with a recursive operation, in accordance with some embodiments.

FIG. 32 shows an illustration of providing an indication of a recursive operation, in accordance with some embodiments.

FIG. 33 is a flowchart illustrating a process for identifying and resolving recursive operations with a network device, in accordance with some embodiments.

FIG. 34A provides an illustration of the detection of an event and generation of a notification.

FIG. 34B provides an illustration of the detection of an event and generation of a notification.

FIG. 34C provides an illustration of the detection of an event and generation of a notification.

FIG. 35 provides a flowchart illustrating an embodiment of a process for generating a notification of an event, in accordance with some embodiments.

FIG. 36 provides an illustration of the detection of an event and generation of a notification with multiple transmission attempts.

FIG. 37 provides an illustration of the detection of an event and generation of a notification with multiple transmission attempts.

FIG. 38 provides a flowchart illustrating an embodiment of a process for generating a notification of an event, in accordance with some embodiments.

FIG. 39 provides an illustration of the detection of an event and generation of a notification requesting acknowledgment.

FIG. 40 provides a flowchart illustrating an embodiment of a process for generating a notification of an event, in accordance with some embodiments.

FIG. 41 provides a flowchart illustrating an embodiment of a process for generating a notification of an event, in accordance with some embodiments.

FIG. 42 provides an illustration describing the reach of notification.

FIG. 43 provides a flowchart illustrating an embodiment of a process for generating a notification of an event, in accordance with some embodiments.

FIG. 44 provides a flowchart illustrating an embodiment of a process for generating a notification of an event, in accordance with some embodiments.

FIG. 45 provides a flowchart illustrating an embodiment of a process for generating a notification of an event, in accordance with some embodiments.

### DETAILED DESCRIPTION

In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be appreciated that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process, which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable storage medium or computer-readable storage medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Systems depicted in some of the figures may be provided in various configurations. In some embodiments, the systems may be configured as a distributed system where one or more components of the system are distributed across one or more networks in a cloud computing system.

A network may be set up to provide an access device user with access to various devices connected to the network. For example, a network may include one or more network devices that provide a user with the ability to remotely configure or control the network devices themselves or one or more electronic devices (e.g., appliances) connected to the network devices. The electronic devices may be located within an environment or a venue that can support the network. An environment can include, for example, a home, an office, a business, an automobile, a park, or the like. A network may include one or more gateways that allow client devices (e.g., network devices, access devices, or the like) to access the network by providing wired connections and/or wireless connections using radio frequency channels in one or more frequency bands. The one or more gateways may also provide the client devices with access to one or more external networks, such as a cloud network, the Internet, and/or other wide area networks.

A local area network, such as a user's home local area network, can include multiple network devices that provide various functionalities. Network devices may be accessed and controlled using an access device and/or one or more network gateways. One or more gateways in the local area network may be designated as a primary gateway that provides the local area network with access to an external network. The local area network can also extend outside of the user's home and may include network devices located outside of the user's home. For instance, the local area network can include network devices such as exterior motion sensors, exterior lighting (e.g., porch lights, walkway lights, security lights, or the like), garage door openers, sprinkler systems, or other network devices that are exterior to the user's home. It is desirable for a user to be able to access the network devices while located within the local area network and also while located remotely from the local area network. For example, a user may access the network devices using an access device within the local area network or remotely from the local area network.

As explained herein, techniques are provided that allow for identification and resolution of network device rule conflicts. When a user adds a new rule, a conflict with one or more existing rules can be identified, and various remedial measures may be taken. In some embodiments, an indication of the conflict can be provided (e.g., displayed) to the user on a user device such as access device (e.g., a mobile device) so that the user is made aware of the conflict and can provide further instructions to resolve the conflict. The indication may include a recommended course of action to resolve the conflict. In some embodiments, upon identifying a rule conflict, the network device (or other computing device included in or associated with the network) may resolve the conflict automatically by cancelling or otherwise modifying one or more of the conflicting rules assigned to the network device.

Techniques are also provided that allow for identification of a recursive operation. The identification of the recursive operation may be identified at rule creation (e.g., before the new rule is assigned to and executed by a network device) or at run time (e.g., after a rule has been created and while it is being executed by a network device). As with identified conflicts, the user can be made aware of the recursive operation and can provide further instructions to resolve the recursive operation. The indication may include a recommended course of action to resolve the recursive operation. In some embodiments, upon identifying the recursive operation, the network device (or other computing device included in or associated with the network) may automatically cause the network device to stop the recursive operation, and may further resolve the recursive operation by cancelling, modifying, or updating an existing rule associated with the recursive operation (e.g., the existing rule assigned to the network device).

In some embodiments, a user may create an account with login information that is used to authenticate the user and allow access to the network devices. For example, once an account is created, a user may enter the login information in order to access a network device in a logical network.

In some embodiments, an accountless authentication process may be performed so that the user can access one or more network devices within a logical network without having to enter network device login credentials each time access is requested. While located locally within the local area network, an access device may be authenticated based on the access device's authentication with the logical network. For example, if the access device has authorized access to the logical network (e.g., a WiFi network provided by a gateway), the network devices paired with that logical network may allow the access device to connect to them without requiring a login. Accordingly, only users of access devices that have authorization to access the logical network are authorized to access network devices within the logical network, and these users are authorized without having to provide login credentials for the network devices.

An accountless authentication process may also be performed when the user is remote so that the user can access network devices within the logical network, using an access device, without having to enter network device login credentials. While remote, the access device may access the network devices in the local area network using an external network, such as a cloud network, the Internet, or the like. One or more gateways may provide the network devices and/or access device connected to the local area network with access to the external network. To allow accountless authentication, a cloud network server may provide a network ID and/or one or more keys to a network device and/or to the access device (e.g., running an application, program, or the like). In some cases, a unique key may be generated for the network device and a separate unique key may be generated for the access device. The keys may be specifically encrypted with unique information identifiable only to the network device and the access device. The network device and the access device may be authenticated using the network ID and/or each device's corresponding key each time the network device or access device attempts to access the cloud network server.

In some embodiments, a home local area network may include a single gateway, such as a router. A network device within the local area network may pair with or connect to the gateway and may obtain credentials from the gateway. For example, when the network device is powered on, a list of gateways that are detected by the network device may be displayed on an access device (e.g., via an application, program, or the like installed on and executed by the access device). In this example, only the single gateway is included in the home local area network (e.g., any other displayed gateways may be part of other local area networks). In some embodiments, only the single gateway may be displayed (e.g., when only the single gateway is detected by the network device). A user may select the single gateway as the gateway with which the network device is to pair and may enter login information for accessing the gateway. The login information may be the same information that was originally set up for accessing the gateway (e.g., a network user name and password, a network security key, or any other appropriate login information). The access device may send the login information to the network device and the network device may use the login information to pair with the gateway. The network device may then obtain the credentials from the gateway. The credentials may include a service set identifier (SSID) of the home local area network, a media access control (MAC) address of the gateway, and/or the like. The network device may transmit the credentials to a server of a wide area network, such as a cloud network server. In some embodiments, the network device may also send to the server information relating to the network device (e.g., MAC address, serial number, or the like) and/or information relating to the access device (e.g., MAC address, serial number, application unique identifier, or the like).

The cloud network server may register the gateway as a logical network and may assign the first logical network a network identifier (ID). The cloud network server may further generate a set of security keys, which may include one or more security keys. For example, the server may generate a unique key for the network device and a separate unique key for the access device. The server may associate the network device and the access device with the logical network by storing the network ID and the set of security keys in a record or profile. The cloud network server may then transmit the network ID and the set of security keys to the network device. The network device may store the network ID and its unique security key. The network device may also send the network ID and the access device's unique security key to the access device. In some embodiments, the server may transmit the network ID and the access device's security key directly to the access device. The network device and the access device may then communicate with the cloud server using the network ID and the unique key generated for each device. Accordingly, the access device may perform accountless authentication to allow the user to remotely access the network device via the cloud network without logging in each time access is requested. Also, the network device can communicate with the server regarding the logical network.

In some embodiments, a local area network may include multiple gateways (e.g., a router and a range extender) and multiple network devices. For example, a local area network may include a first gateway paired with a first network device, and a second gateway paired with a second network device. In the event credentials for each gateway are used to create a logical network, a server (e.g., a cloud network server) may register the first gateway as a first logical network and may register the second gateway as a second logical network. The server may generate a first network ID and a first set of security keys for the first logical network. The first set of security keys may include a unique security key for the first network device and a unique security key for the access device for use in accessing the first network device on the first logical network. The server may register the second gateway as the second logical network due to differences in the credentials between the first gateway and second gateway. The server may assign the second gateway a second network ID and may generate a second set of security keys. For example, the server may generate a unique security key for the second network device and may generate a unique security key for the access device for use in accessing the second network device on the second logical network. The server may associate the first network device and the access device with the first logical network by storing the first network ID and the first set of security keys in a first record or profile. The server may also associate the second network device and the access device with the second logical network by storing the second network ID and the second set of security keys in a record or profile. The server may then transmit the first network ID and the first set of security keys to the first network device, and may transmit the second network ID and the second set of security keys to the second network device. The two network devices may store the respective network ID and set of security keys of the gateway with which each network device is connected. Each network device may send the respective network ID and the access device's unique security key to the access device. The network devices and the access device may then communicate with the cloud server using the respective network ID and the unique key generated for each device.

Accordingly, when multiple gateways are included in the home local area network, multiple logical networks associated with different network identifiers may be generated for the local area network. When the access device is located within range of both gateways in the local area network, there is no problem accessing both network devices due to the ability of the access device to perform local discovery techniques (e.g., universal plug and play (UPnP)). However, when the user is located remotely from the local area network, the access device may only be associated with one logical network at a time, which prevents the access device from accessing network devices of other logical networks within the local area network.

A computing device (e.g., a user device such as a cellular phone) may determine that one or more network devices are connected to the local area network. The determination may be made based on whether the computing device is located within the wireless network of the device or located remote from the wireless network. The computing device may have access to the wireless network based on its authentication with a logical network which enables access to the wireless network. In some embodiments, the computing device may perform local network discovery while within the wireless network to identify the devices connected to the network. Upon determining that the computing device is not located within the network, the computing device can determine the devices in the network by communication with a cloud network to obtain information about the devices on the network. The cloud network can store a status of devices on the network. The computing device can also determine devices on the network by accessing a local cache that can contain information it has previously received about devices known to exist on the network. The computing device can determine a status of the devices based on its local cache, information received from the cloud, or by direct communication with the devices within the local network. The computing device can access status information from the local cache to present in a display to a user.

The computing device may execute an application that can cause the computing device to present a graphical interface including information about devices discovered on the network (e.g., status, name, icon, existing rules corresponding to the operation of the network device, etc.). The graphical interface can present a visual interface for each device accessible on the network. In some embodiments, the visual interface corresponding to a network device can be rendered as a modular tile with one or more interactive elements and/or one or more interactive areas to control operation of the device. In some embodiments, the existing rules associated with the discovered network devices can be received by the computing device.

The visual interface corresponding to a network device can also provide an icon, a name, interactive elements, status or state of the network device (e.g., on/off), and/or interactive areas for controlling one or more functionalities of a network device (e.g., an opportunity to create a new rule assigned to the network device). The functionalities can include, for example, powering the network device on and off. The functionalities can enable adjustment of adjustable attributes and/or settings for a device. For example, a network device can be a light bulb, for which attributes or settings (e.g., brightness) can be controlled via the tile.

In some embodiments, the computing device can also detect input for a new rule corresponding to operation of the network device. For example, the user may access a graphical interface that instructs a network device to operate according to a new rule. The new rule may adjust the attributes or settings (e.g., brightness) of the light bulb via the tile or define a new rule that adjusts the attributes or settings according to a condition (e.g., time, date, range of time, indication of a changed event, etc.). In some embodiments, the new rule may relate to an interaction between the network device and another network device. For example, the new rule may instruct the light bulb to adjust the settings when motion is detected by a motion sensor network device.

As described herein, techniques are provided that analyze rules assigned to network devices. The analysis can include determining whether a conflict exists between an existing rule and a newly provided rule. For example, the existing rule may instruct a sprinkler system to turn on at 8 AM on Mondays and a new rule may instruct the sprinkler system to turn off at 8 AM on Mondays. In such a scenario, a potential conflict exists between the existing rule and the new rule, because the sprinkler system cannot turn on and off at the same time. The techniques described herein may identify rule conflicts, thereby alleviating potential errors in rule creation, streamlining the customization process associated with the local area network (e.g., automation network), ensuring rules are established in accordance automation parameters desired by users, and improving utilization of network device functionalities. Accordingly, techniques and systems are described herein for identifying and resolving network device rules conflicts.

Techniques are also provided that analyze existing rules assigned to network devices, including an analysis to determine whether the addition of a new rule may result in a recursive operation of a network device. For example, implementation of existing rules in combination with a new rule may result in a recursive scenario where a light is repeatedly toggled on and off (i.e., the light is instructed to turn on, then off, then on again, etc.). The techniques described herein may identify the recursive operations when input is provided to create a new rule, thereby alleviating potential errors in rule creation, streamlining the customization process associated with the local area network (e.g., automation network), ensuring rules are established in accordance automation parameters desired by users, and improving utilization of network device functionalities. Accordingly, techniques and systems are described herein for identifying and resolving recursive operations of a network device.

Techniques are also provided that analyze the real-time operations of the network device in accordance with assigned rules to identify that the operations of the network device include a recursive operation. The techniques described herein may identify the recursive operation as the assigned rules are being executed by the network (e.g., after rule creation), thereby streamlining the customization process associated with the local area network (e.g., automation network) and improving utilization of network device functionalities. Accordingly, techniques and systems are described herein for identifying and resolving recursive operations of a network device at near real time.

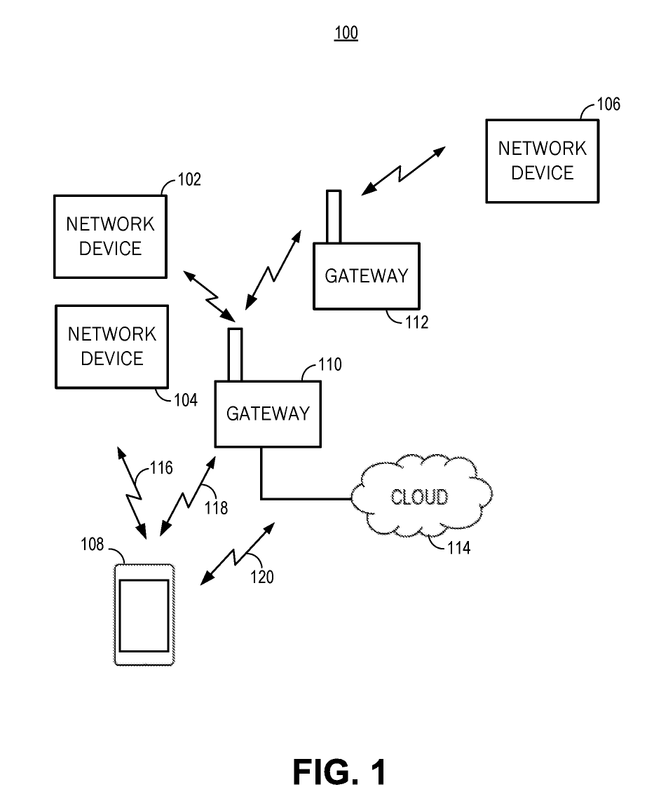

FIG. 1 illustrates an example of a local area network 100. The local area network 100 includes network device 102, network device 104, and network device 106. In some embodiments, any of the network devices 102, 104, 106 may include an Internet of Things (IoT) device. As used herein, an IoT device is a device that includes sensing and/or control functionality as well as a WiFi™ transceiver radio or interface, a Bluetooth™ transceiver radio or interface, a Zigbee™ transceiver radio or interface, an Ultra-Wideband (UWB) transceiver radio or interface, a WiFi-Direct transceiver radio or interface, a Bluetooth™ Low Energy (BLE) transceiver radio or interface, an infrared (IR) transceiver, and/or any other wireless network transceiver radio or interface that allows the IoT device to communicate with a wide area network and with one or more other devices. In some embodiments, an IoT device does not include a cellular network transceiver radio or interface, and thus may not be configured to directly communicate with a cellular network. In some embodiments, an IoT device may include a cellular transceiver radio, and may be configured to communicate with a cellular network using the cellular network transceiver radio. The network devices 102, 104, 106, as IoT devices or other devices, may include home automation network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In some embodiments, network devices 102, 104, 106 may be used in other environments, such as a business, a school, an establishment, a park, or any place that can support the local area network 100 to enable communication with network devices 102, 104, 106. For example, a network device can allow a user to access, control, and/or configure devices, such as office-related devices (e.g., copy machine, printer, fax machine, or the like), audio and/or video related devices (e.g., a receiver, a speaker, a projector, a DVD player, a television, or the like), media-playback devices (e.g., a compact disc player, a CD player, or the like), computing devices (e.g., a home computer, a laptop computer, a tablet, a personal digital assistant (PDA), a wearable device, or the like), lighting devices (e.g., a lamp, recessed lighting, or the like), devices associated with a security system, devices associated with an alarm system, devices that can be operated in an automobile (e.g., radio devices, navigation devices), and/or the like.

A user may communicate with the network devices 102, 104, 106 using an access device 108. The access device 108 may include any human-to-machine interface with network connection capability that allows access to a network. For example, the access device 108 may include a stand-alone interface (e.g., a cellular telephone, a smartphone, a home computer, a laptop computer, a tablet, a personal digital assistant (PDA), a computing device, a wearable device such as a smart watch, a wall panel, a keypad, or the like), an interface that is built into an appliance or other device e.g., a television, a refrigerator, a security system, a game console, a browser, or the like), a speech or gesture interface (e.g., a Kinect™ sensor, a Wiimote™, or the like), an IoT device interface (e.g., an Internet enabled device such as a wall switch, a control interface, or other suitable interface), or the like. In some embodiments, the access device 108 may include a cellular or other broadband network transceiver radio or interface, and may be configured to communicate with a cellular or other broadband network using the cellular or broadband network transceiver radio. In some embodiments, the access device 108 may not include a cellular network transceiver radio or interface. While only a single access device 108 is shown in FIG. 1, it will be appreciated that multiple access devices may communicate with the network devices 102, 104, 106. The user may interact with the network devices 102, 104, or 106 using an application, a web browser, a proprietary program, or any other program executed and operated by the access device 108. In some embodiments, the access device 108 may communicate directly with the network devices 102, 104, 106 (e.g., communication signal 116). For example, the access device 108 may communicate directly with network device 102, 104, 106 using Zigbee™ signals, Bluetooth™ signals, WiFi™ signals, infrared (IR) signals, UWB signals, WiFi-Direct signals, BLE signals, sound frequency signals, or the like. In some embodiments, the access device 108 may communicate with the network devices 102, 104, 106 via the gateways 110, 112 (e.g., communication signal 118) and/or the cloud network 114 (e.g., communication signal 120).

The local area network 100 may include a wireless network, a wired network, or a combination of a wired and wireless network. A wireless network may include any wireless interface or combination of wireless interfaces (e.g., Zigbee™, Bluetooth™, WiFi™, IR, UWB, WiFi-Direct, BLE, cellular, Long-Term Evolution (LTE), WiMax™, or the like). A wired network may include any wired interface (e.g., fiber, Ethernet, powerline Ethernet, Ethernet over coaxial cable, digital signal line (DSL), or the like). The wired and/or wireless networks may be implemented using various routers, access points, bridges, gateways, or the like, to connect devices in the local area network 100. For example, the local area network may include gateway 110 and gateway 112. Gateway 110 or 112 can provide communication capabilities to network devices 102, 104, 106 and/or access device 108 via radio signals in order to provide communication, location, and/or other services to the devices. The gateway 110 is directly connected to the external or cloud network 114 and may provide other gateways and devices in the local area network with access to the external or cloud network 114. The gateway 110 may be designated as a primary gateway. While two gateways 110 and 112 are shown in FIG. 1, it will be appreciated that any number of gateways may be present within the local area network 100.

The network access provided by gateway 110 and gateway 112 may be of any type of network familiar to those skilled in the art that can support data communications using any of a variety of commercially-available protocols. For example, gateways 110, 112 may provide wireless communication capabilities for the local area network 100 using particular communications protocols, such as WiFi™ (e.g., IEEE 802.11 family standards, or other wireless communication technologies, or any combination thereof). Using the communications protocol(s), the gateways 110, 112 may provide radio frequencies on which wireless enabled devices in the local area network 100 can communicate. A gateway may also be referred to as a base station, an access point, Node B, Evolved Node B (eNodeB), access point base station, a Femtocell, home base station, home Node B, home eNodeB, or the like.

The gateways 110, 112 may include a router, a modem, a range extending device, and/or any other device that provides network access among one or more computing devices and/or external networks. For example, gateway 110 may include a router or access point, and gateway 112 may include a range extending device. Examples of range extending devices may include a wireless range extender, a wireless repeater, or the like.

A router gateway may include access point and router functionality, and may further include an Ethernet switch and/or a modem. For example, a router gateway may receive and forward data packets among different networks. When a data packet is received, the router gateway may read identification information (e.g., a media access control (MAC) address) in the packet to determine the intended destination for the packet. The router gateway may then access information in a routing table or routing policy, and may direct the packet to the next network or device in the transmission path of the packet. The data packet may be forwarded from one gateway to another through the computer networks until the packet is received at the intended destination.

A range extending gateway may be used to improve signal range and strength within a local area network. The range extending gateway may receive an existing signal from a router gateway or other gateway and may rebroadcast the signal to create an additional logical network. For example, a range extending gateway may extend the network coverage of the router gateway when two or more devices on the local area network need to be connected with one another, but the distance between one of the devices and the router gateway is too far for a connection to be established using the resources from the router gateway. As a result, devices outside of the coverage area of the router gateway may be able to connect through the repeated network provided by the range extending gateway. The router gateway and range extending gateway may exchange information about destination addresses using a dynamic routing protocol.

The gateways 110 and 112 may also provide the access device 108 and the network devices 102, 104, 106 with access to one or more external networks, such as the cloud network 114, the Internet, and/or other wide area networks. In some embodiments, the network devices 102, 104, 106 may connect directly to the cloud network 114, for example, using broadband network access such as a cellular network. The cloud network 114 may include a cloud infrastructure system that provides cloud services. In certain embodiments, services provided by the cloud network 114 may include a host of services that are made available to users of the cloud infrastructure system on demand, such as registration and access control of network devices 102, 104, 106. Services provided by the cloud infrastructure system can dynamically scale to meet the needs of its users. The cloud network 114 may comprise one or more computers, servers, and/or systems. In some embodiments, the computers, servers, and/or systems that make up the cloud network 114 are different from the user's own on-premises computers, servers, and/or systems. For example, the cloud network 114 may host an application, and a user may, via a communication network such as the Internet, on demand, order and use the application.

In some embodiments, the cloud network 114 may host a Network Address Translation (NAT) Traversal application in order to establish a secure connection between the cloud network 114 and one or more of the network devices 102, 104, 106. For example, a separate secure Transmission Control Protocol (TCP) connection may be established by each network device 102, 104, 106 for communicating between each network device 102, 104, 106 and the cloud network 114. In some embodiments, each secure connection may be kept open for an indefinite period of time so that the cloud network 114 can initiate communications with each respective network device 102, 104, or 106 at any time. In some cases, other types of communications between the cloud network 114 and the network devices 102, 104, 106 and/or the access device 108 may be supported using other types of communication protocols, such as a Hypertext Transfer Protocol (HTTP) protocol, a Hypertext Transfer Protocol Secure (HTTPS) protocol, or the like. In some embodiments, communications initiated by the cloud network 114 may be conducted over the TCP connection, and communications initiated by a network device may be conducted over a HTTP or HTTPS connection. In certain embodiments, the cloud network 114 may include a suite of applications, middleware, and database service offerings that are delivered to a customer in a self-service, subscription-based, elastically scalable, reliable, highly available, and secure manner.

It should be appreciated that the local area network 100 may have other components than those depicted. Further, the embodiment shown in the figure is only one example of a local area network that may incorporate an embodiment of the invention. In some other embodiments, local area network 100 may have more or fewer components than shown in the figure, may combine two or more components, or may have a different configuration or arrangement of components.

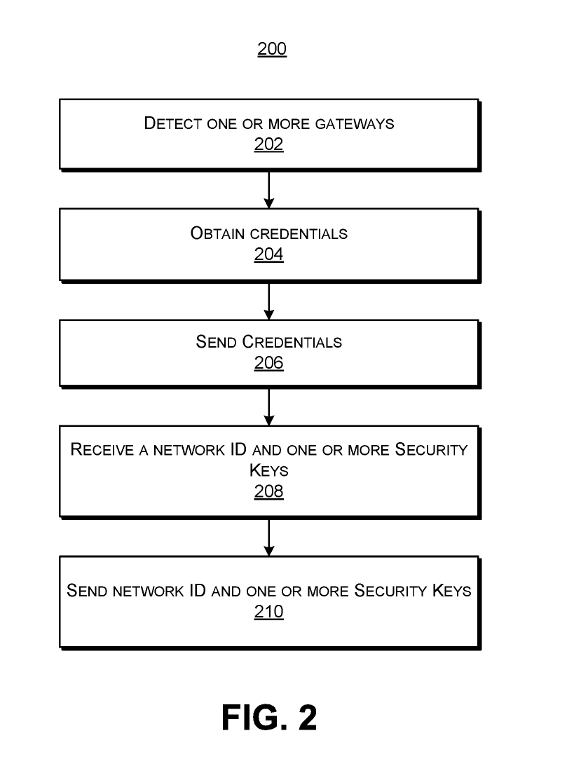

Upon being powered on or reset, the network devices 102, 104, 106 may be registered with the cloud network 114 and associated with a logical network within the local area network 100. FIG. 2 illustrates an example of a process 200 for registering one or more network devices, such as the network devices 102, 104, 106 illustrated in FIG. 1. When multiple network devices 102, 104, 106 and gateways 110, 112 are included within a local area network, the network devices and/or gateways may be installed at different times, resulting in the techniques described with respect to FIG. 2 possibly occurring for each network device and/or gateway at different points in time. For example, a user may install network device 102 at a first point in time on a first floor of the user's house. Gateway 110 may also be located on the first floor, resulting in the network device 102 pairing with gateway 110. The user may later install gateway 112 and network device 106 on a second floor of the user's home, resulting in the network device 106 pairing with gateway 112.

At 202, a network device may detect one or more gateways upon being powered on or reset. In some embodiments, a provisioning process may occur when the network device is powered on or reset and detected by an access device (e.g., access device 108). During the provisioning process, the access device may directly communicate with the network device. In some embodiments, direct communication between network devices (e.g., network devices 102, 104, 106) and access device (e.g., access device 108) may occur using various communications protocols, such as Universal Plug and Play (UPnP), Bluetooth®, Zigbee®, Ultra-Wideband (UWB), WiFi-Direct, WiFi, Bluetooth® Low Energy (BLE), sound frequencies, and/or the like.

The provisioning process may include pairing the network device with a gateway and registering the gateway, network device, and access device with a server, such as a server located within the cloud network 114. For example, upon being powered on or reset to factory settings, the network device may send or broadcast identification information to one or more access devices. The identification information may be sent during a discovery process. For example, the identification information may be sent in response to a discovery request from an access device. In some cases, the identification information may include a name of the network device.

An application, program, or the like that is installed on and executed by the access device may receive the identification information from the network device. When the application on the access device is launched by a user, the access device may display the identification information for selection by the user. Once the network device identification information is selected, the access device may send a signal to the network device indicating that it has been selected. The network device may then send to the access device a list of gateways that are detected by the network device. The access device may receive and display the list of gateways. In some embodiments, the list of gateways includes multiple gateways (e.g., gateways 110 and 112) that are located within the local area network. The user may select the gateway that the user wishes for the network device to pair. For example, the gateway that provides the best signal strength for the network device may be selected. The access device may then prompt the user to enter login information that is required for accessing the network signals provided by the selected gateway. For example, the login information may be the same information that was originally set up to access the gateway network signals (e.g., when the gateway was initially installed). Once entered, the access device may send the login information to the network device. The network device may use the login information to pair with the selected gateway. As one example, network device 102 and network device 104 may be paired with gateway 110, and network device 106 may be paired with gateway 112.

Once paired with a gateway, the network device may be registered with a cloud network (e.g., cloud network 114). For example, the access device (e.g., via the application, program, or the like) may instruct the network device to register with the cloud network upon receiving confirmation from the network device that it has been successfully paired with a gateway. At 204, the network device may obtain credentials from the gateway as part of the registration process. For example, network device 102 may obtain credentials from gateway 110. At a same or later point in time, network devices 104 and 106 may obtain credentials from gateways 110 and 112, respectively. In some embodiments, the credentials may include a SSID of the local area network and a MAC address of the gateway. An SSID received from two gateways (e.g., gateways 110, 112) may be the same due to the gateways both being within the same local area network. In some cases, the SSID of the two gateways may be different. The MAC address of each of the gateways may be unique to each gateway. As a result of each gateway having a unique MAC address, the credentials obtained from a gateway may be unique to that particular gateway. It will be appreciated that other credentials may be obtained from a gateway, such as an Internet Protocol address, or the like.

The network device may then send the gateway credentials to the cloud network at 206. For example, the network devices 102, 104, 106 may send credentials for the gateway with which each is paired to the server located within the cloud network 114. For example, network device 102 may transmit the credentials obtained from gateway 110 to the server, and network device 106 may transmit the credentials obtained from gateway 112 to the server. In some embodiments, the network device may also send information relating to the network device (e.g., MAC address, serial number, make, model number, firmware version, and/or an interface module identifier, or the like) to the server, and/or information relating to the access device (e.g., MAC address, serial number, application unique identifier, or the like) to the server. In some embodiments, the communication of the credentials, the network device information, and/or the access device information sent from the network device to the cloud network server may be in a Hypertext Transfer Protocol (HTTP) format, a Hypertext Transfer Protocol Secure (HTTPS) format, a secure Transmission Control Protocol (TCP) format, or the like. It will be appreciated that other communication formats may be used to communicate between the network device and the cloud network server.

Once the credentials, network device information, and/or access device information are received by the server, the server may register each gateway as a logical network within the local area network and may generate a network ID for each logical network. For example, the server may register the gateway 110 as a first logical network. During the registration process, the server may generate a first network ID for identifying the first logical network. As noted above, it will be appreciated that any number of gateways may be present within the local area network, and thus that any number of logical networks may be registered for the local area network. The server may further generate a first set of security keys for authenticating the network device and the access device. For example, the server may generate a unique key for the network device 102 and a separate unique key for the access device 108.

Once the unique IDs are received by the server, the server may register each network device and determine a visual interface module for each network device. For example, the server may register the network device 102 as a first network device. During the registration process, the server may determine or generate a first interface module ID for identifying a visual interface module suitable for controlling the first network device. As noted above, it will be appreciated that any number of network devices may be present within the local area network, and thus that any number of network devices may be discovered and registered for the local area network.

In some embodiments, a modular visual interface framework may be utilized to dynamically and implicitly provide visual interface modules to an access device 108 so that the access device 108 can be used to control network devices within a network without having to install a new application or a version of an application for each network device. The visual interface modules can enable a user of the access device 108 to remotely control network devices within a network without having to physically interface with the network device. In certain embodiments, an application installed on the access device 108 can have a graphical interface, and the application can be configured to execute one or more visual interface modules usable to control respective network devices in a local area network. The visual interface modules, when executed by an application, can render a visual interface in the graphical interface to enable control of operation of the network device. In some embodiments, the visual interface module can be specific to a given network device.

The visual interface rendered for a visual interface module can be a modular tile that includes information identifying a respective network device and includes interactive areas or interactive elements for controlling and/or monitoring the network device on a network. The visual interface can provide information about a status of the network device corresponding to the tile. The status of a network device may be any changeable variable of that particular network device. For example, the status of a network device may include a state of the network device itself (e.g., on or off) or how the network device is situated within the network with respect to the other network and other devices throughout the network. In certain embodiments, the status can include a value, a state, or other unit of measure corresponding to a setting or an attribute related to operation of a device. The setting or the attribute can be adjustable within a range of values or between different states. For example, the device can be a light bulb and the status can include a value corresponding to brightness (e.g., a percentage of total brightness) emitted by the light bulb when the light bulb is powered-on.

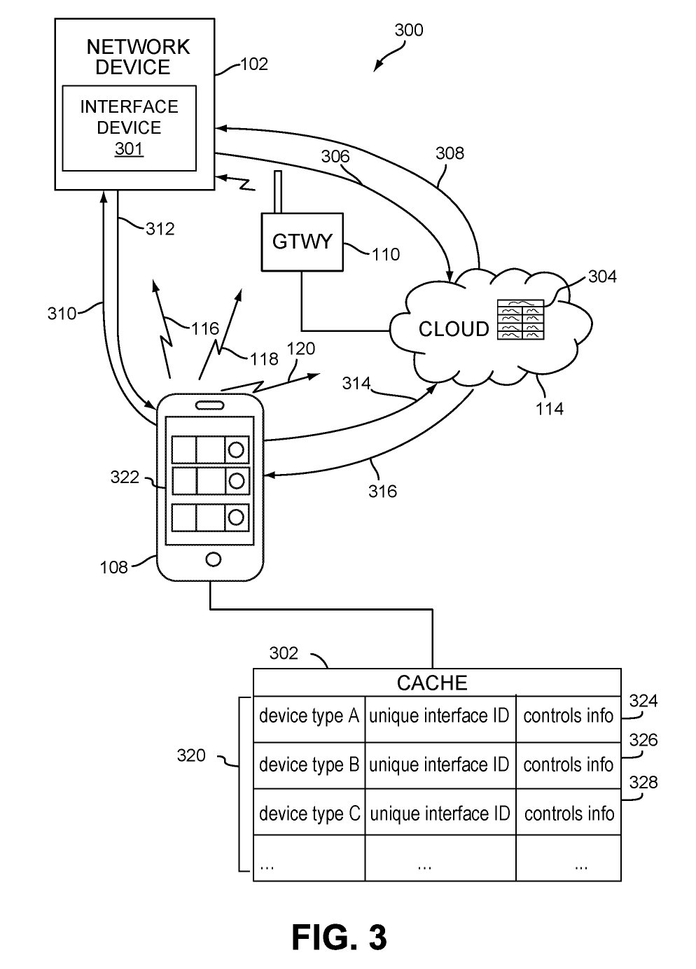

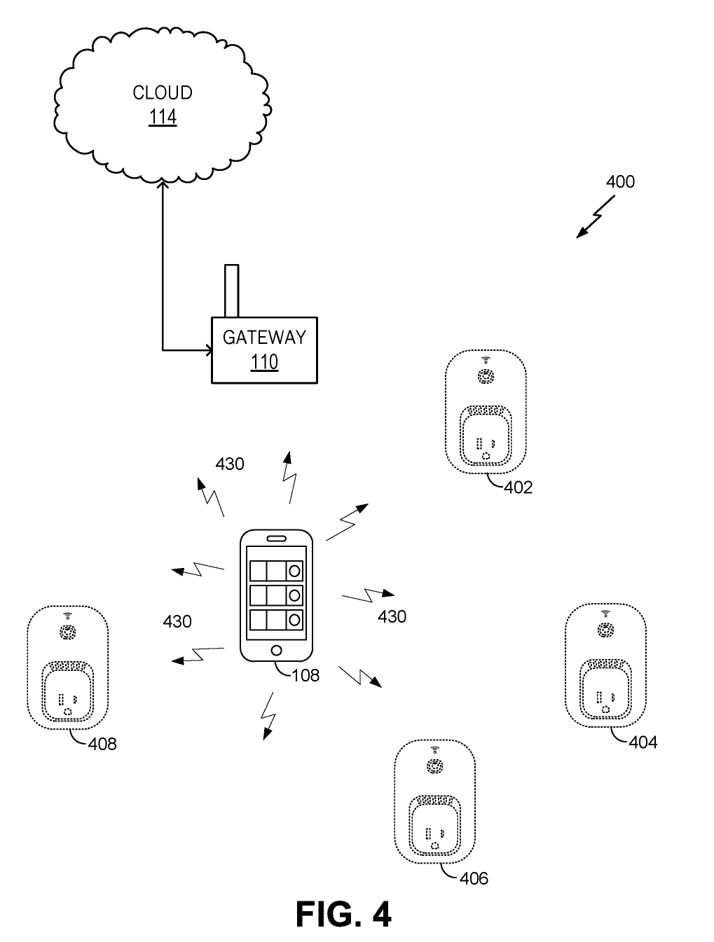

The visual interface can include one or more interactive elements or interactive areas to control one or more settings and/or attributes related to operation of the network device corresponding to the visual interface. The settings and/or attributes can correspond to functionalities or features of the network device. The functionalities can include, for example, powering the network device on and off, or adjusting a setting or an attribute of the network device. The visual interface can be updated to reflect the status of the network device with respect to the adjustment of one or more attributes and/or settings. Operation and implementation of the modular visual interface framework is described below with reference to FIGS. 3 and 4 is just one example of a visual interface that enables a user to control attributes and/or settings related to operation of network devices controllable via a computing device.

In some embodiments, as previously described, network device 104 may also be paired with gateway 110 at the same or a later point in time as the network device 102. During registration of the network device 104, the server may determine that the access device 108 has already been registered with another network device (e.g., network device 102) that is associated with the same logical network of gateway 110. In such embodiments, the server may retrieve the first network ID that was used in registering the first logical network. The server may also generate a new unique security key for the network device 104, and may retrieve the unique key that was previously generated for the access device 108 when registering the gateway 110 as the first logical network. Also in embodiments where the server may determine that the access device 108 has already been registered with another network device, the server may have used a unique ID for the previously discovered network device 102 to determine a first interface module suitable for controlling the network device 102. Further in such embodiments, the server may use another unique ID for the network device 104 to identify a second interface module suitable for controlling network device 104.

The gateway 112 may also be registered by the server as a second logical network with a second network ID. A second set of security keys may be generated for the network device 106 and the access device 108. For example, the server may generate a unique security key for the network device 106 and a unique security key for the access device 108 as it relates to the second logical network. In some embodiments, the gateway may 112 be installed at a later point in time after the gateway 110 is installed, and thus may be registered as the second logical network at the later point in time.

A record or profile may then be created for associating each network ID with the credentials of a corresponding gateway, the corresponding network device(s), and the access device. For example, the server of the cloud network 114 may associate the first network ID with the credentials of gateway 110. Similarly, the server may associate the second network ID with the credentials of gateway 112. In some embodiments, the server performs the association by generating and storing a record including the network ID, the set of security keys, the gateway credentials, the network devices associated with the network ID (e.g., MAC address or serial number of a network device), the access devices associated with the network ID (e.g., MAC address, serial number, application unique identifier, or the like), and/or any other information relevant to the network devices and/or gateways. For example, the server may store the first network ID and the first set of security keys in a first record at a first memory space (e.g., in Flash, DRAM, a database, or the like) along with the SSID and MAC address for gateway 110 and an identifier of the network devices 102 and/or 104. The server may also store the second network ID and the second set of security keys in a second record at a second memory space along with the SSID and MAC address for gateway 112 and an identifier of the network device 106. In some embodiments, an example of a network device identifier may include a MAC address of the network device, a serial number of the network device, or any other unique identifier.

Each of the first and second network IDs may include a unique number or alphanumeric string generated sequentially or randomly. For example, the first time a network device and an associated gateway are registered on the cloud network 114, the unique network ID for the logical network of the gateway may start with 7000000. Each subsequent logical network that is created may be a sequential increment of the initial network ID (e.g., 7000001, 7000002, 7000003, etc.). As another example, the network ID may be generated by a random or pseudo-random number generator. It will be appreciated that other techniques for generating a unique ID may be used. The technique used to generate the network IDs may be dependent on a type of database that is included in the cloud network 114. For example, different databases may have different proprietary mechanisms for creating a unique identifier.

A record or profile may then be created in a data store at the server for associating each network device with a corresponding known interface module so that the interface module can be provided to the access device. For example, the server of the cloud network 114 may associate the first network device 102 with a first interface module. Similarly, the server may associate the second network device 104 with a second interface module. In some embodiments, the server performs the association by generating and storing a record including the unique ID of the network device (e.g., MAC address or serial number of a network device), a unique ID of an interface module suitable to control the network device, and/or any other information relevant to the network device and/or the interface module. For example, the server may store a first record at a first memory space (e.g., in Flash, DRAM, a data store, a database, or the like) with the unique ID of the network device 102 and the unique ID of an interface module for monitoring and controlling the network device 102. The server may also store a second record at a second memory space along with the unique ID of the network device 106 and the unique ID of an interface module for monitoring and controlling the network device 106. The technique used to store records for associating each network device with a corresponding interface module may be dependent on a type of database that is included in the cloud network 114. For example, different databases may have different proprietary mechanisms for creating unique identifiers. The unique identifiers for each interface module may be generated using database specific techniques. For example, a MySQL technique may be used to generate the unique IDs for interface modules. Each unique ID for interface modules may include a universally unique identifier (UUID) or a globally unique identifier (GUID).

The set of keys generated for each logical network may be generated using database specific techniques. For example, a MySQL technique may be used to generate the sets of keys. Each key may include a universally unique identifier (UUID) or a globally unique identifier (GUID). As described above, for each logical network, the server may generate a unique key for a network device and a separate unique key for an access device.

At 208, the network device may receive the network ID and the set of security keys. For example, once the server has generated a record or profile associating the network device 102 with the first logical network, the server may transmit the first network ID and the first set of security keys to the network device 102. The network device 102 may store the first network ID and one or more keys of the first set of keys. For example, the network device 102 may store the unique security key that was created by the server for the network device 102.

As noted previously, the network devices 102, 104, 106 and gateways 110, 112 may be installed at different times. For example, in some embodiments, network device 104 may be installed at a point in time after the first logical network is created based on the pairing between gateway 110 and network device 102. In such embodiments, upon being powered on, the network device 104 may pair with gateway 110, obtain credentials from gateway 110, and transmit the credentials to the server in the cloud network 114 using similar techniques as those described above. The server may associate the network device 104 with the previously generated first network ID. As described above, the server may also generate a new unique security key for the network device 104, and may retrieve the unique key that was previously generated for the access device 108 when registering the first logical network. The network device 104 may then receive and store the first network ID and the security keys from the server. The server may also associate the network device 104 with a known interface module. The server may also generate a record in a data store of interfaces for the network device 104. The access device 108 may receive the interface module for controlling the network device 104 from the server, and then store the interface module in a local cache.

At 210, the network device may send the network ID and the set of security keys to the access device. For example, the network device 102 may send to the access device 108 the first network ID and the unique security key generated for the access device 108. The network device 102 and the access device 108 may then communicate with the cloud network server using the first network ID and each device's unique key. In some embodiments, the network device and the access device may generate a signature using their respective security keys. The signature is sent to the cloud network server along with a communication from the network device or access device. The cloud network server may process the signature in order to authenticate each device, as described below. The network device and access device may use different techniques to generate a signature.

A network device may generate a signature using its uniquely generated security key. For example, the signature may be expressed as: Authorization=MacAddress“:”Signature“:”ExpirationTime. The Authorization term may be an attribute, and the MacAddress, Signature, and ExpirationTime terms may include values for the Authorization attribute. In particular, the MacAddress value may include the MAC address of the network device, which may include a unique alphanumeric or numeric string. The network device may retrieve its MAC address from memory and place it in the MacAddress field. The Signature value may be expressed as: Signature=Base64(HMAC-SHA1(PrivateKey, StringToSign)). The Signature value may include an alphanumeric or numeric string. HMAC-SHA1 is an open source technique that includes a Hash-based Message Authentication Code (HMAC) using a SHA1 hash function. The HMAC-SHA1 technique uses the values PrivateKey and StringToSign as inputs. The PrivateKey input includes the unique security key that was generated by the server for the network device. The StringToSign input may be expressed as StringToSign=MacAddress+“\n”+SerialNumber+“\n”+ExpirationTime. Accordingly, the StringToSign input is generated by appending a serial number of the network device and an expiration time to the network device's MAC address. The ExpirationTime term may indicate the period of time for which the signature is valid. In some embodiments, the ExpirationTime term may include a current time at which the signature is generated plus period of time for which the signature is valid. In one example, the ExpirationTime term may be expressed as ExpirationTime=Number of seconds since Jan. 1, 1970.

The network device may place the signature in a data packet for transmission with a communication signal to the cloud network server. The network device may also place the network ID in the data packet. The signature and the network ID, if included, may be used by the cloud network server to verify that the network device is associated with the logical network. In some embodiments, a signature is provided with each communication sent from the network device to the server. Once the signature is received by the server, the server generates a signature using the same expression as that used by the network device. For example, the server may retrieve the network device's key and other relevant information from storage and generate the signature using the key and the other information using the expression described above. The server then verifies whether the signatures match. Upon determining that the signatures match, the server authenticates the network device's communication.

An access device may also generate a signature using its uniquely generated security key. For example, the access device signature may be expressed as: Authorization=SDU UniqueId“:”Signature“:”ExpirationTime. The Authorization term may be an attribute, and the SDU UniqueId, Signature, and ExpirationTime terms may include values for the Authorization attribute. The SDU UniqueId term may include a unique access device identifier. The SDU UniqueId value may depend on the type of access device that is used and the type of values that may be accessed and/or generated by the type of access device. In some cases, one type of access device may not allow an application to access a unique identifier of the access device (e.g., a serial number, UUID, or the like). In such cases, the SDU UniqueId value may include a value generated by an application or program installed on and executed on the access device that is used to access the network device. The value may be unique to the application or program that generated the value. In other cases, another type of access device may allow an application to access a unique identifier of the access device. In such cases, the SDU UniqueId value may include a value that is unique to the access device itself, such as a serial number, UUID, or the like. In this example, the access device may retrieve the unique value from storage within the access device. It will be appreciated that other unique identifiers may be used to uniquely identify the access device. The Signature value may be expressed as: Signature=Base64(HMAC-SHA1(PrivateKey, StringToSign)). Using this expression, the input to the HMAC-SHA1 technique may include a PrivateKey term and a StringToSign term. The PrivateKey input includes the unique security key that was generated by the server for the access device with regard to a particular logical network. The StringToSign input may be expressed as StringToSign=UniqueId+“\n”+“\n”+Expiration Time. The StringToSign value is different from the StringToSign value generated by network device in that no serial number is included. Accordingly, the StringToSign input is generated by appending an expiration time to the access device's unique identifier. The ExpirationTime term may indicate the period of time for which the signature is valid, similar to that above for the signature generated by the network device.

The access device may place the signature in a data packet and may transmit the data packet to the cloud network server with a communication signal. The network device may also place the network ID in the data packet. The signature and the network ID, if included, may be used by the cloud network server to verify that the access device is associated with the logical network and authorized to communicate with one or more network devices associated with the logical network. In some embodiments, a signature is provided with each communication sent from the access device to the server. The cloud server may receive the signature and may generate a signature using the same expression as that used by the access device. For example, the server may retrieve the access device's key and other relevant information from storage and generate the signature using the key and the other information using the expression described above. The server then verifies whether the signatures match. Upon determining that the signatures match, the server authenticates the access device and allows it to communicate with one or more of the network devices associated with logical network.

Once the provisioning process is completed, the access device 108 may access the network device 102 locally via the gateway 110 (e.g., communication signal 118) or remotely via the cloud network 114 (e.g., communication signal 120). In some embodiments, the communication between the access device 108 and the cloud network 114 may be a HTTP or HTTPS communication. It will be appreciated that other communication mechanisms may be used to communicate between the access device 108 and the cloud network 114.

The network 100 may enable a user to monitor and/or control operation of the devices 102 and 104. For example, a user may monitor and/or control operation of devices by interacting with a visual interface of the gateway 110 (i.e., a web page for gateway 110) and/or a visual interface rendered on a display of an access device, such as access device 108. In some embodiments, an application may be run on the access device. The application may cause the access device to present a graphical interface that includes a visual interface for each device accessible on the network 100.

A network device may generate and/or provide a “status” of the network device. In certain embodiments, the status or state of a network device can be indicated on a visual interface on the access device, for example within the tile with text and/or graphically. The status of the network device can change based on time (e.g., a period, an interval, or other time schedule). The status of a network device may be any piece of information pertinent to that particular network device. The status of a network device may be any changeable variable of that particular network device. For example, the status of a network device may include a state of the network device itself (e.g., on or off) or how the network device is situated within the network with respect to the other network and other network devices throughout the network. For example, the status of a network device may refer to the network device's proximity to another network device and/or its ability to communicate with another network device because of the relative signal strength between the two network devices. In certain embodiments, the status can include a value or some other information indicating a unit of measure for a setting or an attribute related to operation of a device connected to the network device. The setting or the attribute can be adjustable within a range of values. For example, the device connected to the network device can be a light bulb and the status can include a value corresponding to brightness (e.g., a percentage of total brightness) emitted by the light bulb when the light bulb is powered-on. In another example, the device can be a motion sensor and the status can include a value corresponding to sensitivity of the sensor in a range of values between 0 to 100 when the sensor is powered on. In yet another example, the device can be a fan and the status can include a value corresponding to a speed of the fan on a scale of 0 to 100 when the fan is powered-on.

As described above, upon being powered on or reset, the network devices 102 and/or 104 may be registered with the cloud network 114 and associated with a logical network within the local area network 100. Similarly, upon being powered or switched off or otherwise being disconnected from the network 100, the status of the-network device 102 would be known and stored by a cache (not shown) associated with the network 100. For example, cloud network 114 may include storage (e.g. cache) that stores the status of the network devices within each local area network 100 it is connected to and/or provides access to. In another example, the gateway 110 may include storage that stores the status of the network devices within each local area network it is connected to and/or provides access to. More specifically, the status stored in the cache may include a status table which indicates the current status of each network device (as of its last communication with each network device). A status table may include all statuses of each network device, or individual storage tables for each local area network or other subset of its network devices/networks. In one embodiment, a change in status may prompt the-network device to push its change in in status to the cloud network 114 for storage or updating of the cloud's stored status table. In another embodiment, cloud network 114 and/or gateway 110 may continuously (or periodically) communicate with each-network device to check to see if its status has changed.

In some embodiments, a network device (e.g. network device 102 and/or 104) may, upon connecting to the local area network 100, check the status of the network devices on the network 100. In other embodiments, one network device may check the status of one or more of the other network devices on the network 100. The network device may seek to check the status of another network device or access device for various reasons, including to display such status(es) to a user on a display or otherwise, to check whether that network device belongs to the same network, to synchronize or coordinate any scheduled executions, to update an attribute based on adjustments received, among others. For example, a network device or user may desire to check various statuses on a connected device, such as power level, timestamped activity history (e.g. temperature for a thermostat, motion for a motion detector, etc.), how long it has been active/turned on, attributes for operation of the connected device (e.g., a brightness of a lamp, a speed of a fan, or a sensitivity of a sensor, etc.), among many others.

In some embodiments, a device, such as the access device 108 shown in FIG. 1 or the gateway 110, connected to the network 100 can communicate an updated status of a network device, such as the network devices 102 and/or 104. The updated status can be communicated via the network 100 and can include an adjustment that affects a status of the network device. The adjustment can include an amount of change to one or more attributes, one or more settings, or a combination thereof related to operation of the network device connected to the network 100. The access device 108 or the gateway 110 can present a graphical interface that can receive input corresponding to an adjustment to a status of a device. In some embodiments, the updated status of the network device communicated to the network 100 can be received by a network device to which the updated status applies, or can be received by the gateway 110, the cloud network 114, or any other device in communication with the network. If the device cannot directly receive the updated status, it can also/alternatively receive the updated status from the cloud network 114, the gateway 110, or the other devices in the network 100. In some embodiments, the network device can communicate its updated status to the network 100, which can indicate whether the status has been updated. The updated status can be received by the access device or any other device in the network 100. In some embodiments where the access device is not located within the network 100, the access device may not immediately receive the updated status. The updated status can be stored by the cloud network 114 or the gateway 110 for communication to the access device. The status of the network device can indicate whether an adjustment was made based on an adjustment in a setting or an attribute transmitted by the access device. Alternatively, or additionally, the access device can receive, from any other network device connected to the network 100, a status update indicating whether the adjustment was in fact made at a network device.

A network device seeking to check the status of any other device on the network 100 may communicate with the cloud network 114, to which all devices on the network 100 are connected either directly or indirectly. Since the cloud network 114 and/or the gateway 110 can store an updated table/list of the statuses of each of the network devices 102 and 104 within the requesting network's local area network, the cloud network 114 and/or gateway 110 may communicate such status data to the network devices 102 and 104 and the access device. For example, if network devices 102 and 104 were to each turn on and communicate their statuses to cloud network 114, cloud network 114 may analyze the status of network devices 102 and 104 and communicate to network devices 102 and 104 that they are each connected to the same local area network 100.

As previously described, the access device, when located within range of the local area network, may be authenticated using accountless authentication that is based on the access device's authentication with the logical network. For example, if the access device has authorized access to the logical network (e.g., a WiFi network provided by a gateway), the network devices paired with that logical network may allow the access device to connect with them without requiring a network device login. Accordingly, the network device may perform accountless authentication of access devices that have authorization to access the logical network without requiring a user to provide login credentials for the network devices. While located remotely, the access device may also be authenticated to access the network devices via the cloud network using an accountless authentication process. For example, the network ID and the access device's unique security key may be used to allow the access device to communicate with the network devices via the cloud network (e.g., by generating a signature as described above).

When the access device 108 is located within range of both gateways 110, 112 in the local area network 100, the access device 108 does not encounter any issues when attempting to access any of the network devices 102, 104, 106. For example, the access device 108 may perform UPnP discovery and may list all of the network devices 102, 104, 106 that have responded to the discovery request regardless of which network ID the network devices 102, 104, 106 have. Accordingly, the existence of the first and second logical networks with first and second network IDs does not lead to any issues when the access device 108 is located within the local area network 100. However, when the user is located remotely, the access device 108 may only be associated with one logical network at a time. For example, the access device 108, while located remotely from the local area network 100, may query the cloud server with a known network ID (e.g., the first or second network ID). In response, the server will only return the network devices associated with that network ID. As a result, the user will not be able to see all network devices within the user's local area network 100.

FIG. 3 shows a process 300 for providing a visual interface module for controlling a network device. As shown, the process 300 may be performed by one or more computing devices, such as network device 102, a server associated with cloud network 114, or access device 108 described above with reference to FIG. 1. In some embodiments, the network device 102 is associated with a home automation network, such as the local area network 100 described above with respect to FIG. 1. Process 300 is illustrated as a data flow diagram, the operation of which represents operations that can be implemented in hardware, computer instructions, or a combination thereof. Gateway 110 is connected to cloud network 114, and allows network device 102 to connect to the cloud network 114, the Internet, or other external networks via gateway 110. In some embodiments, the network device 102 may be a home automation network device that allows a user to access, monitor, control, and/or configure various electronic devices such as home appliances located within the user's home including, but not limited to, a television, radio, light bulb, microwave, iron, fan, space heater, sensor, and/or the like. In some embodiments, the user can monitor and control network devices by interacting with a visual interface rendered by the gateway 110 (i.e., a web page for gateway 110), a visual interface rendered on display 322 of the access device 108, or a visual interface rendered by the network device 102.

In an embodiment, an application may be run on the access device 108. The application may cause the access device 108 to present a display 322 with a modular visual interface for each network device accessible on the local area network 100. When the application is run on the access device 108, the access device 108 can access a cache 302.

The cache 302 can be a local cache located in onboard storage of the access device 108. The cache 302 can contain a known interface list 320 with records 324, 326 and 328 including interface information for different, known types of network devices. As shown, each of records 324, 326 and 328 can include a device type, a unique interface module ID, and controls information. The known interface list 320 can include a record for each device known by the access device 108 to exist on the local area network 100. When the application is run on the access device 108, the access device 108 can access the known interfaces 320 in the cache 302 to present the display 322, which lists modular interfaces for each network device on the local area network 100. In an example, the display 322 can include a modular tile for each connected network device having an interface in the known interface list 320. Exemplary communications used to populate cache 302 are described in the following paragraphs.

The process 300 can include utilizing communication 306 to register a visual interface module for a network device 102 with a server of cloud network 114. For simplicity, communication 306 is shown as a direct communication between network device 102 and cloud network 114. However, it is to be understood that, in an embodiment, communication 306 can be sent from a manufacturer of network device 102 to cloud network 114. In an additional or alternative embodiment, communication 306 is sent from third party interface developer to cloud network 114. For example, a third party developer of a visual interface module for network device 102 may initiate communication 306 to cloud network 114. In the example of FIG. 3, communication 306 includes registration information for the network device 102. For example, communication 306 can include a unique device ID for network device 102. In some embodiments, the registration information may identify one or more capabilities of network device 102. The registration information can include a unique identifier for the network device, a default name of the network device, one or more capabilities of the network device, and one or more discovery mechanisms for the network device. In one example, communication 306 can include a resource bundle corresponding to network device 102. The resource bundle can be embodied as a structured folder structure whose contents define all visual and interactive elements/areas in a tile. For example, a resource bundle can be a zip file sent from a device manufacturer or a third party developer that is submitted or uploaded to cloud network 114. The resource bundle includes a unique device ID and files defining graphical content of a visual interface module. The graphical content can include definitions of interactive elements/areas for the interface module. The resource bundle can include templates defining interactive control states for each of the interactive elements, language translations for tile text, any menus for the tile, and graphical content of the menus. For example, the resource bundle can define templates, text, and graphical content using a markup language, such as HTML5.

At 306, the process 300 includes transmitting an indication that network device 102 is associated with the network. For example, network device 102 may transmit the indication to the server of the cloud network 114. In some embodiments, transmitting may include transmitting a unique identifier (ID) for the network device 102. For example, the network device 102 may send a communication to the server indicating a unique interface module ID for the network device 102. In such embodiments, the server may then determine that a match between the unique interface module ID and a known interface exists. The cloud network 114 can include a data store 304 of known interfaces. The access device 108 can download a visual interface module identified in data store 304 from the cloud network 114, which can be used to render a modular interface within display 322. In an embodiment, data store 304 can be a tile database where each record in the database is uniquely identified by a tile ID.

Cloud network 114 can use the unique device ID to determine an interface module for network device 102. As shown in FIG. 3, cloud network 114 can access a data store 304 of visual interface modules. A plurality of uniquely identified interface modules can be stored in data store 304. For example, each interface module in data store 304 can be associated with a unique interface module ID. In an embodiment, data store 304 is a database configured to store modular tiles for a plurality of network devices, with each of the stored modular tiles being identified by a unique tile ID. For instance, the network device 102 having a unique device identifier may be matched with an existing interface module based on comparing information received from the network device 102 with information stored in data store 304. In cases where an existing interface module for network device 102 is not found in data store 304, cloud network 114 can use information in a resource bundle for the network device 102 to generate an interface module, where the resource bundle is provided as part of a registration process for a given network device. The generated interface module can then be stored in data store 304 and assigned a unique interface module ID. In some embodiments, information in the resource bundle can be used to update an existing interface module stored in data store 304. After determining the interface module for network device 102, cloud network 114 sends communication 308 to network device 102 in order to provide a unique interface module ID to the network device 102. In one embodiment, communication 308 can include a unique tile ID corresponding to a modular tile for network device 102 that is stored in data store 304. In some embodiments, communication 308 includes a unique tile ID corresponding to a modular tile defined for network device 102. Upon receiving communication 308 with the unique interface module ID (i.e., a unique tile ID), the network device 102 can store the unique interface module ID. In one embodiment, for example, the unique interface module ID can be stored by an interface device 301 of the network device 102 that is configured to provide the interface module ID to an access device or gateway. In an embodiment, the interface device 301 is implemented as a “smart module” in hardware and firmware, such as, for example, a system on a chip (SOC) integrated into the network device 102.

The interface device 301 can include flash memory and dynamic random access memory (DRAM). The flash memory may be used to store instructions or code relating to an operating system, one or more applications, and any firmware. The flash memory may include nonvolatile memory so that any firmware or other program can be can updated. In the event the interface device 301 loses power, information stored in the flash memory may be retained. The DRAM of the interface device 301 may store various other types of information needed to run the interface device 301, such as all runtime instructions or code. The flash memory or DRAM or a combination thereof may include all instructions necessary to communicate with network device 102.

The process 300 can include sending, from the access device 108, intra-network communication 310 including a query, to the network device 102. The query can be a request for information such as a query for capabilities, a request for an identity of the network device 102, and/or a request for a unique interface module ID. For example, communication 310 can be sent from access device 108 to network device 102 to query network device 102 about its identity. In response to the query sent from access device 108, the process 300 can include receiving intra-network communication 312 at the access device 108 with device information for the network device 102. According to an embodiment, in response to the query, the network device 102 can send communication 312 to inform the access device 108 of the identity and/or capabilities of the network device 102. For instance, in response to receiving the query, the network device 102 may send communications 312 to the access device 108 with at least a unique interface module ID. The process 300 can include utilizing intra-network device communications 310 and 312 as part of a discovery process for the network device 102. For example, when the network device 102 is initially connected to the network, it and access device 108 can automatically exchange communications 310 and 312 to provide the access device 108 with information that can be used to determine a basic, default visual interface stored in cache 302.

Within the context of a modular tile framework, embodiments can dynamically render a functional user interface without having to download the appropriate interface template from a remote server, such as a server associated with the cloud network 114, in order to control a newly discovered network device. These embodiments can be used in cases where a connection to the Internet or the cloud network 114 is unavailable or unreliable, and immediate use of a newly discovered network device is desired. In this case, an application on the access device 108 or a stationary device such as gateway 110 could, based on certain information received from the network device 102, dynamically render a functional interface for immediate use. Such a functional interface may not be the ideal, visually optimized, interface that is downloadable from the cloud network 114. However, such a functional interface will suffice until the application is able connect to the Internet and/or the cloud network 114 and subsequently download the appropriate and visually optimized interface module for the network device 102.

In some embodiments, communication 312 may be received when the network device 102 is rebooted (e.g., powered on, reset or restored to default settings, or the like). For example, when the network device 102 is rebooted, it may broadcast one or more messages on the local area network 100 to discover whether there are any access devices in the local area network 100. For example, communication 312 may be broadcast according to a UPnP protocol during a discovery process. The network device 102 may receive communications 310 from access device 108 indicating that it is located within the local area network 100 and interrogating network device 102 about its functionalities. That is, after receiving a broadcast message from network device 102, access device 108 may then query network device 102 by sending communication 310 in order to receive the communication 312 including information about the network device.

After receiving communication 312, if the access device 108 can access the cloud network 114, it sends a communication 314 to the cloud network 114 as a request for an interface module for the network device 102. Otherwise, if the access device 108 cannot access the cloud network 114, the access device 108 looks up the unique interface module ID received from the network device 102 in cache 302. As discussed above, cache 302 can be a local cache stored on the access device 108. Basic properties for known interfaces can be stored in cache 302 as a device type and controls information. These basic properties can include, for example, a default icon, a default name, and interactive elements or interactive areas for controlling one or more primary functionalities of a network device. The primary functionalities can include, for example, powering the network device on and off. The basic properties can also include controls information for secondary functionalities.

In some embodiments, when the access device is connected to the cloud network 114, the access device 108 sends communication 314 to query the cloud network 114 about network device 102. The communication 314 can include at least the unique interface module ID for the network device 102. At this point, the cloud network 114 can compare the unique interface module ID of the network device 102 to known interface module IDs stored in data store 304 in order to determine that there is a match between the unique interface module ID sent with communication 314 and a known interface module. If the cloud network 114 finds an interface module in its data store 304, it transmits the interface module to the access device 108 via communication 316. For example, if the access device 108 is currently using a default interface module for network device 102 that was determined based on exchanging communications 310 and 312, and then subsequently is able to connect to the cloud network 114, communications 314 and 316 between the access device 108 and the cloud network 114 can be used to obtain an updated interface module for the network device 102.

Upon receiving communication 316 from the cloud network 114, the access device 108 populates a record in cache 302 corresponding to the network device 102 with device type and controls information received via communication 316. That is, when the access device is remote from the local area network 100, it can exchange communications 314 and 316 with the cloud network 114 to receive an interface module for a network device. Information received via communications 316 can be used to populate records of cache 302. Records in cache 302 can be updated using modular interfaces received via communication 216. In additional or alternative embodiments, new records can be created in cache 302 when communication 316 includes a modular interface for a newly discovered network device.

Records 324, 326, 328 in cache 302 store network device types, unique interface module IDs, and control information for known network devices. The access device 108 uses the records in cache 302 to render visual interfaces in the display 322. For example, the display 322 can include a navigable list of modular tiles corresponding to network devices in the local area network 100.

Display 322 can also include an indicator representing a state of network device 102. In embodiments, communications 312 and/or 314 can include a last known state of the network device 102 and/or historical data associated with the network device 102. In one embodiment, such state information can be based on information received via communication 312 from the network device 102 when the access device 108 is connected to the local area network 100. In this way, display 322 of the access device 108 can reflect a current state and historical data for the network device 102 when the access device is not connected to the local area network 100. In additional or alternative embodiments, the state information can be based on information received via communication 316 from the cloud network 114 when the access device 108 is connected to the cloud network 114. Using the state information, an interface module or tile for the network device 102 within display 322 can indicate an “on” or “off” state for the network device 102 when the network device is powered on or off.

FIG. 4 illustrates an example of a network 400, according to embodiments of the present invention. Specifically, the network 400 can be a wireless local area network enabling an access device to communicate with network devices to control adjustment of attributes related to operation of the network devices. Network 400 includes network device 402, network device 404, network device 406, and network device 408. The network 400 also includes access device 108. In other words, the network 400 may be substantially similar to the network 100 except that access device 108 has been turned on near the network 400, to which it is associated, or has entered an area to which the network 400 can reach.

When access device 108 can enter the network 400 as shown in FIG. 4, access device 108 may be authenticated based on the access device's authentication with the logical network or may otherwise commence communication with cloud network 114. Access device 108 may also communicate notification of its presence or other information directly to other network devices 402-408 within network 400, as shown in FIG. 4 by communication paths 430. As noted, such communication may include various communications protocols, such as Universal Plug and Play (UPnP), Bluetooth®, Zigbee®, Ultra-Wideband (UWB), WiFi-Direct, WiFi, Bluetooth® Low Energy (BLE), sound frequencies, and/or the like. For example, access device 108 may communicate to all other devices in network 400, including network device 402, network device 404, network device 406, and network device 408, information/data regarding its status. Such status data may include the fact that it is present and turned on, or other status data/information. At any time that network devices 402, 404, 406 and 408 recognize that access device 108 is present at network 400, the network devices may communicate back to access device 108. For example, the network devices may send an acknowledgement (e.g., ACK signal) back to access device 108 to confirm that they received the status data sent by access device 108. The network devices may also send their own status data to access device 108.

While network devices 402-408 and access device 108 may each receive communication from other network devices around the network 400, including the status of each of those network devices, network devices 402-408 and/or access device 108 may be continuously scanning network 400 (including, for example, running discovery algorithms) to determine whether any devices within the network have moved, turned on/off or otherwise added to or subtracted from the network 400, or have otherwise changed statuses.

Since network devices 402-408 and access device 108 may each receive communication from other devices around network 400, including the status of each of those devices, each network device within network 400 may know the status of each other network device in the network 400. For example, access device 108 or devices 402-408 may not be required to communicate with cloud network 114 in order to obtain one or more of such statuses. Since cloud network 114 is an external network and may be remote from network 400, communication between network devices within the network 400 and cloud 114 may take more time than communication between two devices within network 400. For example, communication between devices within network 400 may take anywhere from 1 millisecond to 100 milliseconds, while communication between a device within network 400 and the cloud network 114 may take anywhere from 50 milliseconds to 1 second or more). Furthermore, if a network device is retrieving information from cloud 114, the request must travel from the network device to cloud network 114, and then the information must travel back from cloud network 114 to the network device. This process may double the latency caused by retrieving information with cloud 114. Therefore, devices within the network 400 may choose to send and receive/retrieve statuses directly with other devices within the network 400 instead of communicating such information via cloud network 114. When a network device receives status data from another network device on the device's local area network 400, it may store that status data so that it may retrieve and use that status data at a later time.

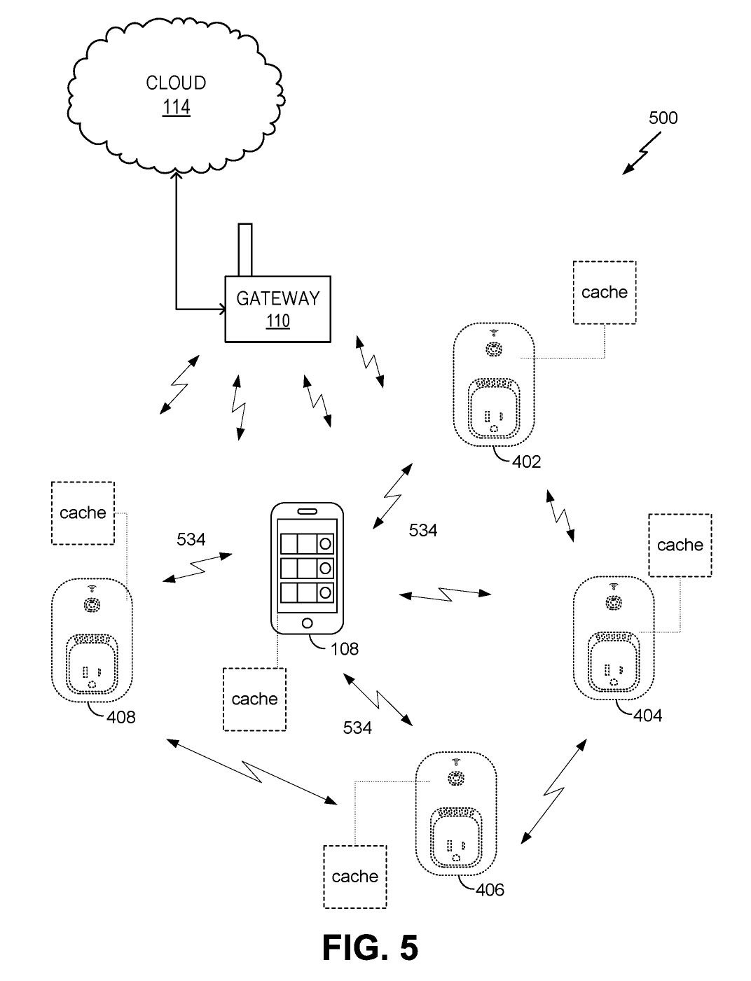

FIG. 5 illustrates an example of a network 500, according to embodiments of the present invention. The local area network 500 may include network device 402, network device 404, network device 406, network device 408, and access device 108. FIG. 5 also illustrates that one or more network devices 402-408 and/or access device 108 may include a storage device, such as a cache, for storing data, including data regarding its own status and data regarding statuses received from the other devices within local area network 500. For example, access device 108 may, after being powered up, broadcast/send its status to network device 408 via communication 534. Network device 408 may store the status data received from access device 108 until the next time access device 108 updates its status by sending new/updated status data to network device 408. Cache may be used for storage within network devices 402-408 and/or access devices within the local area network 500 so that each of the devices may be able to quickly retrieve the data it needs from storage. An application operating on the access device 108 can access the cache to obtain information to display the visual interface for each network device 402-408 registered within the network 500. Although a caching device may be used to store such data within the network and/or access devices within the local area network 500, other types of storage may be used.

The cache can contain a known interface list including interface information for different, known types of devices. The known list can include a record for each network device known by the access device 108 to exist on the network 500. When an application is run on the access device 108, the access device 108 can access the known interfaces in the cache to present the display of access device 108. The display can present one or more visual interfaces, each corresponding to a network device known to exist on the network 500. Each visual interface can be generated based on a visual interface module corresponding to each device on the network 500. In an example, the display can include a visual interface (e.g., a module tile) for each device in the network 500 having an interface in the known interface list.

The cache can also contain known status information about each network device in the known device list. When the application is run on the access device 108, the access device 108 can access the known status information in the cache to present a status display. The access device 108 can populate each tile with an indicator representing the respective known status information for each device in the known device list. The status display can include an indicator of one or more attributes, one or more settings, or a combination thereof related to operation of each device in the network 500. For example, the status display can include a speed of a fan (e.g., a fan speed of 56 in a range of values between 0 and 100) of the network device 402 (e.g., a fan), a value of sensitivity of a sensor (e.g., a value of 34 in a range of values 0-100) for the network device 404 (e.g., a motion sensor), a value of brightness (e.g., 65 percent brightness) for the network device 406 (e.g., a light bulb), and a value of temperature (e.g. a slow cooker). Although shown as having a single indicator for an attribute or a setting related to operation of a network device, the status display can present a plurality of indicators corresponding to different attributes and/or settings related to operation of a network device.

In some embodiments, the cache can include other information about a network device. The other information can indicate a device's firmware version, last known firmware update status, connectivity to cloud status, registration status (e.g., whether the network device has a key or not), and other such information. The cache can include information that could be used for troubleshooting. In embodiments described below, the access device 108 can access status information from another other device on the network 500 and can use that information to update its own cache, update the status display, and/or pass the information to the cloud network 114 and/or the gateway 110 for trouble shooting and/or storage.

Even though each network device may know and store (e.g. in cache) the state of each other network device within local area network 500, a network device may not know when another network device changes status (e.g. turns/powers off). However, network devices and/or access devices within local area network 500 may broadcast/send any updates in its status to other devices on the network. For example, if network device 402 changes status, it may send status data to the other network devices, such as network devices 404, 406 and 408 and to access device 108. However, network device 402 may not know which devices to update since the other devices may change statuses periodically (e.g. turn off).

Therefore, a network or access device may subscribe to another network or access device within local area network 500. For example, network devices 404, 406 and 408 and access device 108 may subscribe to status data notifications/updates from network device 402. Such a subscription may be registered for upon initial connection with network device 402 when network device 402 first enters local area network 500 or at any other time after network device 402 has been associated with local area network 500. Subscriptions may be controlled to last indefinitely or may expire after a certain predetermined period of time after initial subscription. However, network devices may re-subscribe to another network device before or after their previous subscription has expired.

Subscriptions between network device and/or access devices may be registered, similar to registering a network device upon initial entrance into the local area network, including security registrations described herein with respect to FIGS. 1 and 2. For example, a network device may send its unique security key, which it may have stored along with its network ID after being registered on the network, to a network device to which it wants to subscribe. However, subscriptions may take on many other forms, including sending a different form of identification to a network device to which a network device wants to subscribe. However, subscriptions may take on many other forms, including sending a different form of identification to a network device to which a network device wants to subscribe.

Upon receiving a subscription from another network device or access device, the device being subscribed to may store a list of the devices that subscribed to it. For example, network device 402 may store a list of network devices 404, 406 and 408 and access device 108 after those devices subscribe to network device 402. Then, when network device 402 undergoes a change in status, network device 402 may send that change in status to only the devices that had previously subscribed to it but where the subscription had not yet expired. Furthermore, according to some embodiments, the subscription list of a network device may be automatically updated if that device receives notification that another device has left the range of the local area network, either from that device itself or from a different device. Therefore, the various devices within a given local area network, such as network 500, each contain continuously updated statuses of each other device on the network and obtain those statuses and updates through direct communication without necessary use of the cloud.

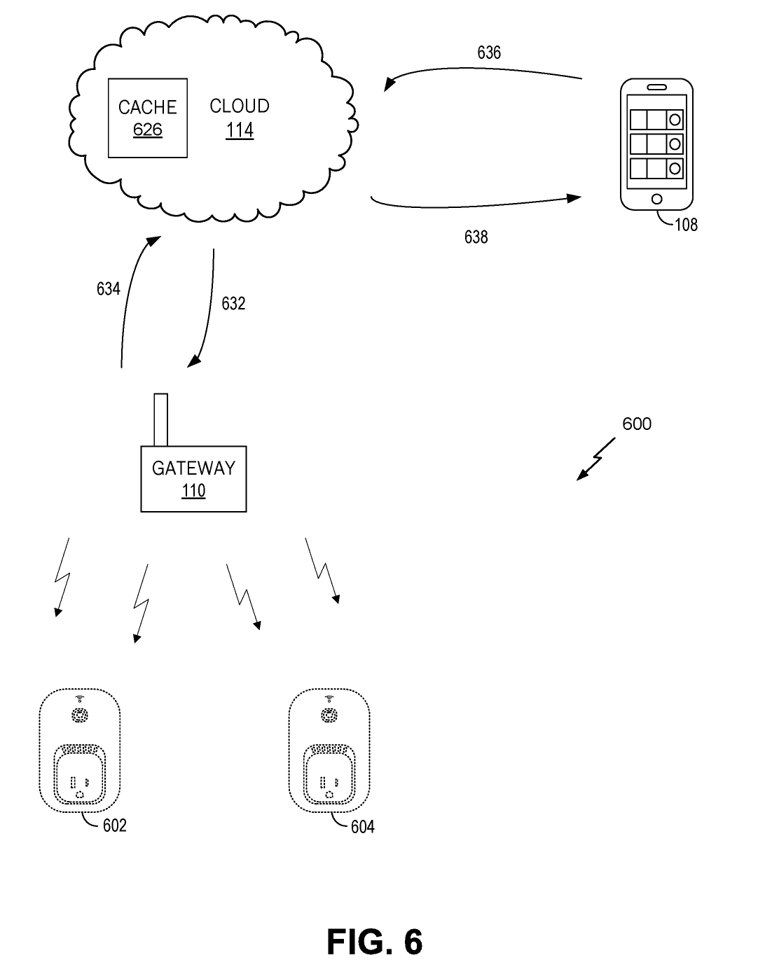

FIG. 6 illustrates an access device 108 that is located remotely from network 600 (e.g. local area network), according to embodiments of the present invention. Local area network 600 includes gateway 110 and network devices 602 and 604 (which may be, for example, the same as any of network devices 402-408 in FIGS. 4 and 5), as shown in FIG. 6. However, network 600 may also include a variety of other network devices and one or more access devices directly connected to network 600. Gateway 110 is connected to cloud network 114, and allows network devices 602 and 604 to connect to cloud 114, the internet, or other external networks via gateway 110. In some embodiments, the network devices 602 and 604 may include home automation devices that allow a user to access, control, and/or configure various home appliances located within the user's home, such as a television, radio, light, microwave, iron, and/or the like.

Access device 108 is not directly connected to network 600. Instead, access device 108 is external to network 600 and may connect to cloud network 114 and to network 600 via cloud network 114. As noted, network devices 602 and 604 may change status on a periodic basis. In some embodiments, even when external to and not directly connected to network 600, an access device may request to check the status of the devices on the network. When access device 108 seeks to check the status of any device on the network, the access device 108 may transmit/send a communication 636 to the cloud network 114, to which all devices on the network are connected either directly or indirectly via gateway 110. Since the cloud network 114 stores an updated table/list of the statuses of each of the devices within the requesting access device's network, the cloud network 114 may transmit a communication 638 of such status data to the access device 108. For example, after network devices 602 and 604 are turned on, authenticated and are a part of network 600, network devices 602 and 604 may communicate their statuses to cloud network 114. Furthermore, any time the status of network devices 602 and 604 changes, the device that incurred a status change may push/send information (e.g. an indication) of that status change to cloud network 114. Cloud network 114 may store, in cache 626 or otherwise, the statuses (which may be time stamped in metadata or otherwise) of network devices 602 and 604. Therefore, when access device 108 requests from cloud network 114 the statuses of devices on network 600, cloud 114 may send its most recently stored/updated statuses to access device 108.

To obtain the most updated status data of devices within network 600, cloud 114 may, upon receiving a request for status data related to network devices 602 and 604, transmit/send a communication 632 (e.g. request, query, etc.) for such status data to network devices 602 and 604 via gateway 110. Once network devices 602 and 604 receive this request, network devices 602 and 604 may send a communication 634 (e.g. updated status data) to cloud 114 to replace the previously stored/cached statuses in cache 626. Upon receipt of updated status data in communication 634 from network 600, cloud 114 may send a communication 638 of such status data to the access device 108.

However, the process of cloud network 114 requesting updated statuses from network devices 602 and 604 within network 600 may cause latency within the system. More specifically, the time required for cloud network 114 to request updated statuses from network devices 602 and 604 and to in turn receive updated statuses from network devices 602 and 604 may be substantially greater than the time required for cloud network 114 to send its currently stored statuses (without being updated) for network devices 602 and 604 to access device 108. For example, of the total time required for access device 108 to receive updated statuses from cloud network 114, 80% or more of that total time may include cloud network 114 requesting updated statuses from network devices 602 and 604. On the other hand, of the total time required for access device 108 to receive updated statuses from cloud network 114, 20% or more of that total time may include the status data being transmitted from cloud network 114 to access device 108. Since a majority of the process required for access device 108 to request and receive status data for network devices 602 and 604 is the transmission of data between cloud 114 and network devices 602 and 604, the access device 108 and cloud network 114 may maximize efficiency by minimizing the effect of the transmission of data between cloud 114 and network devices 602 and 604 on the whole process/system.

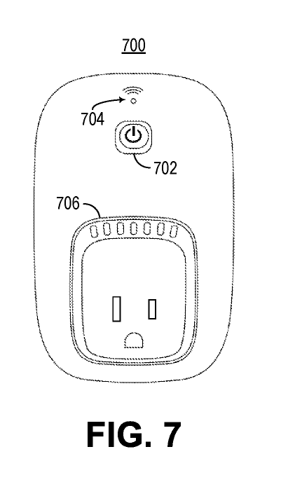

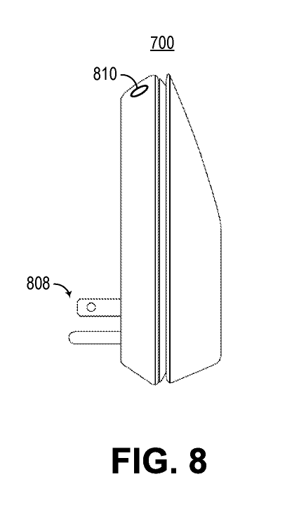

FIG. 7 illustrates an example of a front view of a network device 700. FIG. 8 illustrates an example of a side view of the network device 700. The network device 700 may include any of the network devices 102, 104, or 106 described herein. In some embodiments, the network device 700 may be a home automation network device. For example, the network device 700 may include a home automation switch that may be coupled with a home appliance. A user may wirelessly access the network device 700 in order to access, control, and/or configure various home appliances located within the user's home. For instance, the user may remotely control appliances such as a television, radio, light, microwave, iron, space heater, wall A/C unit, washer, dryer, fan, and/or the like.

In some embodiments, the network device 700 may include a WiFi enabled switch that connects home appliances and other electronic devices to a compatible 802.11b/g/n/ac WiFi network. The network device 700 may thus allow users to locally or remotely turn devices on or off from anywhere, program customized notifications, and/or change device status. The network device 700 may further allow a user to create custom schedules or have devices respond to sunrise or sunset.

The network device 700 includes a power button 702 that may be depressed in order to turn the network device 700 on and off. In some embodiments, a light source may be integrated with or located behind the power switch. For example, a light-emitting diode (LED) may be located on a circuit board under the power button 702. The light source may be illuminated when the network device 700 is powered on, and may not be illuminated when the network device 700 is powered off.

The network device 700 further includes a communications signal indicator 704. The signal indicator 704 may indicate whether the network device 700 has access to a communications signal, such as a WiFi signal. For example, the signal indicator 704 may include a light source (e.g., a LED) that illuminates when the network device 700 is connected to a communications signal. The light source may depict different colors or other characteristics (e.g., flashing, dimming, or the like) to indicate different levels of signal strength or mode of operation.

The network device 700 includes a restore button 810. The restore button 810 may allow a user to reset the network device 700 to factory default settings. For example, upon being depressed, the restore button 810 may cause all software on the device to be reset to the settings that the network device 700 included when purchased from the manufacturer.

The network device 700 further includes a plug 808 and an outlet 706. The plug 808 allows the network device 700 to be plugged into a wall socket, such as a socket providing AC at 120 V, 220 V, or the like. In turn, an appliance may be plugged into the outlet 706. Once the network device 700 is registered according to the techniques described above, an appliance plugged into the outlet 706 may be controlled by a user using an access device (e.g., access device 108).

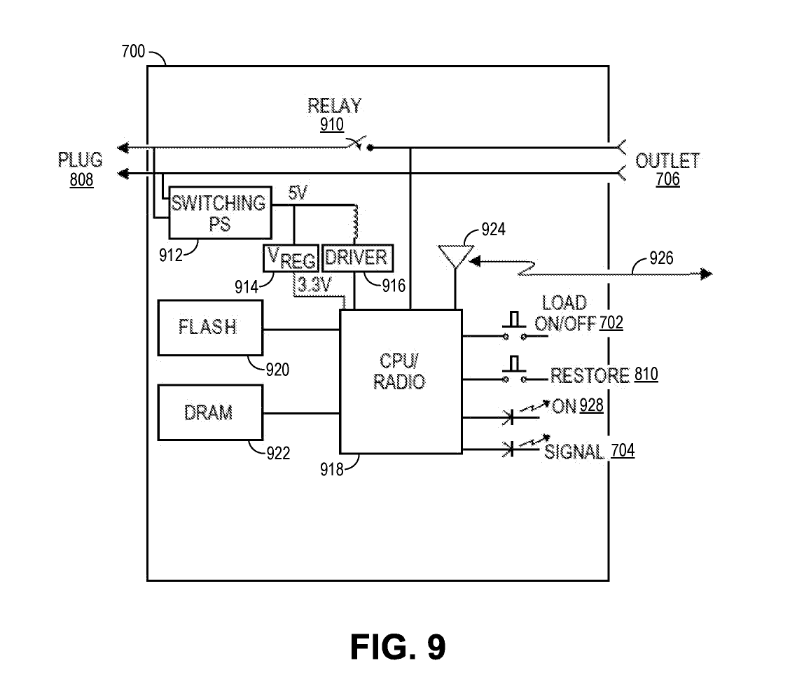

FIG. 9 is an example of a block diagram of the network device 700 depicting different hardware and/or software components of the network device 700. As described above with respect to FIGS. 7 and 8, the network device 700 includes the outlet 706, the plug 808, the power button 702, the restore button 810, and the communications signal indicator 704. The network device 700 also includes light source 928 associated with the power button 702. As previously described, the light source 928 may be illuminated when the network device 700 is powered on.

The network device 800 further includes a relay 910. The relay 910 is a switch that controls whether power is relayed from the plug 808 to the outlet 706. The relay 910 may be controlled either manually using the power button 702 or remotely using wireless communication signals. For example, when the power button 702 is in an ON position, the relay 910 may be closed so that power is relayed from the plug 808 to the outlet 706. When the power button 702 is in an OFF position, the relay 910 may be opened so that current is unable to flow from the plug 808 to the outlet 706. As another example, an application or program running on an access device may transmit a signal that causes the relay 910 to be opened or closed. For instance, an access application may display a graphical interface on the access device that includes a power button. The user may tap or otherwise select the power button, and the access application may send a communication signal (e.g., over a WiFi network) to the network device 700 instructing the network device 700 to open or close the relay 910.

The network device 700 further includes flash memory 920 and dynamic random access memory (DRAM) 922. The flash memory 920 may be used to store instructions or code relating to an operating system, one or more applications, and any firmware. The flash memory 920 may include nonvolatile memory so that any firmware or other program can be can updated. In the event the network device 700 loses power, information stored in the flash memory 920 may be retained. The DRAM 922 may store various other types of information needed to run the network device 700, such as all runtime instructions or code.

The network device 700 further includes a CPU/Radio 918. The CPU/Radio 918 controls the operations of the network device 700. For example, the CPU/Radio 918 may execute various applications or programs stored in the flash memory 920 and/or the dynamic random access memory (DRAM) 922. The CPU/Radio 918 may also receive input from the various hardware and software components, interpret the input, and perform one or more functions in response to the input. As one example, the CPU/Radio 918 may determine whether the power button 702 has been pressed, and determines whether the relay 910 needs to be opened or closed. The CPU/Radio 918 may further perform all communications functions in order to allow the network device 700 to communicate with other network devices, one or more gateways, a cloud network, and/or one or more access devices. While the CPU and radio of the network device 700 are shown to be combined in the CPU/Radio 918, it will be appreciated that, in some embodiments, the CPU and radio may be separately located within the network device 700. For example, CPU circuitry may be situated at a separate location on a circuit board from the location of radio circuitry, the CPU circuitry may be located on a different circuit board from the radio circuitry, or the like. Further, the network device 700 may include multiple radios that are configured to communicate using one or more communication protocols, such as any combination of a WiFi™ transceiver radio, a Bluetooth™ transceiver radio, a Zigbee™ transceiver radio, a UWB transceiver radio, a WiFi-Direct transceiver radio, a BLE transceiver radio, and/or any other wireless network transceiver radio or interface. In some embodiments, the network device 700 does not include a cellular network transceiver radio or interface, and thus may not be configured to directly communicate with a cellular network. In some embodiments, the network device 700 may include a cellular network transceiver radio, and may be configured to communicate with a cellular network using the cellular network transceiver radio.

The network device 700 may communicate with other devices and/or networks via antenna 924. For example, antenna 924 may include a 2.4 GHz antenna, a 5 GHz antenna, or the like, that can transmit and receive WiFi communications signals. The network device 700 may include other types of antennas that can communicate Bluetooth® signals, Zigbee® signals, Ultra-Wideband (UWB) signals, WiFi-Direct signals, BLE signals, and/or the like. In some embodiments, the antenna 924 may be configured to communicate different types of signals, such as the WiFi signals, Bluetooth® signals, Zigbee® signals, UWB signals, WiFi-Direct signals, BLE signals, and/or the like. In some embodiments, the network device 700 may include multiple antennas for communicating the different types of communication signals. As one example, the network device 700 may include both a 2.4 GHz antenna and a 5 GHz antenna.

The network device 700 further includes a driver 916, a switching power supply 912, and a voltage regulator 914. The driver 916 may include instructions or code that can be used to translate control signals or commands received from applications running on the DRAM 922 to commands that the various hardware components in the network device 700 can understand. In some embodiments, the driver 916 may include an ambient application running on the DRAM 922. The switching power supply 912 may be used to transfer power from the outlet in which the plug 808 is connected to the various loads of the network device 700 (e.g., CPU/Radio 918). The switching power supply 912 may efficiently convert the voltage and current characteristics of the electrical power to a level that is appropriate for the components of the network device 700. For example, the switching power supply 912 may perform AC-DC conversion. In some embodiments, the switching power supply 912 may be used to control the power that is relayed from the plug 808 to the outlet 706. The voltage regulator 914 may be used to convert the voltage output from the switching power supply 912 to a lower voltage usable by the CPU/Radio 918. For example, the voltage regulator 914 may regulate the DC voltage from 5 V to 3.3 V.

In various embodiments, functions may be stored as one or more computer-program products, such as instructions or code, in a non-transitory machine-readable storage medium, such as the flash memory 920 and/or the DRAM 922. The network device 700 can also comprise software elements (e.g., located within the memory), including, for example, an operating system, device drivers, executable libraries, and/or other code, such as one or more application programs, which may comprise computer programs implementing the functions provided by various embodiments, and/or may be designed to implement methods and/or configure systems, as described herein. Merely by way of example, one or more procedures described with respect to the processes discussed above, for example as described with respect to FIG. 2, may be implemented as code and/or instructions executable by a computer (and/or a processor within a computer); in an aspect, then, such code and/or instructions can be used to configure and/or adapt a computer (or other device) to perform one or more operations in accordance with the described methods. Such functions or code may include code to perform the steps described above with respect to FIG. 2. The memory, such as the flash memory 920 and/or the DRAM 922, may be a processor-readable memory and/or a computer-readable memory that stores software code (programming code, instructions, etc.) configured to cause a processor(s) within the CPU/Radio 918 to perform the functions described. In other embodiments, one or more of the functions described may be performed in hardware.

A set of these instructions and/or code might be stored on a non-transitory machine-readable storage medium, such as the flash memory 920 and/or the DRAM 922. In some cases, the storage medium might be incorporated within a computer system, such as the CPU/Radio 918. In other embodiments, the storage medium might be separate from a computer system (e.g., a removable medium, such as a compact disc), and/or provided in an installation package, such that the storage medium can be used to program, configure and/or adapt a computer with the instructions/code stored thereon. These instructions might take the form of executable code, which is executable by the network device 700 and/or might take the form of source and/or installable code, which, upon compilation and/or installation on the network device 700 (e.g., using compilers, installation programs, compression/decompression utilities, etc.) then takes the form of executable code.

It should be appreciated that the network device 700 may have other components than those depicted in FIGS. 7-9. Further, the embodiment shown in the figures are only one example of a network device that may incorporate an embodiment of the invention. In some other embodiments, network device 700 may have more or fewer components than shown in the figure, may combine two or more components, or may have a different configuration or arrangement of components.

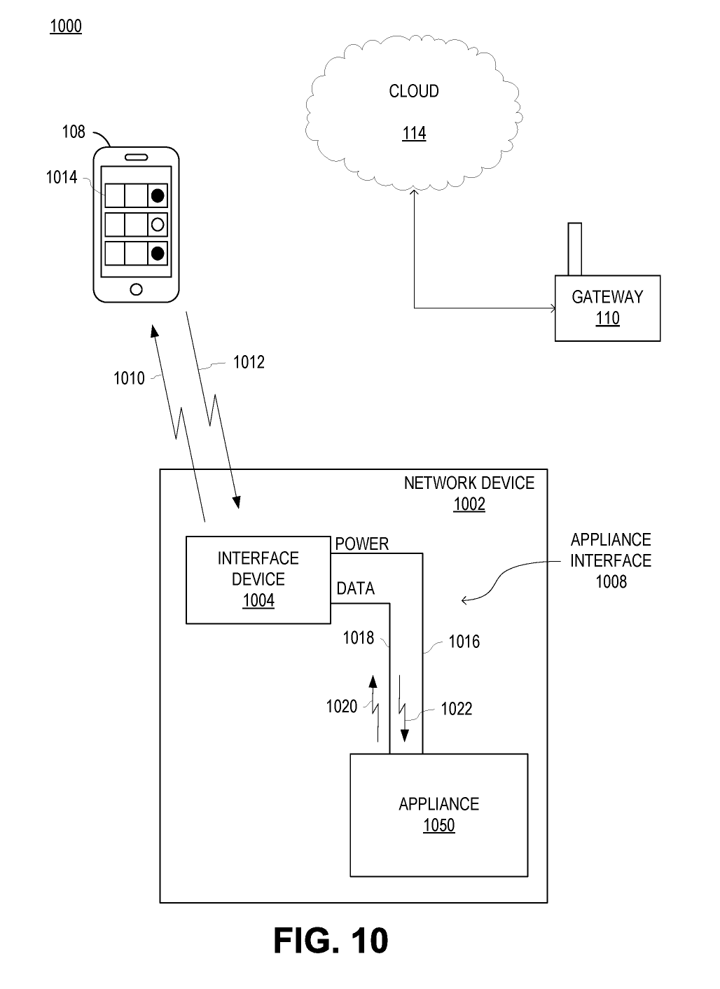

FIG. 10 is a schematic illustration of a local area network 1000 including a network device 1002 that includes an appliance 1050. The network device 1002 can comprise an interface device 1004 and the appliance 1050 connected by an appliance interface 1008. The appliance interface 1008 can include a data connection 1018 and a power connection 1016. The data connection 1018 can be a serial connection (e.g., RS-232, USB, or other), or any other suitable data connection. The interface device 1004 can be fully powered by the network device 1002 through the power connection 1016, or can have a separate source of power.

The appliance 1050 can be any suitable electric device, such as a crock pot, a space heater, an iron, a washing machine, a dishwasher, a lamp, a radio, a computer, an amplifier, or another electrical device. Additional examples of suitable electrical devices include electrical devices incorporated into or with non-electrical devices, such as an actuator system in an electrically-actuated deadbolt, a sensing system in a seat cushion, or other suitable electrical device incorporated into or with a non-electrical device. The appliance 1050 can be adapted to operate with the interface device 1004. The appliance 1050 can be any finite state machine. The appliance 1050 can, but need not, know or store one or more states related to the appliance. For example, the appliance 1050 may know or store data related to whether the appliance 1050 is turned on, how long the appliance has been on (or off), among other status data.

The interface device 1004 can be positioned within the housing of the appliance 1050, or can be attached externally to the appliance 1050. The interface device 1004 can be removable from the appliance 1050, or can be permanently installed in or on the appliance 1050.

The interface device 1004 can be connected to the local area network 1000 through a network interface. The interface device 1004 can be connected by a wired or wireless connection (e.g., WiFi, Zigbee, or others described herein or well known). In some embodiments, the interface device 1004 can be connected directly to the cloud network 114 through a cellular internet connection (e.g., EDGE, LTE, or others).

The interface device 1004 can communicate with another network device, an access device 108, or another client device through a network interface. The interface device 1004 can transmit a status information signal 1010 with status information to the access device 108, and the access device 108 can transmit a network device control signal 1012 to the interface device 1004. The status information signal 1010 and the network device control signal 1012 can be transmitted between the interface device 1004 and the access device 108 using a telecommunications network (e.g., a cellular network, or other suitable broadband network), using a local area network 1000 (e.g., through a gateway 110), or using the cloud network 114, although such a signal may pass through an intermediary device or network to do so.

The interface device 1004 can interpret the network device control signal 1012 and perform actions based on the contents of the network device control signal 1012. The network device control signal 1012 can include commands that can be performed by the interface device 1004 itself. The network device control signal 1012 can also include commands that are to be performed by the appliance 1050. Commands that are to be performed by the appliance 1050 can include commands like turn on or off, set a desired temperature (e.g., heat up or cool down to 215° F. or any other temperature), or other suitable commands depending on the particular appliance. The interface device 1004 can interpret the network device control signal 1012 and can send out a command 1022, through the data connection 1018 of the appliance interface 1008, based on the network device control signal 1012. The appliance 1050 can then perform the command indicated in the network device control signal 1012.

The interface device 1004 can also transmit commands to the appliance 1050 that are not based on a network device control signal received from the access device 108, but are rather based on programming in the interface device 1004. Examples of such commands can include commands to update a communication rate, commands to check a state of the appliance 1050, commands to set or get a clock time of the appliance 1050, or any other suitable commands.

The interface device 1004 can receive, through the data connection 1018 of the appliance interface 1008, a response (e.g., response 1020) to any command from the appliance 1050. In some examples, the response 1020 can include an indication that the command 1022 was received. In some examples, the response may include only an indication that a command is received (e.g., an ACK). In some examples, the response 1020 can include information for some value on the appliance 1050, such as an “on/off” state, a serial number, a product identification, a manufacturer identification, a temperature, a time since live, a setting, or any other value retrievable from the appliance 1050. The interface device 1004 can interpret the value and can send information about the value (e.g., the state of the appliance is “on,” the temperature of the appliance, the time since the appliance first turned on, or other information) as status information (e.g. using status information signal 1010) to the access device 108. Additionally, the interface device 1004 can send status information about itself (e.g., time since live, supplied power, signal strength, and others) as status information (e.g. using status information signal 1010) to the access device 108.

The interface device 1004 can also use responses (e.g., response 1020) from the appliance 1050 to perform additional functions at the interface device 1004, such as error handling. In some cases, when performing the additional functions, the interface device 1004 does not transmit any status information signal 1010 to the access device 108 based on those particular responses.

The access device 108 can include one or more display tiles (e.g., display tile 1014) for displaying information and controls corresponding to the network device 102.

In some embodiments, the interface device 1004 can transmit a heartbeat command (e.g., command 1022) over the data connection 1018 to the network device 1002 to determine whether the appliance 1050 is working properly and/or in a state of readiness. If the interface device 1004 determines that the appliance 1050 has had some sort of failure (e.g., the appliance 1050 sends a response 1020 indicating a failure or the interface device 1004 does not receive any response 1020), the interface device 1004 can take corrective action (e.g., restarting the appliance 1050 or an element of the appliance 1050), can log the event, or can alert the user).

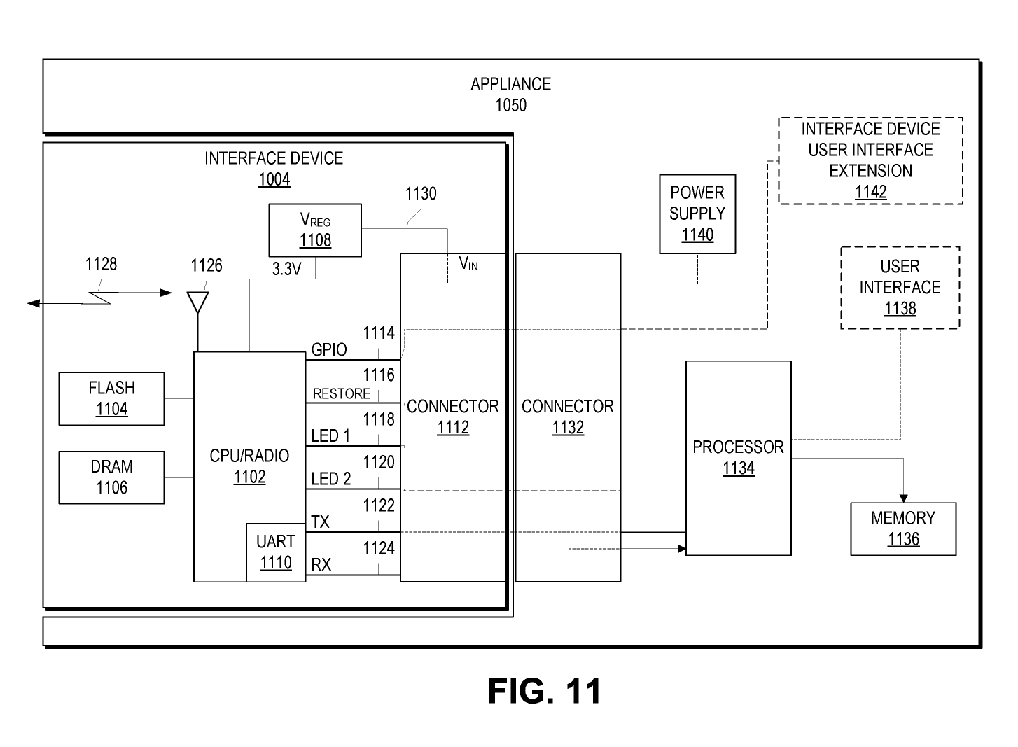

FIG. 11 depicts a block diagram of a network device including an interface device 1004 attached to an appliance 1050 according to one embodiment. The interface device 1004 can include connector 1112 that interacts with connector 1132 of the appliance 1050.

The interface device 1004 can include flash memory 1104 and dynamic random access memory (DRAM) 1106. The flash memory 1104 may be used to store instructions or code relating to an operating system, one or more applications, and any firmware. The flash memory 1104 can be used to store a cache. The flash memory 1104 may include nonvolatile memory so that any firmware or other program can be can updated. In the event the interface device 1004 loses power, information stored in the flash memory 1104 may be retained. The DRAM 1106 may store various other types of information needed to run the interface device 1004, such as all runtime instructions or code. The flash memory 1104 or DRAM 1106 or a combination thereof may include all instructions necessary to communicate with an appliance 1050, including all instructions necessary to communicate using the appliance serial protocol disclosed herein.

The interface device 1004 further includes a CPU/Radio 1102. The CPU/Radio 1102 can control the operations of the interface device 1004. For example, the CPU/Radio 1102 may execute various applications or programs stored in the flash memory 1104 and/or the dynamic random access memory (DRAM) 1106. The CPU/Radio 1102 may also receive input from the appliance 1050, interpret the input, and perform one or more functions in response to the input. The CPU/Radio 1102 may further perform all communications functions in order to allow the interface device 1004 to communicate with other network devices, one or more gateways, a cloud network, and/or one or more access devices. The interface device 1004 may communicate with other devices and/or networks via antenna 1126. For example, antenna 1126 may include a 2.4 GHz antenna that can transmit and receive WiFi communications signals 1128. The antenna 1126 may include other types of antennas that can transmit and/or receive Bluetooth® signals, Zigbee® signals, Ultra-Wideband (UWB) signals, and/or the like. In some embodiments, the interface device 1004 may include multiple antennas for communicating different types of communication signals.

The CPU/Radio 1102 can include at least one universal asynchronous receiver/transmitter (UART) 1110. The CPU/Radio 1102 can use the UART 1110 to send and receive serial communications. The CPU/Radio 1102 can send data through a transmit line 1122 and a receive data through a receive line 1124. The CPU/Radio 1102 can send and receive data through the transmit line 1122 and receive line 1124 using a serial protocol, such as RS232. The CPU/Radio 1102 can also include an input/output (GPIO) line 1114, a restore line 1116, an LED 1 line 1118, and an LED 2 line 1120. The CPU/Radio 1102 can have additional or fewer lines as necessary. The GPIO line 1114 can be used for any suitable function, such as powering an indicator light on an appliance 1050 or accepting an input from the appliance 1050. A signal sent on the restore line 1116 can be used to restore the CPU/Radio 1102 and/or the interface device 1004 to factory defaults. The LED 1 line 1118 and LED 2 line 1120 can be used to power first and second LEDs that can be used to indicate various statuses, such as whether the interface device has a network connection and whether the interface device is powered on.

The interface device 1004 further includes a voltage regulator 1108. The voltage regulator 1108 may be used to convert the voltage output from the appliance 1050 to a voltage usable by the CPU/Radio 1102. For example, the voltage regulator 1108 may regulate the DC voltage from 5 V to 3.3 V. The voltage regulator 1108 can be supplied with power from a power line 1130.

Each of the interface lines, including the GPIO line 1114, the restore line 1116, the LED 1 line 1118, the LED 2 line 1120, the transmit line 1122, the receive line 1124, the power line 1130, and any additional lines, can be routed through connector 1112. Connector 1112 can be a proprietary or universal connector. Any appliance 1050 to which the interface device 1004 is attached through the connector 1112 can have the necessary hardware to make use of the interface lines, such as to provide power to the power line 1130 and to provide the first and second LEDs that are driven by the LED 1 line 1118 and LED 2 line 1120.

In alternate embodiments, some interface lines are not routed through the connector 1112. For example, the power line 1130 can be routed to a power supply attached directly to the interface device 1004, and the LED 1 line 1118 and LED 2 line 1120 can be routed to first and second LEDs located within the interface device 1004.

In various embodiments, functions may be stored as one or more instructions or code in memory, such as the flash memory 1104 and/or the DRAM 1106. The interface device 1004 can also comprise software elements (e.g., located within the memory), including, for example, an operating system, device drivers, executable libraries, and/or other code, such as one or more application programs, which may comprise computer programs implementing the functions provided by various embodiments, and/or may be designed to implement methods and/or configure systems, as described herein. Merely by way of example, one or more procedures described with respect to the processes discussed below may be implemented as code and/or instructions executable by a computer (and/or a processor within a computer); in an aspect, then, such code and/or instructions can be used to configure and/or adapt a device (e.g. a specialty computer) to perform one or more operations in accordance with the described methods. Such functions or code may include code to perform various steps described below. The memory, such as the flash memory 1104 and/or the DRAM 1106, may be a processor-readable memory and/or a computer-readable memory that stores software code (programming code, instructions, etc.) configured to cause a processor(s) within the CPU/Radio 1102 to perform the functions described. In other embodiments, one or more of the functions described may be performed in hardware.

A set of these instructions and/or code might be stored on a computer-readable storage medium, such as the flash memory 1104 and/or the DRAM 1106. In some cases, the storage medium might be incorporated within a computer system, such as the CPU/Radio 1102. In other embodiments, the storage medium might be separate from a computer system (e.g., a removable medium, such as a compact disc), and/or provided in an installation package, such that the storage medium can be used to program, configure and/or adapt a device (e.g. a computer) with the instructions/code stored thereon. These instructions might take the form of executable code, which is executable by the interface device 1004 and/or might take the form of source and/or installable code, which, upon compilation and/or installation on the interface device 1004 (e.g., using any of a variety of compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other access or computing devices such as network input/output devices may be employed.

The interface device 1004 may have other components than those depicted in FIG. 11. Further, the embodiment shown in the figures are only one example of an interface device that may incorporate an embodiment of the invention. In some other embodiments, interface device 1004 may have more or fewer components than shown in the figure, may combine two or more components, or may have a different configuration or arrangement of components.

The appliance 1050 can have a processor 1134. The processor 1134 can be a microcontroller, such as a Peripheral Interface Controller (PIC). The appliance 1050 can include a memory 1136 (e.g., a flash memory or other) that is readable by the processor 1134. The memory 1136 can include instructions enabling the innate functionality of the appliance 1050, such as heating and timing for a crock pot.

The appliance 1050 can include a user interface 1138. The user interface 1138 can provide buttons, displays, LEDs, knobs, and other input and output elements necessary for a user to interact with the appliance 1050. For example, a user interface 1138 for a slow cooker can include a display, a power button, a temperature adjustment button, and a start button. The user interface 1138 can be driven and/or monitored by the processor 1134. In some embodiments, the appliance 1050 is “headless” or has no user interface 1138.

The appliance 1050 can include a power supply 1140 that can provide power to the voltage regulator 1108 of the interface device 1004 through connector 1132, connector 1112, and power line 1130.

The appliance 1050 can include an interface device user interface extension 1142. The interface device user interface extension 1142 can include various input and output elements that are passed directly to the interface device 1004 without being processed by the processor 1134. Examples of input and output elements of the interface device user interface extension 1142 include LEDs associated with the LED 1 line 1118 and LED 2 line 1120, a hardware restore button associated with the restore line 1116, or any other suitable input/output element.

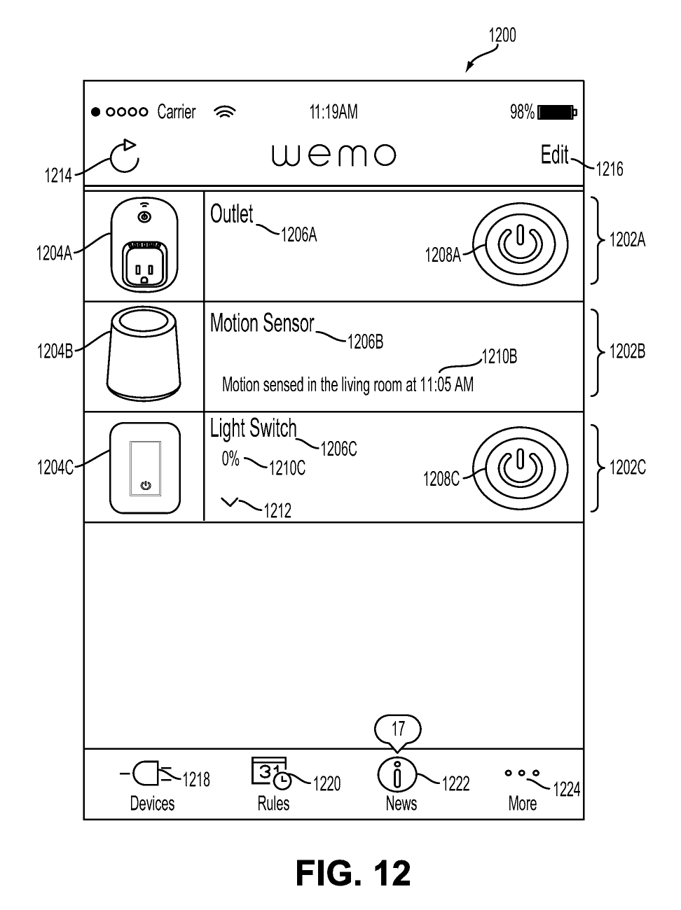

FIG. 12 depicts an example interface for controlling network devices, in accordance with some embodiments. Display 1200 is a visual interface usable to monitor and control one or more network devices and rules corresponding to operation of the network devices. In some embodiments, display 1200 is provided through access device 108 (e.g., a mobile device). Display 1200 includes modular tiles 1202A, 1202B, and 1202C (hereinafter “tiles 1202”) for interacting with network devices in a network. In this embodiment, tiles 1202A, 1202B, and 1202C correspond with three different network devices, including an outlet, motion sensor, and light switch.

In some embodiments, the information contained in tiles 1202 can be received via an intra-network communication (e.g., communication 310) between the computing device operating the display 1200 and the network device. For example, the information in the communication can include information about icons, names, status, existing rules, or capabilities of one or more network devices. In some embodiments, a communication can be sent from the computing device to a network device to query the network device about its identity. In response to receiving the query, the network device may send communications to the computing device operating the display 1200 with at least a unique interface module ID. The communication may provide the computing device with information that can be used to determine a basic, default visual interface that includes the tiles 1202.

The communication may be transmitted between the computing device operating the display 1200 and the network during the initial discovery process. For example, when the network device is initially connected to the network, the network and the computing device can automatically exchange these communications. The information in the communications can establish the initial information in tiles 1202, including any existing rules associated with the network device.

The tiles 1202 may also include icons 1204A, 1204B, and 1204C (hereinafter “icons 1204”). The icons 1204 can include images corresponding to each network device. For example, the images may include an outline, silhouette, photograph, or other visual representation of the network device. As illustrated, the icon for tile 1202A includes an outline of an outlet, the icon for tile 1202B includes an outline of a motion sensor, and the icon for tile 1202C includes an outline of a light switch.

The tiles 1202 may also include a name 1206A, 1206B, and 1206C (hereinafter “names 1206”) for the corresponding network device. The names 1206 include a description of the network device (e.g., “outlet”) or the electronic device. In some embodiments, the description can be associated with each network device during the registration process described above. As illustrated, tile 1202A corresponds with an outlet network device and is named “outlet,” tile 1202B corresponds with a motion sensor network device and is named “motion sensor,” and tile 1202C corresponds with light switch network device and is named “light switch.”

The tiles 1202 may also include interactive elements configured to control one or more states, settings, attributes, and/or other aspects of the network devices. For example, in FIG. 12, the interactive elements can include a power button, as illustrated as a power button 1208A in tile 1202A, for turning the outlet on and off. The power button 1208A can be selected with a click or press (e.g., a tap gesture) to turn the outlet on and off. Similarly, in the example described in FIG. 12, tile 1202C includes a power button 1208C for activating a power on/off function on a light switch.

In certain embodiments, the status or state of a network device (used interchangeably) can be indicated within the tile, including any piece of information pertinent to that particular network device. For example, the status of a network device may include a state of the network device itself (e.g., on or off) or how the network device is situated within the network with respect to other network devices in the network. For example, the status of a network device may refer to the network device's proximity to another network device and/or its ability to communicate with another network device because of the relative signal strength between the two network devices. In some embodiments, tiles 1202 can convey status information about a network device, including, but not limited to, a firmware version, a last known firmware update status, connectivity to cloud status, registration status (e.g., an indication that the network device has a key or does not), a primary mode of the network device (e.g., on or off), a secondary mode of the device (e.g., standby, high, low, etc.), a schedule, existing rules, and settings for the network device.

In some embodiments, the status can include a value or some other information indicating a unit of measure for a setting or an attribute related to operation of a network device. The setting or attribute can be adjustable within a range of values, in some embodiments. For example, the network device can be a light switch and the status can include a value corresponding to brightness (e.g., a percentage of maximum brightness) emitted by the light bulb associated with the light switch when the light switch is powered-on. In another embodiment, the network device can be a motion sensor and the status can include a value corresponding to sensitivity of the sensor in a range of values between 0 and 100 when the sensor is powered-on.

Returning to FIG. 12, the displayed status of a network device can change based on time (e.g., a period, an interval, or other time schedule). For example, tile 1202B may indicate a sensor-specific status 1210B that changes when an event such as motion is detected. In an illustrative embodiment, the tile may provide a status that includes “Motion sensed in the living room at 11:05 AM.”

In some embodiments, the status information can change based in part on one or more rules assigned to a network device. As illustrated, status 1210C indicates that the light switch is at 0%, which corresponds to the light switch being turned off. The light switch may be assigned a rule that instructs the light switch to remain at 0% until the light switch is pressed by a user, and then change to 100% in response to the light switch being pressed. When the light switch is pressed by the user, the rule may instruct the light switch to change to 100%. The status 1210C can indicate that the light switch is at 100% as well. In another example, a rule may instruct the light switch to turn on at 6 AM, and the status 1210C of the light switch can indicate that the light switch is on at 6 AM.

Status information may be provided in multiple locations in tiles 1202 as well. For example, the status may also be reflected by the power button 1208C for the light switch not being lit up or shaded/bolded.

When a network device has extended capabilities, such as secondary or tertiary functionalities, an interactive element 1212 can be selected to expand and contract a menu including controllable settings for the capabilities. The menu can be, for example, a full drop down menu or drawer with interactive elements for setting the extended capabilities of the network device to be displayed within the graphical interface. The display 1200 can enable control of settings and/or attributes related to operation of the network device corresponding to the tile. For example, the tiles 1202 can include a drawer that displays the operations for secondary functionalities in response to a selection made for a primary functionality (e.g., controlling a power state) for a network device. In certain embodiments, the drawer can display secondary settings, including a default, implied secondary setting for a network device that can affect the operation of the network device and can be related to scheduling operation of the network device (e.g., setting on/off times), selecting auto off timeouts or thresholds, selecting settings for putting the network device into standby, hibernate, or sleep mode, and/or controlling adjustable features (e.g., lighting or speed). By enabling a user control features and secondary settings of a network device, the user is enabled with the ability to remotely control multiple features for several network devices without being present at a location for those devices.

Display 1200 can also include selectable icons and links outside of the tile display area. For example, refresh icon 1214 can be selected to refresh information presented in display 1200, such as status and state information displayed in tiles 1202A, 1202B, and 1202C. For instance, the status 1210B in tile 1202B for the motion sensor can be refreshed on an automatic, periodic basis, in addition to being manually updated when refresh icon 1214 is selected. Similarly, the brightness status 1210C in tile 1202C for the light switch can be updated when refresh icon 1214 is selected.

The edit link 1216 can be selected to edit the list of tiles 1202A, 1202B, and 1202C. For example, edit link 1216 can be selected to sort or re-order the sequence of tiles 1202A, 1202B, and 1202C displayed in display 1200. Edit link 1216 can also be selected to delete one of the tiles 1202A, 1202B, and 1202C in cases where a user no longer wants to view a given tile. Devices icon 1218 can be selected to list discovered network devices in a network.

Rules icon 1220 can be selected to display existing rules pertaining to network devices. For example, rules icon 1220 can be selected to display one or more existing rules assigned to the network devices. As an example illustration, the outlet corresponding to tile 1202A may be assigned an existing rule that turns on the outlet at 8 PM every night. When the outlet turns on, the corresponding electronic device coupled with the outlet (e.g., a lamp, a television, etc.) may receive power from the outlet (e.g., and also power on). In another example, an existing rule assigned to the motion sensor corresponding to tile 1202B can detect motion during particular hours of the day. As described in further detail below, rules icon 1220 can be selected to provide new rules pertaining to network devices. As used herein, providing a “new rule” may include modifying an existing rule or a providing an entirely new rule.

The rules icon 1220 can also access existing rules (or allow new rules to be provided) that relate to a network device's interaction with another network device. For example, an existing rule assigned to the light switch of tile 1202C can turn on the light switch for a specified duration when the motion sensor of tile 1202B detects motion. That is, by selecting rules icon 1220, a user can review or provide a rule that turns on a light switch for a certain number of minutes when a motion sensor detects motion in a room. In this way, rules can relate to interactions between multiple network devices.

The display 1200 includes other functionalities as well. News icon 1222 can be selected to review news items, such as news associated with network devices and/or the application. For instance, news icon 1222 can be selected to view announcements and news items relevant to network devices controlled via tiles 1202A, 1202B, and 1202C and/or information relevant to the application, such as messages of available tile updates. The more icon 1224 can be selected to access additional features of the application or other functionalities.

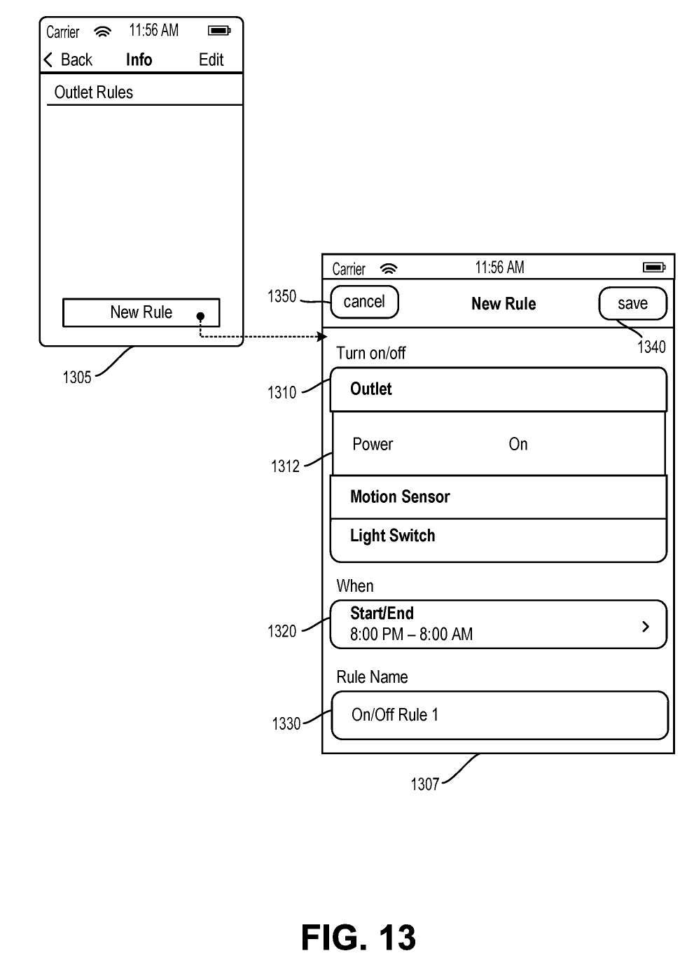

FIG. 13 shows example interfaces for establishing a new rule assigned to a network device, in accordance with some embodiments. For example, when the user selects rules icon 1220, interface 1305 may be presented by the computing device for the user to assign a new rule to a particular network device. The interface 1305 may also display existing rules assigned to network devices. As illustrated in FIG. 13, however, a particular network device (i.e., an outlet) has not assigned any existing rules.

The user can activate an option to add a new rule (e.g., by selecting, tapping, clicking, etc.). An interface 1307 may be provided by the computing device that allows the user to create a new rule assigned to a particular network device. The interface 1307 can include a digital keyboard, one or more dropdown menus, radio buttons, or other tools that enable the user to provide input to create the new rule. For example, the user may tap on a portion of the interface 1307, the interface 1307 can render a dropdown menu of options that includes “on,” “off,” and scheduling options. The user can scroll through the options in a dropdown menu (not shown). When the user desires to select an option (e.g., “on”), the user may tap the “on” option to provide input to interface 1307. The computing device may associate the input with the new rule assigned to the network device. Other input may be provided as well, including, for example, a start/end time and a rule name (e.g., by typing, tapping, selecting, etc.).

As illustrated, the user provided input corresponding to the new rule is assigned to outlet 1310 in order to control the operation of power 1312 delivered by the outlet. The power for the outlet can be turned on or off. The new rule may specify a time 1320 to turn the power on, including a start and end time (e.g., 8:00 PM to 8:00 AM). The new rule may also correspond with a name 1330 (e.g., “On/Off Rule 1”). In other words, the new rule named “On/Off Rule 1” may instruct the outlet to provide power between 8:00 PM to 8:00 AM.

The user may save the new rule. For example, the user can select a save option 1340. When the user saves the rule, the new rule may become an “existing rule” assigned to the network device as described herein. In some examples, the user may choose not to save the rule and instead select a cancel option 1350 to not save the rule, thus not assigning the new rule to the network device.

In some embodiments, the computing device may analyze the new rule before (or after) the user elects to save the rule. For example, when the network device includes one or more existing rules, the new rule may be compared with the existing rules to determine whether a conflict exists (e.g., whether an existing rule and the new rule may instruct the network device to turn on and off at the same time). In some embodiments, the computing device (e.g., access device 108) can receive existing rules from network devices in the local area network each time the access device joins the network, such that the computing device is regularly provided with the existing rules assigned to network devices.

If a newly provided rule does not create a conflict with an existing rule, the new rule may be transmitted. For example, the rule may be transmitted by the computing device to the network device. In some embodiments, the new rule may be stored locally at the network device. The new rule may also or alternatively be transmitted to a cloud-based device to store the new rule remotely from the network device.

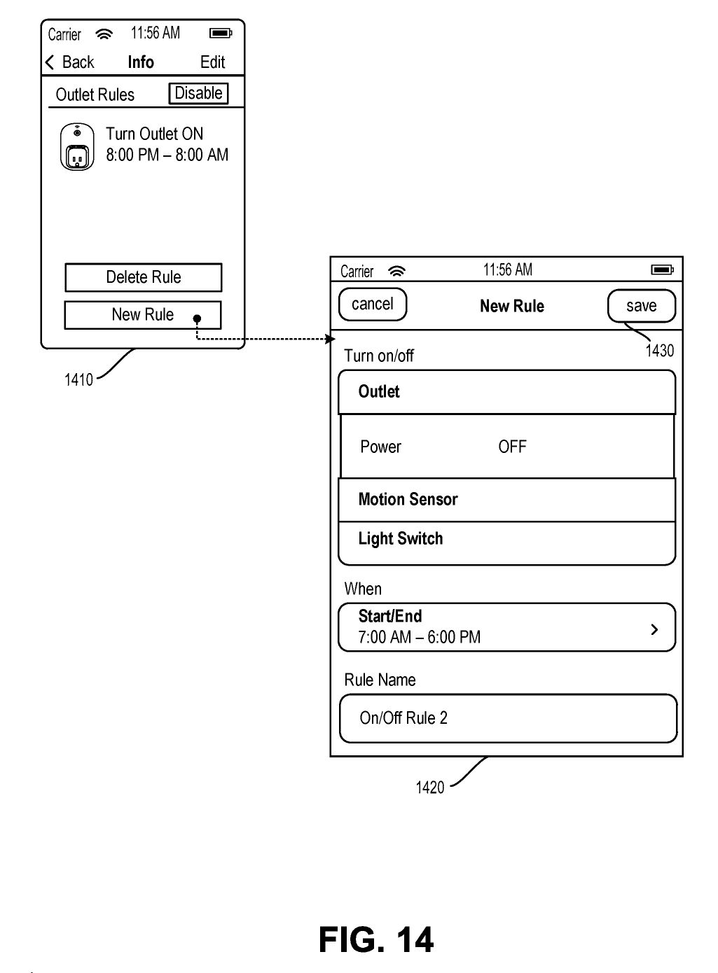

FIG. 14 shows example interfaces for establishing a new rule that conflicts with an existing rule assigned to a network device, in accordance with some embodiments. An interface 1410 providing the existing rule is shown. For example, when the user selects rules icon 1220 (e.g., illustrated in FIG. 12), interface 1410 may be presented by the computing device for the user to view current rules assigned to the particular network device. The existing rule (i.e., “On/Off Rule 1” shown in FIG. 13) assigned to the particular network device (i.e., the outlet) is illustrated in interface 1410. As illustrated, the input from FIG. 13 was saved as an existing rule corresponding to operation of the outlet, the rule instructing the outlet to provide power between 8:00 PM to 8:00 AM according to “On/Off Rule 1.”

At some time after creating the “On/Off Rule 1,” the user may attempt to assign a new rule to the outlet. The user may provide input to assign the new rule (e.g., as described above with respect to FIG. 13), which the user can provide through interface 1420 (e.g., via a keyboard, dropdown menu, radio buttons, etc.). As illustrated, the new rule is assigned to the outlet in order to control the operation of power for the outlet. The new rule may instruct the outlet to not provide power at a specified time, including a start and end time (e.g., to turn power off from 7:00 AM to 6:00 PM). This may include not providing power to an electronic device coupled with the outlet (e.g., a lamp plugged into the outlet). The new rule may also be assigned a name (e.g., “On/Off Rule 2”). In other words, the new rule named “On/Off Rule 2” may instruct the outlet to not provide power (e.g., to the lamp) between 7:00 AM to 6:00 PM. The user may attempt to store the new rule by selecting the save option 1430.

As illustrated, the new rule and the existing rule conflict between the hours of 7 AM and 8 AM, when the outlet is instructed to provide power according to “On/Off Rule 1” and simultaneously instructed not to provide power according to “On/Off Rule 2.” Since the state of the outlet cannot be both “on” and “off” at the same time, the new rule and the existing rule create a conflict in terms of the operational state of the outlet.

In some embodiments, when a new rule is provided, the computing device may analyze existing rules to determine whether a conflict is created by the new rule. In some embodiments, the computing device performing the analysis can be access device 108 (e.g., a mobile device) displaying the interfaces shown in FIGS. 12-14. In some embodiments, if the existing rule and new rule are transmitted to a cloud-based device, the cloud-based device may perform the analysis of the existing rule and the new rule to determine whether a conflict exists. In some embodiments, the analysis can be performed by any other suitable type of computing device such as the network device, another network device, a gateway, or other computing device.

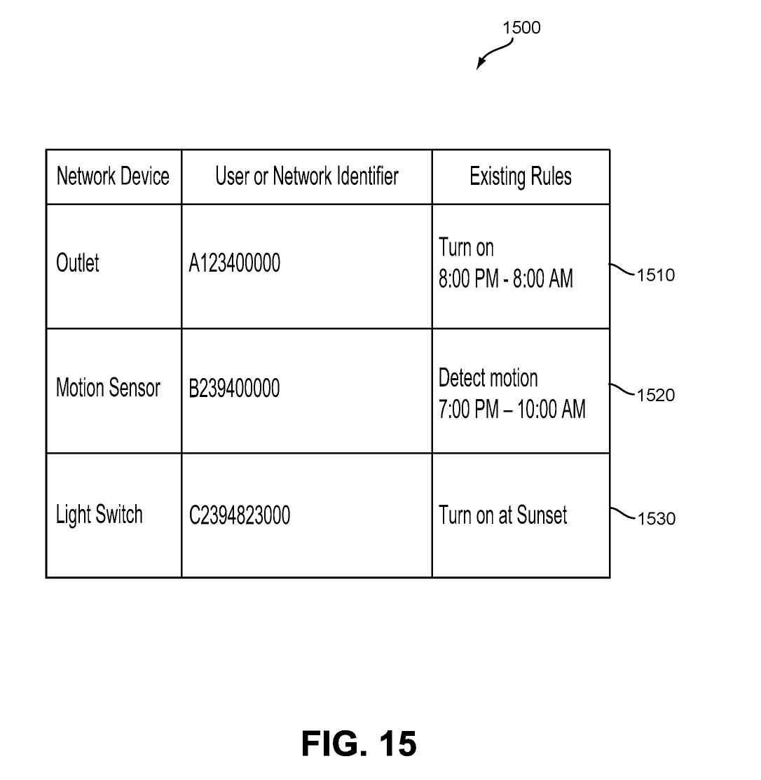

FIG. 15 shows an illustration of a data store including existing rules assigned to network devices, in accordance with some embodiments. The data store 1500 may include one or more network devices, user or network identifiers, and existing rules. In the example illustrated in FIG. 15, data store 1500 includes existing rules assigned to the outlet, motion sensor, and light switch. It should be appreciated, however, that data store 1500 can include existing rules describing any other suitable network devices such as a light switch, outlet, or motion sensor, or corresponding electronic devices that are coupled with network devices, like a lamp plugged into an outlet network device. In some embodiments, data store 1500 can be included in the cloud network 114 illustrated in FIG. 1. In some other embodiments, data store 1500 can be included in any other suitable device such as network device 106, access device 108, gateway 110, etc.

The existing rules may include various types of information. For example, as illustrated in FIG. 15, the existing rules can include a rule 1510 that causes an outlet to power on 8:00 PM-8:00 AM (i.e., “On/Off Rule 1”), a rule 1520 that causes a motion sensor to detect motion 7:00 PM-10:00 AM, and a rule 1530 that causes a light switch to turn on at sunset. A new rule can be compared to existing rules in data store 1500 to determine whether a conflict exists.

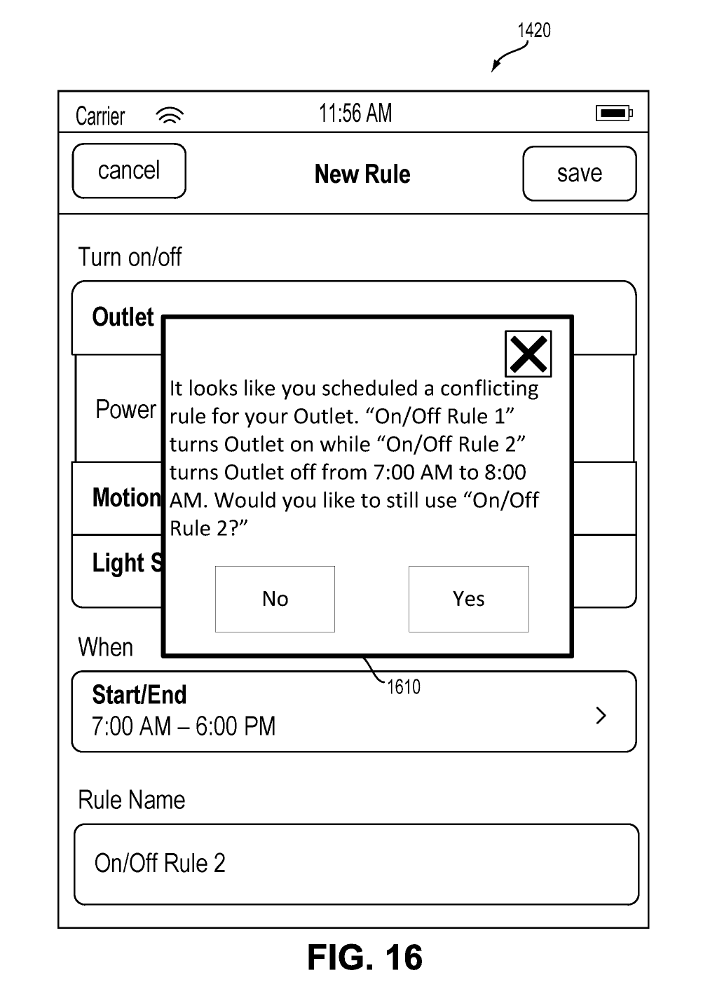

FIG. 16 shows an illustration of an example interface for providing an indication of a conflict between an existing rule and a new rule assigned to a network device, in accordance with some embodiments. The indication of a conflict may be provided after the user attempts to save the new rule (e.g., by selecting the save option 1430 in FIG. 14). As illustrated, the interface may be similar to interface 1420 described with FIG. 14 and the indication of the conflict may be a message overlaid on top of the interface 1420.

The indication may be provided after the computing device (e.g., the cloud-based device) performs the analysis identifying the conflict. For example, a cloud-based device may perform the analysis and transmit the indication of the conflict to an access device which may in turn display the indication to a user. In some embodiments, the computing device performing the analysis can be an access device displaying the interfaces shown in FIGS. 12-14. For example, the access device 108 (e.g., a mobile device) can determine whether the conflict exists and can generate and provide the indication of the conflict (e.g., on interface 1420).

As seen in FIG. 16, the interface 1420 may display an indication 1610 of the conflict. The indication 1610 can include content related to the conflict between the existing rule and the new rule. As illustrated, the message includes “It looks like you scheduled a conflicting rule for your Outlet. ‘On/Off Rule 1’ turns Outlet on while ‘On/Off Rule 2’ turns Outlet off from 7:00 AM to 8:00 AM. Would you like to still use ‘On/Off Rule 2’?” The user may respond to the message by selecting “yes” or “no.” For example, when “yes” is selected, “On/Off Rule 1” can be canceled and replaced by “On/Off Rule 2.” In some embodiments, when “yes” is selected, “On/Off Rule 1” can be automatically modified to prevent the conflict (e.g., by moving the end time back to 7:00 AM). When “no” is selected, “On/Off Rule 2” may be canceled and the new rule may not be stored. In some embodiments, the message can be provided through other means, including transmitting the message to a user device as a text message or Short Message Service (SMS), email message, audible message, or other suitable message format.

In some embodiments, the indication of the conflict may be provided by the computing device to another computing device. For example, the computing device that analyzes and identifies the conflict between the existing rule and the new rule may be an access device and the second computing device may be a cloud-based device. In some embodiments, the existing rule and new rule may be transmitted. For example, the existing rule and the new rule may be transmitted to a cloud-based device. When the cloud-based device (or other computing device) receives the rules, the cloud-based device may perform the analysis of the existing rule and the new rule and determine that the conflict exists. The indication of the conflict may be provided to the access device, network device, or any other computing device to help identify and/or resolve the conflict.

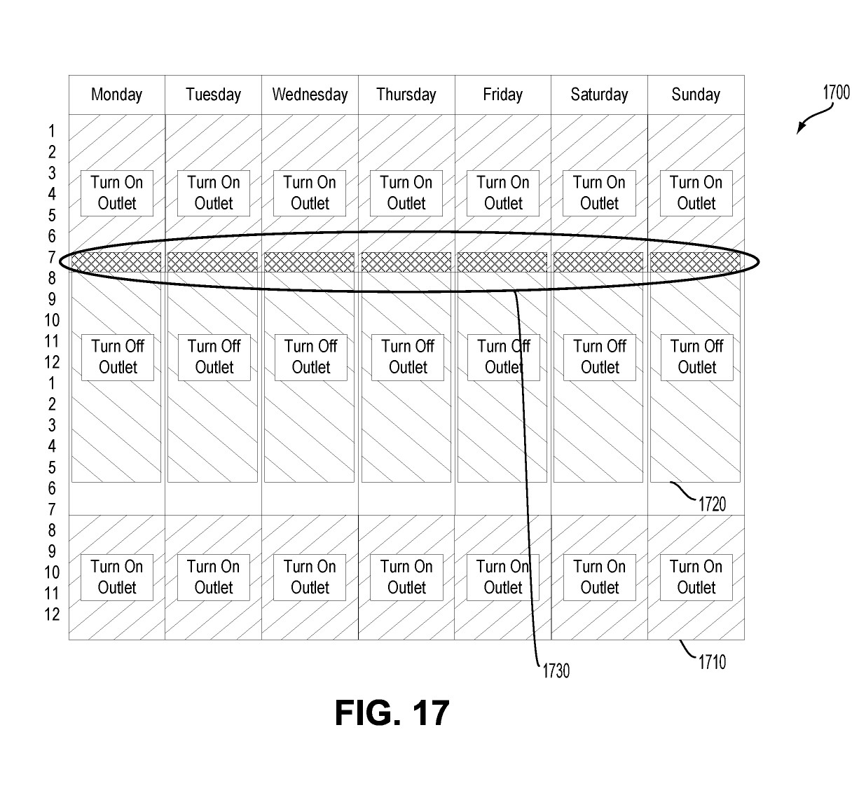

FIG. 17 shows an illustration of an example scheduling interface for providing an indication of a conflict between an existing rule and new rule assigned to a network device, in accordance with some embodiments. As illustrated, an indication of an existing rule 1710 can correspond with a rule to turn on the outlet between 8:00 PM to 8:00 AM and an indication of a new rule 1720 can correspond with a rule to turn off the outlet between 7:00 AM to 6:00 PM. An indication of the conflict 1730 between the existing and new rules can be provided as well. The indication of the conflict may be highlighted for the user as a particular time frame where the rules conflict.

In some embodiments, the interface 1700 may be interactive and allow the user to adjust a new rule and/or existing rule to resolve the identified conflict. For example, the user may select an indication of the existing rule 1710 or the new rule 1720 and can drag an edge of the indication corresponding to the start or end time to a different time than that originally provided by the user. In some embodiments, adjusting the start and/or end time of the indication of a rule in the scheduling interface 1700 may cause the corresponding rule to be modified accordingly. As an illustration, the end of the indication of the existing rule 1710 can be dragged up to 7:00 AM, so that the corresponding existing rule as modified causes the outlet to provide power between 8:00 PM and 7:00 AM. This would eliminate the conflict between 7:00 AM and 8:00 AM, since the existing rule would not cause the outlet to provide power past 7:00 AM. In another example, the beginning of the indication of the new rule 1720 can be dragged down to 8:00 AM, so that the corresponding new rule as modified causes the outlet to not provide power between 8:00 AM and 5:00 PM. This would also eliminate the conflict between 7:00 AM and 8:00 AM, since the new rule would not turn the outlet off until 8:00 AM.

In some embodiments, the user can cancel or delete a rule from interface 1700. For example, the user may select the indication of the new rule 1720 and delete the indication (e.g., on a virtual keyboard, by typing delete, by swiping the rule off of the interface, etc.).

In some embodiments, the interface 1700 can provide an indication 1730 of the conflict (e.g., instead of or in addition to the indication 1610 in FIG. 16). The indication 1730 of the conflict may show the overlapping rules and/or may be a notification or message that overlays on top of the interface 1700 (not shown).

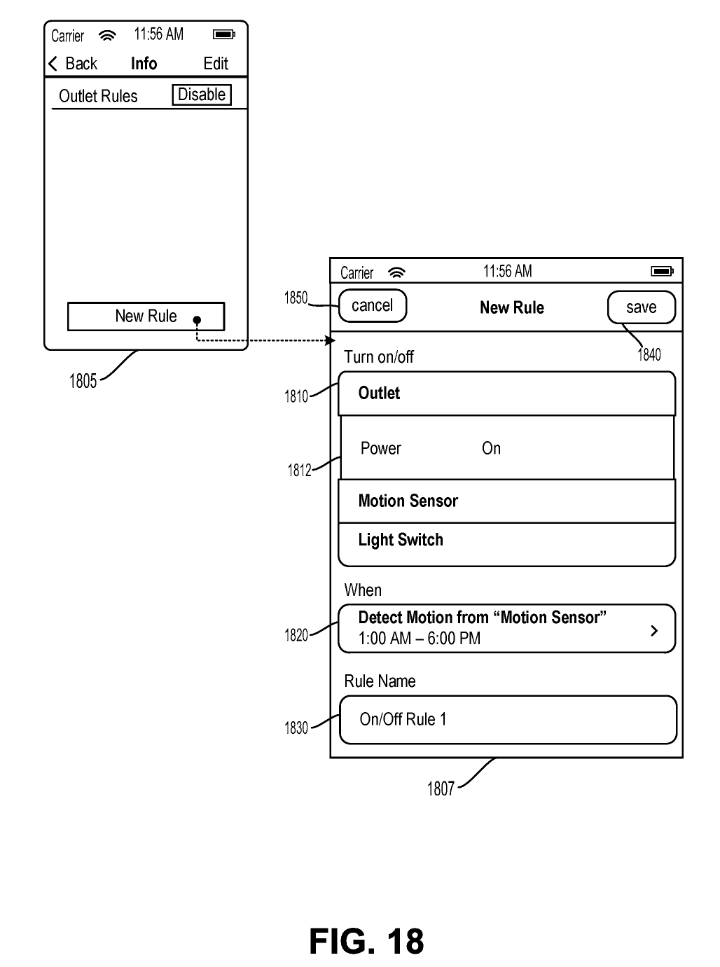

FIG. 18 shows an example interface for establishing a new rule assigned to a network device that relates to an interaction between the network device and another network device, in accordance with some embodiments. For example, when the user selects rules icon 1220, interface 1805 may be presented by the computing device for the user to assign a new rule to a particular network device. The interface 1305 may also display existing rules assigned to network devices. As illustrated in FIG. 13, however, a particular network device (i.e., an outlet) has not assigned any existing rules.

The user can activate an option to add a new rule (e.g., by selecting, tapping, clicking, etc.). An interface 1807 may be provided by the computing device that allows the user to create a new rule assigned to a particular network device. The interface 1807 can include a digital keyboard, one or more dropdown menus, radio buttons, or other tools that enable the user to provide input to create the new rule. For example, the user may tap on a portion of the interface 1807, the interface 1807 can render a dropdown menu of options that includes “on,” “off,” and scheduling options. The user can scroll through the options in a dropdown menu (not shown). When the user desires to select an option (e.g., “on”), the user may tap the “on” option to provide as input to interface 1807. The computing device may associate the input with the new rule assigned to the network device. Other input may be provided as well, including, for example, a start/end time and a rule name (e.g., by typing, tapping, selecting, etc.).

As illustrated, the user provided input corresponding to the new rule is assigned to outlet 1810 in order to control the operation of power 1812 delivered by the outlet. The power for the outlet can be turned on or off. The new rule may specify a time 1820 to turn the power on, including a start and end time (e.g., 1:00 AM to 6:00 PM). The new rule may also correspond with a name 1830 (e.g., “On/Off Rule 1”). In other words, the new rule named “On/Off Rule 1” may instruct the outlet to provide power between 1:00 AM and 6:00 PM.

Some rules may depend on another network device. As illustrated, the power is turned on when the motion is detected from the network device “motion sensor.” For example, the motion sensor network device may detect whether an object moves in a particular space during a particular time. When motion is sensed by the motion sensor, the motion sensor may transmit an indication of the motion to one or more other network devices in the local area network (as described with FIGS. 12-14). The network devices may interact to provide information to other network devices. These network devices may be affected by the indication of motion when these devices include existing rules associated with motion. As shown, the outlet (e.g., a network device) is affected by the operation of the motion sensor (e.g., another network device in the shared network).

In some embodiments, the interface 1807 may be used to generate a new rule that corresponds to an interaction between the network device and another network device in a shared network. As illustrated, the new rule (e.g., and potentially the existing rule) corresponds to an interaction between the outlet and the motion sensor.

The user may save the new rule. For example, the user can select a save option 1840. When the user saves the rule, the new rule may become an “existing rule” assigned to the network device as described herein. In some examples, the user may choose not to save the rule and instead select a cancel option 1850 to not save the rule, thus not assigning the new rule to the network device.

In some embodiments, the computing device may analyze the new rule before (or after) the user elects to save the rule. For example, when the network device includes one or more existing rules, the new rule may be compared with the existing rules to determine whether a conflict exists (e.g., whether an existing rule and the new rule may instruct the network device to turn on and off at the same time). In some embodiments, the computing device (e.g., access device 108) can receive existing rules from network devices in the local area network each time the access device joins the network, such that the computing device is regularly provided with the existing rules assigned to network devices.

If a newly provided rule does not create a conflict with an existing rule, the new rule may be transmitted. For example, the rule may be transmitted by the computing device to the network device. In some embodiments, the new rule may be stored locally at the network device. The new rule may also or alternatively be transmitted to a cloud-based device to store the new rule remotely from the network device.

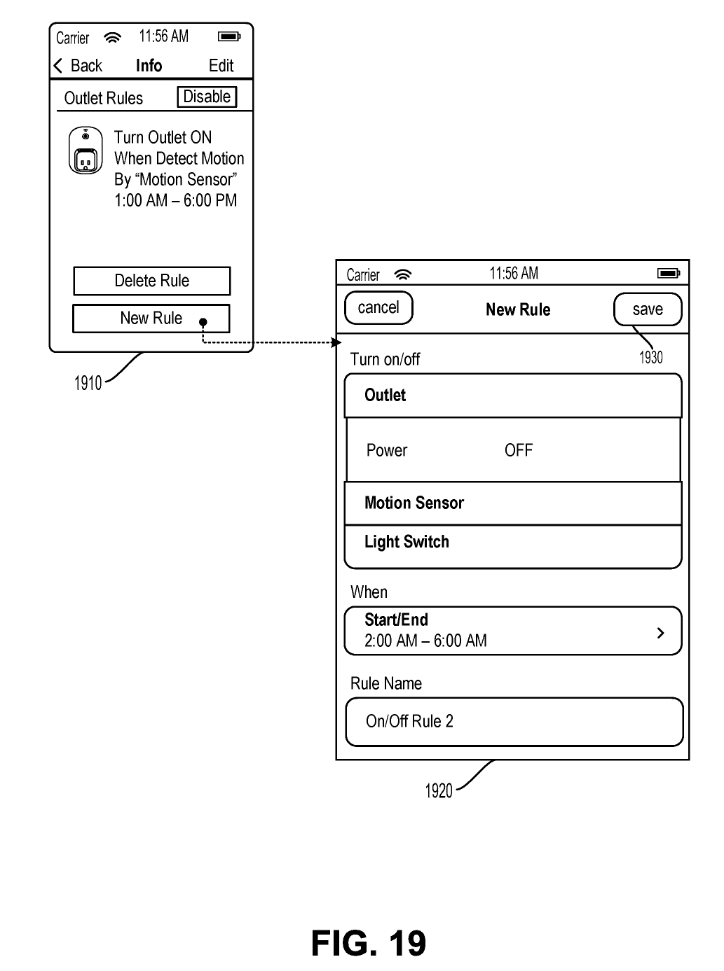

FIG. 19 shows example interfaces for establishing a new rule that conflicts with an existing rule assigned to a network device, in accordance with some embodiments. An interface 1910 providing the existing rule is shown. For example, when the user selects rules icon 1220 (e.g., illustrated in FIG. 12), interface 1910 may be presented by the computing device for the user to view current rules assigned to the particular network device. The existing rule (i.e., “On/Off Rule 1” shown in FIG. 18) assigned to the particular network device (i.e., the outlet) is illustrated in interface 1910. As illustrated, the input from FIG. 18 was saved as an existing rule corresponding to operation of the outlet, the rule instructing the outlet to provide power between 1:00 AM to 6:00 PM according to “On/Off Rule 1.”

At some time after creating the “On/Off Rule 1,” the user may attempt to assign a new rule to the outlet. The user may provide input to assign the new rule (e.g., as described above with respect to FIG. 18), which the user can provide through interface 1920 (e.g., via a keyboard, dropdown menu, radio buttons, etc.). As illustrated, the new rule is assigned to the outlet in order to control the operation of power for the outlet. The new rule may instruct the outlet to not provide power at a specified time, including a start and end time (e.g., to turn power off from 2:00 AM to 6:00 AM). This may include not providing power to an electronic device coupled with the outlet (e.g., a lamp plugged into the outlet). The new rule may also be assigned a name (e.g., “On/Off Rule 2”). In other words, the new rule named “On/Off Rule 2” may instruct the outlet to not provide power (e.g., to the lamp) between 2:00 AM to 6:00 AM. The user may attempt to store the new rule by selecting the save option 1930.

As illustrated, the new rule and the existing rule conflict between the hours of 2:00 AM and 6:00 AM, when the outlet is instructed to provide power according to “On/Off Rule 1” and simultaneously instructed not to provide power according to “On/Off Rule 2.” Since the state of the outlet cannot be both “on” and “off” at the same time, the new rule and the existing rule create a conflict in terms of the operational state of the outlet.

In some embodiments, the conflict may be a potential conflict. For example, an actual conflict or current conflict may include an existing rule that restricts power to the light switch 10:00 AM to 8:00 PM, followed by a new rule that includes providing power the light switch at 6:00 PM. As illustrated, the actual conflict or current conflict would arise at 6:00 PM. The potential conflict may be similar to the actual conflict or current conflict. For example, the existing rule can restrict power the light switch 10:00 AM to 8:00 PM, followed by a new rule that includes providing power to the light switch when any motion is detected. As illustrated, the conflict could arise when motion is detected 10:00 AM to 8:00 PM.

In some embodiments, when a new rule is provided, the computing device may analyze existing rules to determine whether a conflict is created by the new rule. In some embodiments, the computing device performing the analysis can be access device 108 (e.g., a mobile device) displaying the interfaces shown in FIGS. 12-14. In some embodiments, if the existing rule and new rule are transmitted to a cloud-based device, the cloud-based device may perform the analysis of the existing rule and the new rule to determine whether a conflict exists. In some embodiments, the analysis can be performed by any other suitable type of computing device such as the network device, another network device, a gateway, or other computing device.

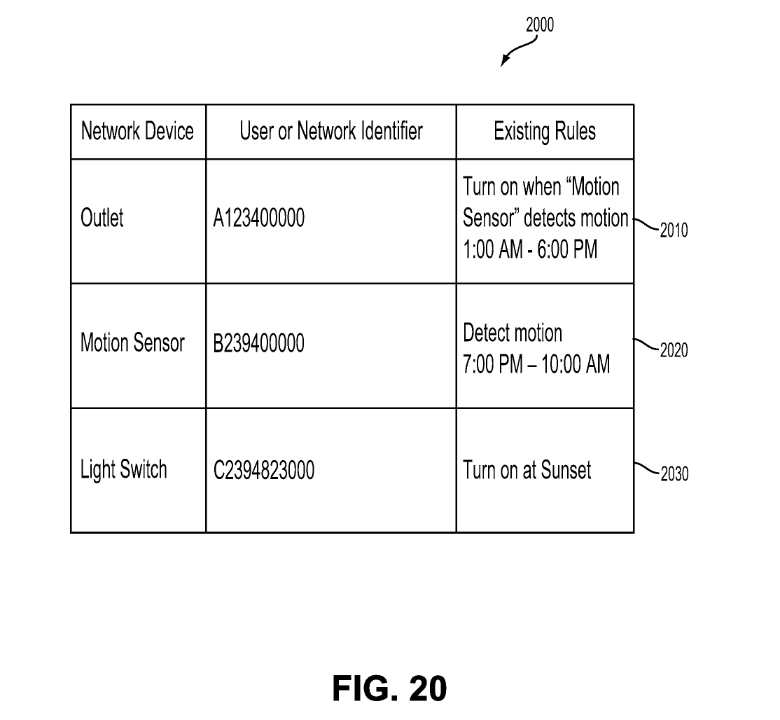

FIG. 20 shows an illustration of a data store including existing rules assigned to network devices, in accordance with some embodiments. The data store 2000 may include one or more network devices, user or network identifiers, and existing rules. In the example illustrated in FIG. 20, data store 2000 includes existing rules assigned to the outlet, motion sensor, and light switch. It should be appreciated, however, that data store 2000 can include existing rules describing any other suitable network devices such as a light switch, outlet, or motion sensor, or corresponding electronic devices that are coupled with network devices, like a lamp plugged into an outlet network device. In some embodiments, data store 2000 can be included in the cloud network 114 illustrated in FIG. 1. In some other embodiments, data store 2000 can be included in any other suitable device such as network device 106, access device 108, gateway 110, etc.

The existing rules may include various types of information. For example, as illustrated in FIG. 20, the existing rules can include a rule 2010 that causes an outlet to turn on when the motion sensor detects motion between 1:00 AM and 6:00 PM, a rule 2020 that causes a motion sensor to detect motion between 7:00 PM and 10:00 AM, and a rule 2030 that causes a light switch to turn on at sunset. A new rule can be compared to existing rules in data store 2000 to determine whether a conflict exists.

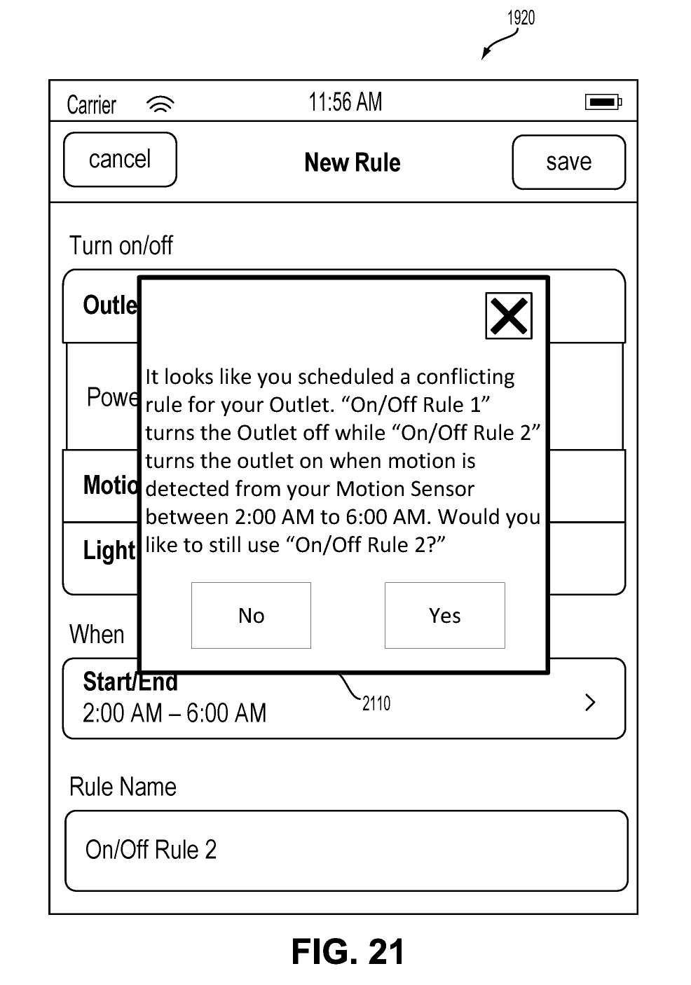

FIG. 21 shows an illustration of an example interface for providing an indication of a conflict between an existing rule and a new rule assigned to a network device, in accordance with some embodiments. The indication of a conflict may be provided after the user attempts to save the new rule (e.g., by selecting the save option 1930 in FIG. 19). As illustrated, the interface may be similar to interface 1920 described with FIG. 19 and the indication 2110 of the conflict may be a message overlaid on top of the interface 1920.

The indication may be provided after the computing device (e.g., the cloud-based device) performs the analysis identifying the conflict. For example, a cloud-based device may perform the analysis and transmit the indication of the conflict to an access device which may in turn display the indication to a user. In some embodiments, the computing device performing the analysis can be an access device displaying the interfaces shown in FIGS. 12-14. For example, the access device 108 (e.g., a mobile device) can determine whether the conflict exists and can generate and provide the indication of the conflict (e.g., on interface 1420).

As seen in FIG. 21, the interface 1920 may display an indication 2110 of the conflict. The indication 2110 can include content related to the conflict between the existing rule and the new rule. As illustrated, the message includes “It looks like you scheduled a conflicting rule for your Outlet. ‘On/Off Rule 1’ turns Outlet on while ‘On/Off Rule 2’ turns Outlet off from 2:00 AM-6:00 AM. Would you like to still use ‘On/Off Rule 2’?” The user may respond to the message by selecting “yes” or “no.” For example, when “yes” is selected, “On/Off Rule 1” can be canceled and replaced by “On/Off Rule 2.” In some embodiments, when “yes” is selected, “On/Off Rule 1” can be automatically modified to prevent the conflict (e.g., by moving the start time to 6:00 AM). When “no” is selected, “On/Off Rule 2” may be canceled and the new rule may not be stored. In some embodiments, the message can be provided through other means, including transmitting the message to a user device as a text message or Short Message Service (SMS), email message, audible message, or other suitable message format.

In some embodiments, the indication of the conflict may be provided by the computing device to another computing device. For example, the computing device that analyzes and identifies the conflict between the existing rule and the new rule may be an access device and the second computing device may be a cloud-based device. In some embodiments, the existing rule and new rule may be transmitted. For example, the existing rule and the new rule may be transmitted to a cloud-based device. When the cloud-based device (or other computing device) receives the rules, the cloud-based device may perform the analysis of the existing rule and the new rule and determine that the conflict exists. The indication of the conflict may be provided to the access device, network device, or any other computing device to help identify and/or resolve the conflict.

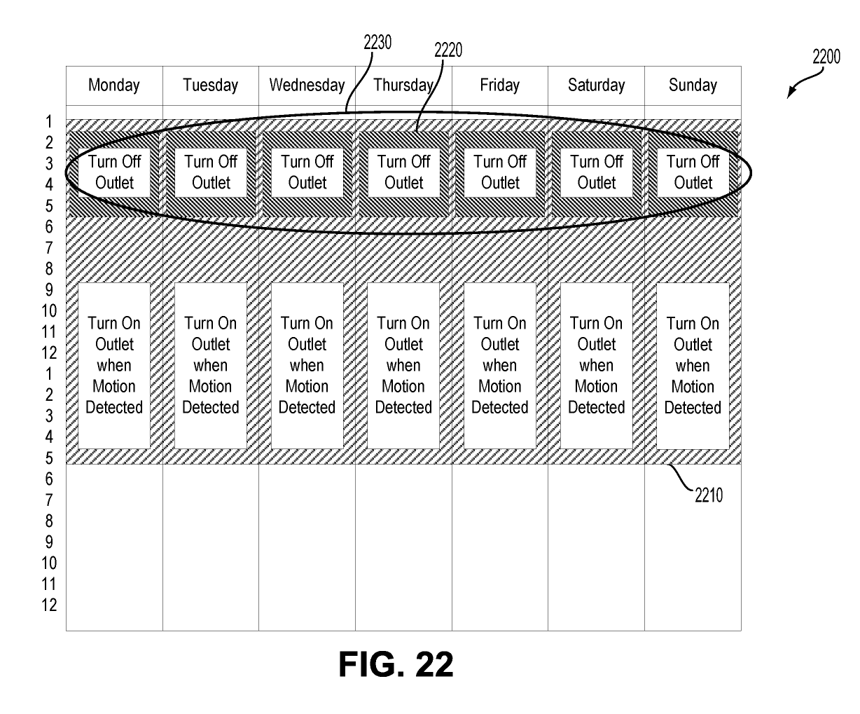

FIG. 22 shows an illustration of an example scheduling interface for providing an indication of a conflict between an existing rule and new rule assigned to a network device, in accordance with some embodiments. As illustrated, an indication of an existing rule 2210 can correspond with a rule to turn on the outlet when motion is sensed between 1:00 AM to 6:00 PM and an indication of a new rule 2220 can correspond with a rule to off the outlet between 2:00 AM to 6:00 AM. An indication 2230 of the conflict between the existing and new rules can be provided as well. The indication of the conflict may be highlighted for the user as a particular time frame where the rules conflict.

In some embodiments, the interface 2200 may be interactive and allow the user to adjust a new rule and/or existing rule to resolve the identified conflict. For example, the user may select an indication of the existing rule 2210 or the new rule 2220 and can drag an edge of the indication corresponding to the start or end time to a different time than that originally provided by the user. In some embodiments, adjusting the start and/or end time of the indication of a rule in the scheduling interface 2200 may cause the corresponding rule to be modified accordingly. As an illustration, existing rule 2210 corresponds with 1:00 AM to 6:00 PM and the new rule 2220 corresponds with 2:00 AM to 6:00 AM. A time gap in the middle of existing rule can be created, so that the existing rule does not exist between 2:00 AM to 6:00 AM. In another example, the end of the indication of the existing rule 2210 can be dragged up to 2:00 AM, so that the corresponding existing rule is 1:00 AM to 2:00 AM and the existing rule 2210 can occur again between 6:00 AM to 6:00 PM. This would eliminate the conflict between 2:00 AM and 6:00 AM, since the existing rule 2210 would not turn the outlet on during the same time frame that the new rule 2220 instructs the outlet to turn off.

In some embodiments, the user can cancel or delete a rule from interface 2200. For example, the user may select the indication of the new rule 1620 and delete the indication (e.g., on a virtual keyboard, by typing delete, by swiping the rule off of the interface, etc.).

In some embodiments, the interface 2200 can provide an indication 2230 of the conflict (e.g., instead of or in addition to the indication 2110 in FIG. 21). The indication 2230 of the conflict may show the overlapping rules and/or may be a notification or message that overlays on top of the interface 2200 (not shown).

In some embodiments, new or existing rules assigned to a network device may be analyzed for other types of conflicts, including to determine whether they are compatible with capabilities and limitations of a network device. For example, when an allowable range of temperatures is possible for a thermostat network device, any new rules that configure the thermostat to operate outside of that range may indicate a conflict. As an example illustration, a manufacturer may configure a thermostat to only allow temperatures up to 85 degrees. When a newly provided rule would configure the thermostat to 100 degrees, the computing device may identify the conflict and may prevent the rule from being created. In some embodiments, an indication of the conflict may be provided.

In some embodiments, a network device can be associated with multiple users (e.g., when multiple users assign rules to the same network device, etc.). In some embodiments, the users may be associated with a priority. For example, John and Jane may be the guardians of Jimmy. The new rules received from John or Jane may take priority over new rules received from Jimmy, so that when a conflict exists between a new rule or existing rule from John or Jane and a new or existing rule from Jimmy, the new or existing rule provided by Jimmy may be rejected (e.g., with or without an indication of the conflict). In some embodiments, such conflicts can be identified and resolved by a computing device such as an access device (e.g., a mobile device). In some embodiments, a cloud-based device can identify and resolve such conflicts, and an indication of the conflict can be provided by the cloud-based device to an access device.

In some embodiments, the new rules may be analyzed with respect to rules assigned to other network devices in other networks. For example, the analysis can include an identification of the most common rules in other networks. In another example, the analysis can consider automation parameters used to operate other network devices (e.g., of the same type). In some embodiments, rules and other automation parameters may be ranked, filtered, and/or sorted using various metrics, such as frequency, duration, recency, proximity, or any other suitable metrics. In some embodiments, based on the analysis of new rules, a message related to usage of the network device can be transmitted to a user device (e.g., a cellular phone).

Existing rules may be received from other networks. For example, a data store may exist on a cloud-based storage and include existing rules from various local area networks. In some embodiments, the existing rules in the data store may be analyzed. In some embodiments, the analysis may help determine common existing rules across several networks and/or other data metrics, and may further help determine how conflicts are resolved with other network devices associated with other networks. Such a determination may allow recommendations for resolution of the conflict to be made, or to allow rule conflicts to be resolved automatically (e.g., without input from the user).

In some embodiments, an automated process may help resolve the conflict. For example, the new rule and/or existing rule may be analyzed to determine feasibility (e.g., it is not feasible to set a thermostat to 150 degrees). In another example, the new rule and/or existing rule may be compared with other existing rules (e.g., other users in the same geographic area with a thermostat establish a rule that turns off the air conditioning at 6 PM). The comparison with other existing rules may include other network devices in the shared network or other network devices in other networks (e.g., local area networks within a geographic area, other networks that include the same network device, etc.), and may identify the likelihood that either the new rule or the existing rule should be used (or modified) to affect the operation of the network device without rule conflicts.

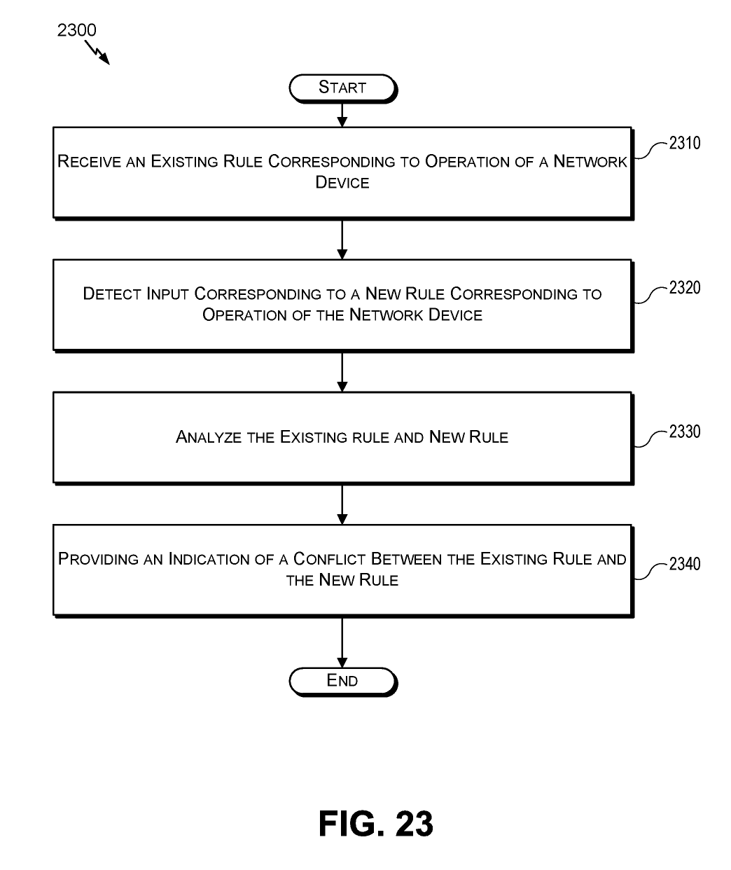

FIG. 23 is a flowchart illustrating a process for identifying and resolving network device rule conflicts, in accordance with some embodiments. Specifically, the process 2300 provides a technique to analyze an existing rule and a new rule to determine whether a conflict exists between the existing rule and new rule. The technique can be implemented by a computing device which may be a network device, a user device (e.g., an access device), or a cloud-based device.

Process 2300 is illustrated as a logical flow diagram, the operation of which represents operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, applications, objects, components, data structures, and the like that perform particular functions or implement particular data types. The order in which the operations are described is not intended to be construed as a limitation, and any number of the described operations can be combined in any order and/or in parallel to implement the processes.

Additionally, the process 2300 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium may be non-transitory.

At 2310, the process 2300 can include receiving an existing rule corresponding to operation of a network device. The existing rule may be received from the network device. For example, upon connecting to the network, the computing device (e.g., an access device such as a mobile phone) may receive existing rules from some or all network devices connected to the network. Exemplary network devices include, but are not limited to, interior network devices (e.g., light switch, outlet, motion sensor, fan, garage door opener, sprinklers, heater, television, etc.), exterior motion sensors, exterior lighting (e.g., porch lights, walkway lights, security lights, etc.), garage door openers, sprinkler systems, and other network devices usable in a user's home, office, business or other location.

At 2320, the process 2300 can include detecting input corresponding to a new rule corresponding to operation of the network device. For example, an interface may be provided via a computing device. The input detected corresponding to the new rule may include identification of the network device, scheduling information for the new rule (e.g., time of day, day of week, etc.), and/or other information.

At 2330, the process 2300 can include analyzing the existing rule and the new rule. For example, the analysis can include determining that a conflict exists between the existing rule and the new rule. In some embodiments, the conflict between the existing rule and the new rule corresponds to an interaction between the network device and another network device in a shared network (e.g., one network device provides information to another network device during an interaction or communication, etc.). For example, the conflict may relate to the interaction between a network device such as an outlet with another network device such as a motion sensor in the same network.

In some embodiments, the analysis to determine the conflict may be performed at various computing devices. For example, the existing rule and the new rule may be analyzed at a user device (e.g., an access device such as a mobile device), since both the existing rule and new rule may be received at the user device. In some embodiments, the existing rule and the new rule are transmitted to a cloud-based device (e.g., another type of computing device). The cloud-based device receives the existing rule and the new rule, performs the analysis of the existing rule and the new rule, and determines that the conflict exists.

In some embodiments, the conflict between the existing rule and new rule corresponds to a conflicting state of the network device. For example, the state of an outlet network device may not exist in both the “on” state and “off” state at the same time. In another example, the state of the light switch network device may not exist at both “50% brightness” and “100% brightness” at the same time.

In some embodiments, analyzing the existing rule and new rule includes analyzing rules corresponding to operation of other network devices in other networks. For example, a data store that includes the existing rule may exist on a cloud-based storage that include existing rules assigned to other network devices in other networks that may be analyzed. The analysis may help determine common existing rules across several networks and/or other data metrics, and may further help determine how conflicts are resolved with other network devices associated with other networks. Such a determination may allow recommendations for resolution of the conflict to be made, or to allow rule conflicts to be resolved automatically (e.g., without input from the user).

At 2340, the process 2300 can include providing an indication of the conflict between the existing rule and the new rule. The indication of the conflict may be provided to a user operating a user device (e.g., an access device, such as a mobile device). For example, the indication can be provided via an interface (e.g., including tiles, icons, names identifying different network devices, selectable icons and links, etc.) displayed on the user device. In another example, the indication of the conflict may be transmitted to a user device by a cloud-based device as a message. In such embodiments, the message can be provided as a text message or Short Message Service (SMS), email message, audible message, or other suitable message format.

In some embodiments, after providing the indication of the conflict, the computing device may detect input corresponding to a selection or modification of the existing rule or the new rule. This may include providing a visual display of the existing rule or the new rule and receiving a selection. The selection may identify which rule to keep and which rule to remove. In another example, the existing rule or new rule may be modified by the user to resolve the conflict. The selection or modification may be transmitted (e.g., to the network device for storage and subsequent execution of the rule).

In some embodiments, the indication of the conflict may include a recommendation for resolving the conflict. Such a recommendation can be based on the user's historical interaction with the network device, interaction by other users with other similar network devices in other networks, or any other suitable information. In some embodiments, upon identifying the conflict, an automated process can be initiated that resolves the conflict with user input. For example, the new rule and/or existing rule may be analyzed to determine feasibility (e.g., it is not feasible to set a thermostat to 150 degrees). In response to identifying lack of feasibility, the subject rule can be canceled or otherwise modified automatically. In another example, the new rule and/or existing rule may be compared with other existing rules (e.g., a majority of users in the area with a thermostat establish a rule that turns off the air conditioning at 6 PM). The comparison with other existing rules may include other devices in the shared network or other network devices in other networks (e.g., local area networks within a geographic area, networks that include the same outlet network device, etc.), and identify the likelihood that either the new rule or the existing rule provided by the user should be used (or modified) to affect the operation of the network device. In such scenarios, the subject rule can be canceled or otherwise modified automatically. When a conflict is resolved without user input, an indication of the conflict (e.g., an indication that the conflict was identified and resolved) can be provided. In some embodiments, when a rule conflict is resolved automatically, no indication that of the conflict resolution is provided.

Embodiments discussed herein also provide techniques that allow for identification of a recursive operation. The identification of the recursive operation may be identified at rule creation (e.g., before the new rule is assigned to and executed by a network device) or at run time (e.g., after a rule has been created and while it is being executed by a network device). As with identified conflicts, the user can be made aware of the recursive operation and can provide further instructions to resolve the recursive operation. The indication may include a recommended course of action to resolve the recursive operation. In some embodiments, upon identifying the recursive operation, the network device (or other computing device included in or associated with the network) may automatically cause the network device to stop the recursive operation, and may further resolve the recursive operation by cancelling, modifying, or updating an existing rule associated with the recursive operation (e.g., the existing rule assigned to the network device).

A recursive operation may include an operation of a network device where the operation repeats itself (e.g., in more than a threshold number of instances within a threshold period of time, etc.). For example, a first existing rule may turn on a light in the local area network, and execution of the first rule may trigger a second existing rule that may turn off the same light. Execution of the second rule may then trigger a third existing rule that causes the light to turn back on. When the first existing rule is activated, the light may be toggled on and off in succession, causing a recursive operation.

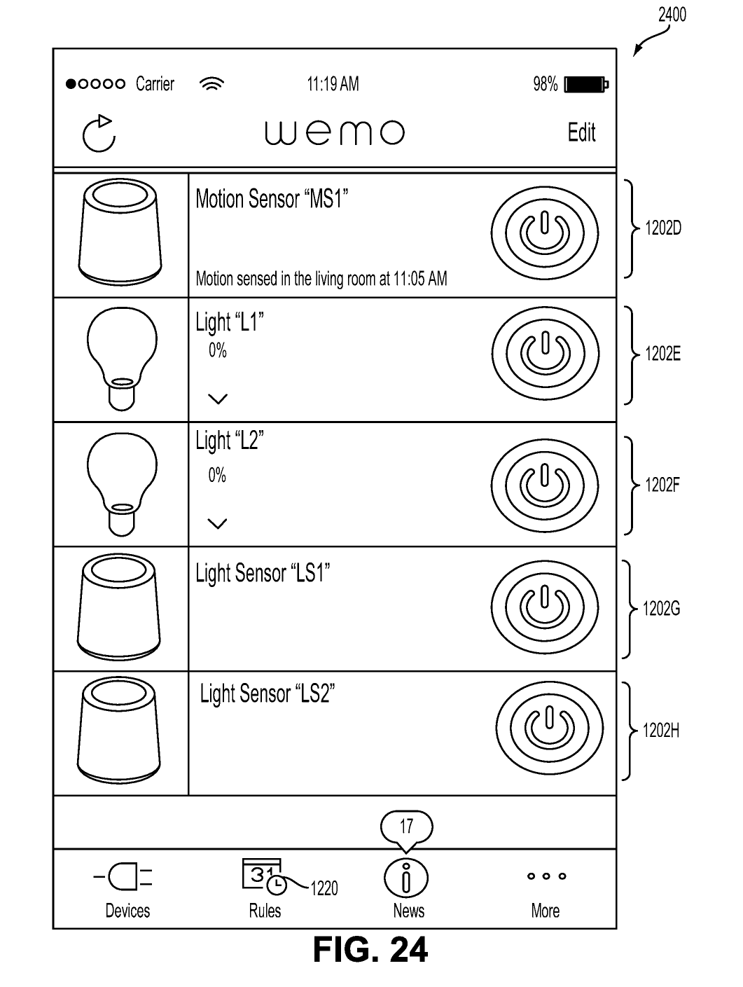

FIG. 24 an example interface for controlling network devices, in accordance with some embodiments. Interface 2400 is a visual interface usable to monitor and control one or more network devices and rules corresponding to operation of the network devices. Interface 2400 may be similar to display 1200 in FIG. 12. For example, in some embodiments, interface 2400 is provided through access device 108 (e.g., a mobile device) and includes modular tiles 1202D, 1202E, 1202F, 1202G, and 1202H (hereinafter “tiles 2402”) for interacting with network devices in a network. In this embodiment, tiles 2402 correspond with five different network devices, including a motion sensor “MS1,” light “L1,” light “L2,” light sensor “LS1,” and light sensor “LS2.”

In some embodiments, the information contained in tiles 2402 can be received via an intra-network communication (e.g., communication 310) between the computing device operating the interface 2400 and the network device. For example, the information in the communication can include information about icons, names, status, existing rules, or capabilities of one or more network devices. In some embodiments, a communication can be sent from the computing device to a network device to query the network device about its identity. In response to receiving the query, the network device may send communications to the computing device operating the interface 2400 with at least a unique interface module ID. The communication may provide the computing device with information that can be used to determine a basic, default visual interface that includes the tiles 2402.

As illustrated, rules icon 1220 can be selected to display existing rules pertaining to these network devices. For example, rules icon 1220 can be selected to display one or more existing rules assigned to the network devices. As an example illustration, the motion sensor “MS1” corresponding to tile 1202D may be assigned an existing rule that senses motion throughout the day. When motion is sensed by motion sensor “MS1,” an existing rule can, for example, turn on light “L1.” In another example, a light sensor “LS1” of tile 1202G can sense light from light “L1” (e.g., because this light is closest to “LS1”). The existing rule assigned to light sensor “LS1” can instruct light “L2” to turn on when light “L1” is on. That is, by selecting rules icon 1220, a user can review or provide a new rule that turns on a light when a light sensor detects that other lights in a room are on. In this way, rules can relate to interactions between multiple network devices.

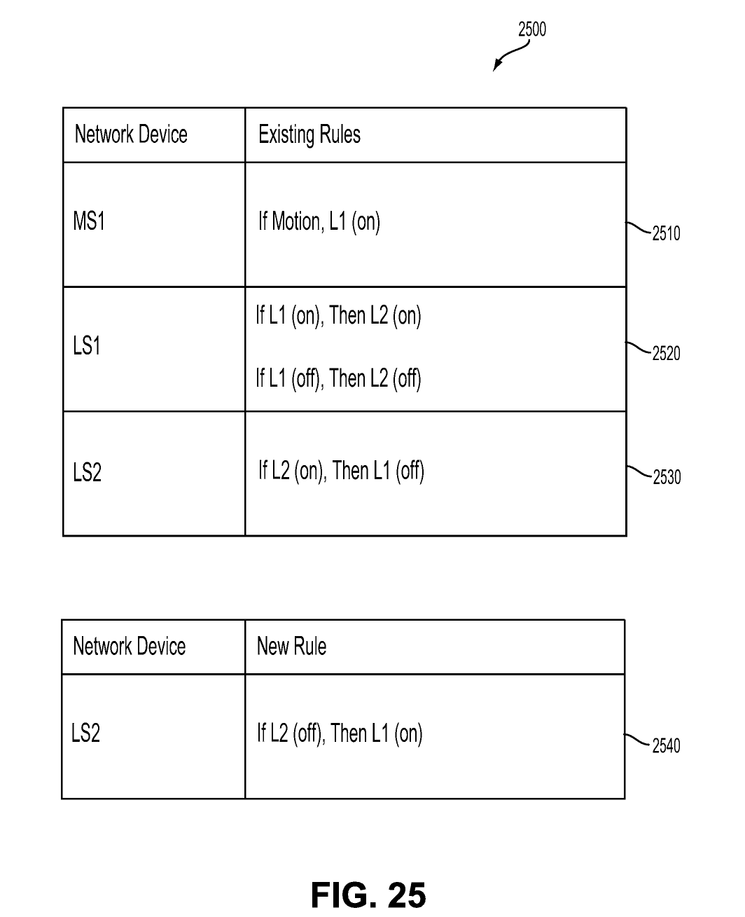

FIG. 25 shows an illustration of a data store including existing rules assigned to network devices and a new rule, in accordance with some embodiments. The data store 2500 may include one or more network devices and existing rules. In the example illustrated in FIG. 25, data store 2500 includes existing rules assigned to motion sensor “MS1,” light sensor “LS1,” and light sensor “LS2.” It should be appreciated, however, that data store 2500 can include existing rules describing any other suitable network devices, or corresponding electronic devices that are coupled with network devices, like a lamp plugged into an outlet network device. In some embodiments, data store 2500 can be included in a cloud-based device (e.g., the cloud network 114 illustrated in FIG. 1). In some other embodiments, data store 2500 can be included in any other suitable device such as network device 106, access device 108, gateway 110, etc.

The existing rules may include various types of information. For example, as illustrated in FIG. 25, the existing rules can include a rule 2510 that causes motion sensor “MS1” to turn light “L1” on when motion is sensed (i.e., “On/Off Rule 1”). Rules 2520 include two existing rules assigned to light sensor “LS1.” The first existing rule includes if light “L1” is on, then turn light “L2” on (i.e., “On/Off Rule 2”). The second existing rule includes if light “L1” is off, then turn light “L2” off (i.e., “On/Off Rule 4”). Rule 2530 includes a rule assigned to light sensor “LS2,” including if light “L2” is on, then turn light “L1” off (i.e., “On/Off Rule 3”).

A new rule is also shown in FIG. 25, including if light “L2” is off, then turn light “L1” on (i.e., “On/Off Rule 5”). The new rule 2540 may or may not be stored in data store 2500, based in part on whether the new rule creates a recursive operation of the network device, as described in further detail below. In some embodiments, the existing rules are created in response to user input, as described above with respect to FIGS. 13-14 and 18-19.

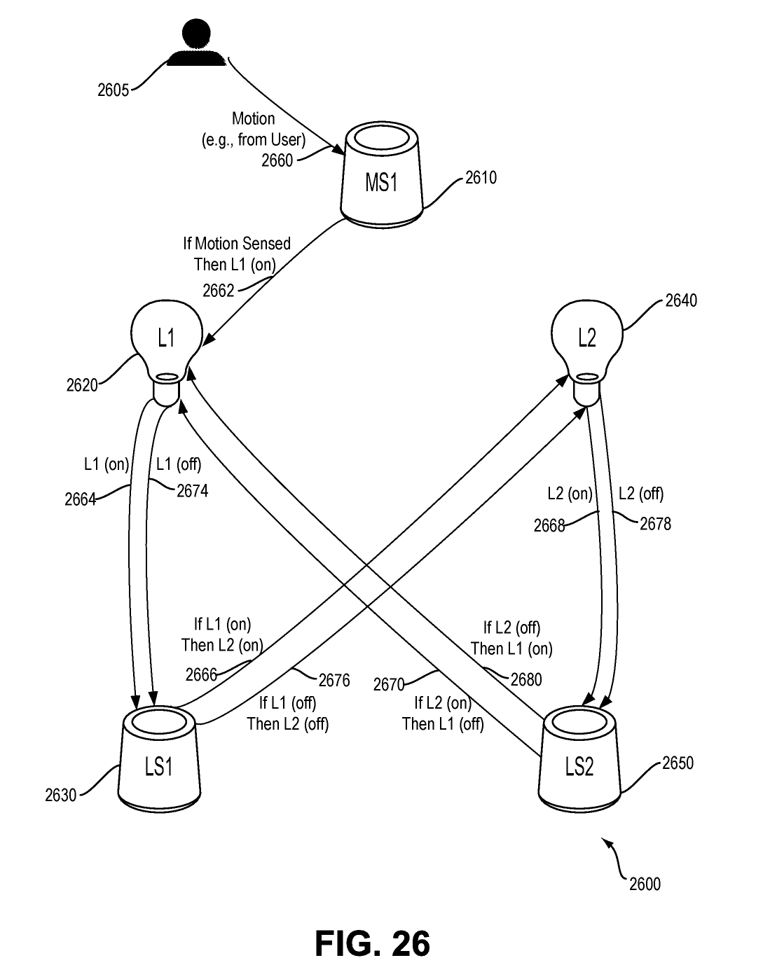

FIG. 26 shows an illustration of a recursive operation, in accordance with some embodiments. The recursive operation illustrated by FIG. 26 may result from the new rule and existing rules illustrated in FIG. 25 being executed. Embodiments of the invention may identify and resolve any other suitable recursive operations that may result from multiple rules being assigned to one or more network devices. In FIG. 26, an example 2600 is provided as a visual representation of a portion of a local area network that includes a user 2605, motion sensor “MS1” 2610, light “L1” 2620, light sensor “LS1” 2630, light “L2” 2640, and light sensor “LS2” 2650.

At 2660, motion is sensed at motion sensor “MS1” 2610. Motion sensor “MS1” 2610 may sense motion from user 2605 through various technologies. For example, motion may be sensed using passive infrared (IR) or microwave (e.g., radar) technologies. Motion may be sensed using other technologies as well, including projecting a beam of light and sensing when the beam of light is broken (e.g., using a photo-sensor), detecting motion through ultrasonic sound waves (e.g., as an “echo,” similar to that of microwave energy), and the like. It should be appreciated that other implementations of a motion sensor can used without diverging from the essence of the embodiments herein.

At 2662, “On/Off Rule 1” is activated, including if motion is sensed by motion “MS1” 2610, then turn light “L1” on. In some embodiments, light “L1” turns on. The interaction between the network devices can use various technologies. In some embodiments, the motion sensor “MS1” 2610 can provide a communication to light “L1” 2620 that instructs the light to turn on (e.g., indirectly via gateway 110, 112, directly via WiFi, or as any other suitable communication transmitted between the network devices discussed with respect to FIGS. 1-6). In some embodiments, the motion sensor “MS1” 2610 can provide a communication to gateway 110, 112 and/or cloud 114, and the gateway 110, 112 and/or cloud 114 can provide a communication to the light “L1.” The communication may include an instruction for light “L1” to turn on.

At 2664, light “L1” 2620 turns on and is sensed by light sensor “LS1” 2630. Light sensor senses light from light “L1” through various technologies. For example, the light sensor may be a type of photo-sensor or photo-detector that senses light or other electromagnetic energy. In another example, the light sensor “LS1” may determine the light is detected from light “L1,” because light “L1” is the closest light to light sensor “LS1.” In yet another example, light sensor “LS1” may determine that the light “L1” is on, because the light “L1” transmits an indication that it is on to the light sensor “LS1.” It should be appreciated that other implementations of a light sensor can used without diverging from the essence of the embodiments herein.

At 2666, “On/Off Rule 2” is activated, including if light (e.g., from light “L1”) is sensed by light sensor “LS1” 2630, then turn light “L2” on. In some embodiments, light “L2” turns on in response to, for example, a command sent to light “L2” by light sensor “LS1”.

At 2668, light “L2” 2640 turns on and is sensed by light sensor “LS2” 2650. Light sensor “LS2” 2650 may operate in substantially the same way as light sensor “LS1” 2630 and may sense light from light “L2” through various technologies.

At 2670, “On/Off Rule 3” is activated, including if light (e.g., from light “L2”) is sensed by light sensor “LS2” 2650, then turn light “L1” off. In some embodiments, light “L1” turns off in response to, for example, a command sent to light “L1” by light sensor “LS2”.

At 2674, light “L1” 2620 turns off and is sensed by light sensor “LS1” 2630. Light sensor may sense the absence of light from light “L1” through various technologies described above.

At 2676, “On/Off Rule 4” is activated, including if light (e.g., from light “L1”) is not sensed by light sensor “LS1” 2630 (or if the light sensor senses that the light has been turned off), then turn light “L2” off. In some embodiments, light “L2” turns off in response to, for example, a command sent to light “L2” by light sensor “LS1”.

At 2678, light “L2” 2640 turns off and this is sensed by light sensor “LS2” 2650. At 2680, “On/Off Rule 5” is activated, including if light (e.g., from light “L2”) is not sensed by light sensor “LS2” 2650, then turn light “L1” on. In some embodiments, light “L1” turns on in response to, for example, a command sent to light “L1” by light sensor “LS2”.

As illustrated, the execution of the new rule and existing rules may create a recursive operation. For example, when motion is sensed, the existing rules and the addition of the new rule may correspond to a recursive operation where the light “L1” and light “L2” will repeatedly toggle between both “on” and “off” states when the existing rules and the new rule are executed. By analyzing the new rule and the existing rules, this recursive operation can be identified.

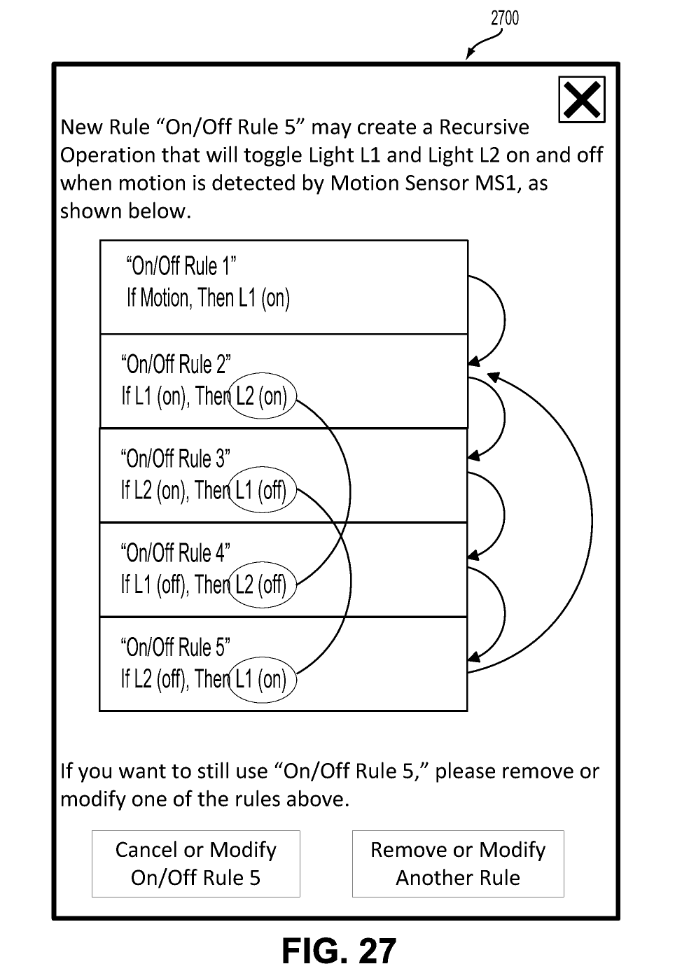

FIG. 27 shows an illustration of providing an indication of a recursive operation, in accordance with some embodiments. The indication 2700 of a recursive operation may be provided after the user attempts to save the new rule (e.g., by selecting the save option 1430 in FIG. 14 or the save option 1930 in FIG. 19).

The indication may be provided by a computing device after identifying the recursive operation. For example, the computing device may be a cloud-based device that receives the existing rule and new rule. The cloud-based device can perform the analysis, determine that a recursive operation exists, and transmit the indication of the recursive operation to an access device 108 (e.g., a mobile device). The indication of the recursive operation may be transmitted as a message, such as a text message or Short Message Service (SMS), email message, audible message, or other suitable message format. In some embodiments, the computing device can be an access device that analyzes the new rule and existing rules, identifies the recursive operation, and provides (e.g., displays) the indication of the recursive operation.

As seen in FIG. 27, an indication 2700 of the recursive operation may be displayed on an interface of a computing device (e.g., the access device). The indication can include content related to the conflict between the existing rules and the new rule. As illustrated, the indication 2700 includes “New Rule ‘On/Off Rule 5’ may create a Recursive Operation that will toggle Light ‘L1’ and Light ‘L2’ on and off when motion is detected by Motion Sensor ‘MS1,’ as shown below. If you want to still use ‘On/Off Rule 5,’ please remove or modify one of the rules above.” The indication 2700 can also include one or more illustrations or animations of the recursive operation to help illustrate the recursive operation for the user.

As described above, such a recursive operation can be identified by analyzing the existing rule and the new rule. The user may respond to the message by selecting “cancel or modify On/Off Rule 5” or “remove or modify another rule.” For example, when “cancel or modify On/Off Rule 5” is selected, “On/Off Rule 5” is canceled and not stored for execution. When “remove or modify another rule” is selected, an interface may allow the user to select which rule can be canceled or modified to avoid the recursive operation. A particular rule may be selected and canceled or modified (e.g., “On/Off Rule 3” or another rule).

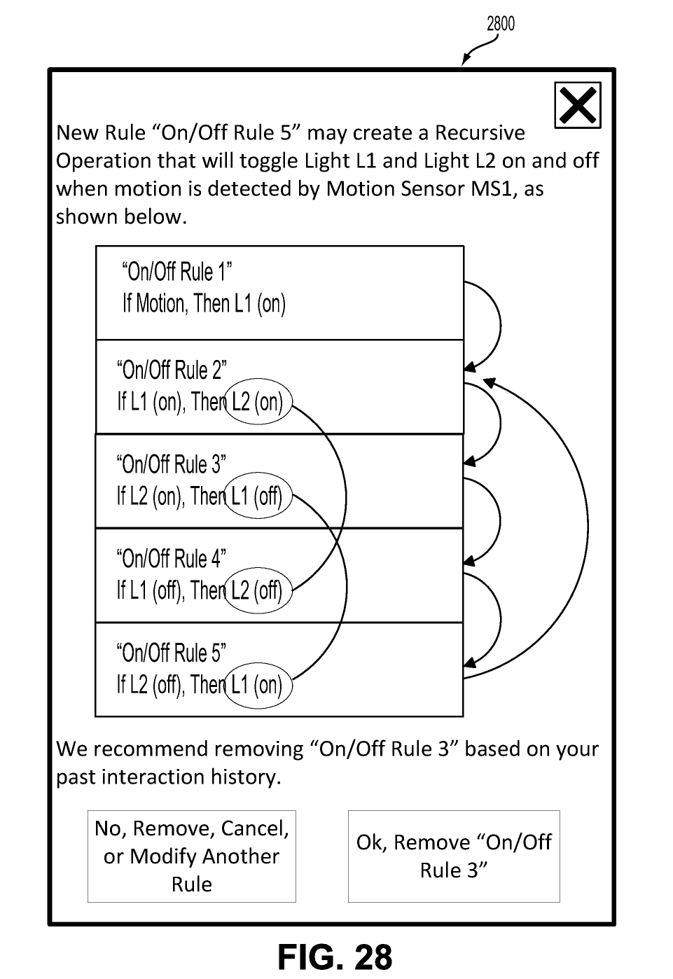

FIG. 28 shows an illustration of providing an indication of a recursive operation, in accordance with some embodiments. The indication 2800 of a recursive operation may be provided after the user attempts to save the new rule (e.g., by selecting the save option 1430 in FIG. 14 or the save option 1930 in FIG. 19). The indication 2800 may be provided to indicate the recursive operation. As illustrated, the indication 2800 includes “New Rule ‘On/Off Rule 5’ may create a Recursive Operation that will toggle Light ‘L1’ and Light ‘L2’ on and off when motion is detected by Motion Sensor ‘MS1,’ as shown below. We recommend removing ‘On/Off Rule 3’ based on past interaction history.” The indication 2800 can also include one or more illustrations or animations of the recursive operation to help illustrate the recursive operation for the user.

The recommendation can be generated in response to an analysis of the user's historical interaction with a network device associated with the recursive operation. For example, if the user has manually turned on light “L1” in the past after the existing rule “On/Off Rule 3” turns light “L1” off, the existing rule “On/Off Rule 3” may be identified as a low priority rule that should be removed or modified. In some embodiments, recommendations can be provided based on other users' interactions with similar network devices in other networks, or based on other suitable metrics that may identify which existing or new rule the user may prefer to remove or modify in order to avoid the recursive operation.

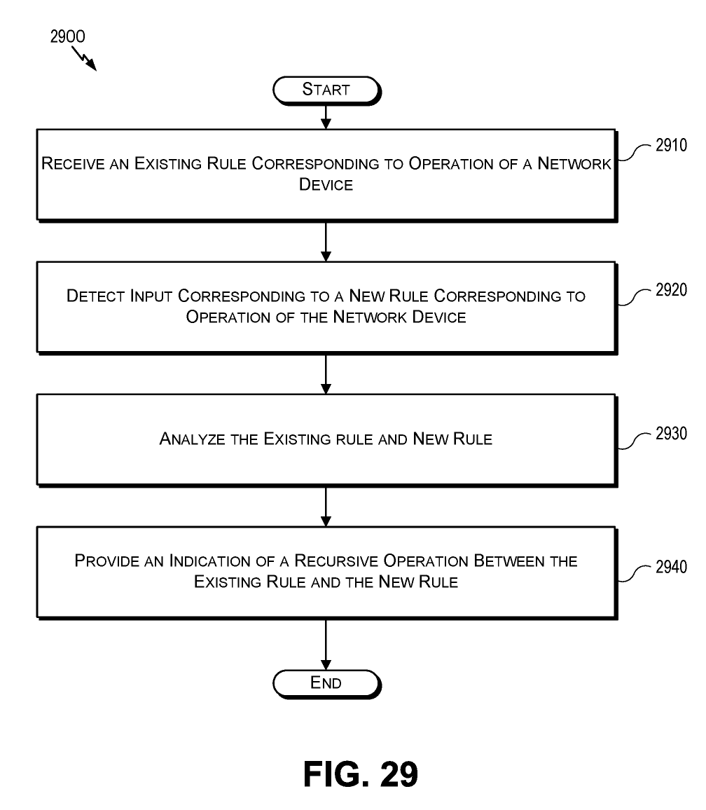

FIG. 29 is a flowchart illustrating a process for identifying and resolving recursive operations with a network device, in accordance with some embodiments. Specifically, the process 2900 provides a technique to analyze an existing rule and a new rule to determine whether a recursive operation exists between the existing rule and new rule. The technique can be implemented by a computing device which may be a network device, a user device (e.g., an access device such as a mobile device), or a cloud-based device.

Process 2900 is illustrated as a logical flow diagram, the operation of which represents operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, applications, objects, components, data structures, and the like that perform particular functions or implement particular data types. The order in which the operations are described is not intended to be construed as a limitation, and any number of the described operations can be combined in any order and/or in parallel to implement the processes.

Additionally, the process 2900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium may be non-transitory.

At 2910, the process 2900 can include receiving an existing rule. The existing rule can correspond to the operation of a network device. In some embodiments, the existing rule may be received at a computing device. The existing rule may be received from the network device. For example, upon connecting to the network, the computing device (e.g., an access device such as a mobile phone) may receive existing rules from some or all network devices connected to the network. Suitable network devices include, but are not limited to, interior network devices (e.g., light switch, outlet, motion sensor, fan, garage door opener, sprinklers, heater, television, etc.), exterior motion sensors, exterior lighting (e.g., porch lights, walkway lights, security lights, etc.), garage door openers, sprinkler systems, and other network devices usable in a user's home, office, business or other location. In some embodiments, the existing rule is one of multiple existing rules associated with the recursive operation of the network device.

At 2920, the process 2900 can include detecting input corresponding to a new rule corresponding to operation of the network device. For example, an interface may be provided via a computing device. The input detected corresponding to the new rule may include identification of the network device, scheduling information for the new rule (e.g., time of day, day of week, etc.), and/or other information. In another example, the input corresponding to the new rule may correspond to modification of an existing rule.

At 2930, the process 2900 can include analyzing the existing rule and the new rule. In some embodiments, the analysis can include determining that the new rule and the existing rule are associated with a recursive operation of the network device. For example, the recursive operation between the existing rule and the new rule can correspond with an interaction between the network device and another network device in a shared network (e.g., one network device provides information to another network device during an interaction or communication, etc.).

In some embodiments, the analysis to determine the recursive operation may be performed at various computing devices. For example, the existing rule and the new rule may be analyzed at a user device (e.g., an access device such as a mobile device), since both the existing rule and new rule may be received at the user device. In some embodiments, the existing rule and the new rule are transmitted to a cloud-based device (e.g., another type of computing device). The cloud-based device receives the existing rule and the new rule, performs the analysis of the existing rule and the new rule, and determines that the recursive operation will or may occur when the existing rule and new rule are executed.

In some embodiments, the recursive operation can cause a state of the network device to be repeatedly toggled. For example, the state of a light network device may be repeatedly toggled between the “on” state and the “off” state in rapid succession when a recursive operation occurs.

In some embodiments, analyzing the existing rule and new rule includes analyzing rules corresponding to operation of other network devices in other networks. For example, a data store that includes the existing rule may exist on a cloud-based storage and include existing rules from other network devices in other networks. In some embodiments, the existing rule and new rule may be analyzed by the cloud-based storage. The analysis may help determine common existing rules across several networks and/or other data metrics, and may further help determine how recursive operations are resolved with other network devices associated with other networks. Such a determination may allow recommendations for resolution of the recursive operation to be made, or to allow recursive operation to be resolved automatically (e.g., without input from the user).

At 2940, the process 2900 can include providing an indication of the recursive operation. For example, providing an indication of the recursive operation can include identifying (e.g., by the access device) that a new rule is associated with a recursive operation (e.g., so that the new rule can be canceled or modified, so the existing rule can be modified or removed, etc.). In some embodiments, providing the indication of the recursive operation can include displaying the indication of the recursive operation, for example, by the access device. Examples of some indications of the recursive operation are illustrated in FIGS. 27-28.

In some embodiments, recommendations can be provided to prevent the recursive operation of the network device from being executed. For example, providing the indication of the recursive operation can include providing a recommendation corresponding to removal or modification of the existing rule to prevent the recursive operation, or providing a recommendation corresponding to cancelation or modification of the new rule to prevent the recursive operation. In some embodiments, providing an indication of the recursive operation can initiate an automatic operation performed by the network device. For example, automatic operation can include automatically removing, canceling, or modifying one or more existing rules or new rules. Thus, in such embodiments, providing the indication of the recursive operation can include providing an indication that the existing rule has been automatically removed or modified to prevent the recursive operation, or an indication that the new rule has been automatically canceled or modified to prevent the recursive operation.

In some embodiments, one or more actions (e.g., detections, transmissions of indications, changing/modifying/canceling rules, etc.) may be performed after the indication of the recursive operation is provided. Such actions may include input provided by the user to remove, modify, or cancel a rule to prevent the recursive operation from being executed. For example, input can be received corresponding to removal or modification of the existing rule, or cancelation or modification of the new rule. When input corresponding to removal or modification is received, the removal or modification of the existing rule can be transmitted. In some embodiments, the removal or modification can be transmitted to the network device, a cloud-based device, or any other suitable computing device. When input corresponding to cancelation or modification of the new rule is received, the cancelation or modification of the new rule can be transmitted. In some embodiments, the cancelation or modification of the new rule can be transmitted to the network device, a cloud-based device, or any other suitable computing device. Transmitted rule removals, modifications, and cancelations can be stored by the receiving device, and may prevent future executions of the recursive operation of the network device.

Techniques associated with the present disclosure are also related to analyzing real-time operations of a network device in accordance with assigned rules to identify that the operations of the network device include a recursive operation of a network device. For example, a new rule may be created that causes a recursive operation of the network device (e.g., that was not identified at rule creation and yet creates a recursive operation during real-time operation of the network device). In some embodiments, multiple rules corresponding to operations of a network device can be received by a computing device. Operations of the network device can be detected. These operations may be in accordance with the multiple rules. In some embodiments, the operations of the network device may be analyzed, which can include identifying that the operations of the network device include a recursive operation. An indication of the recursive operation may be provided.

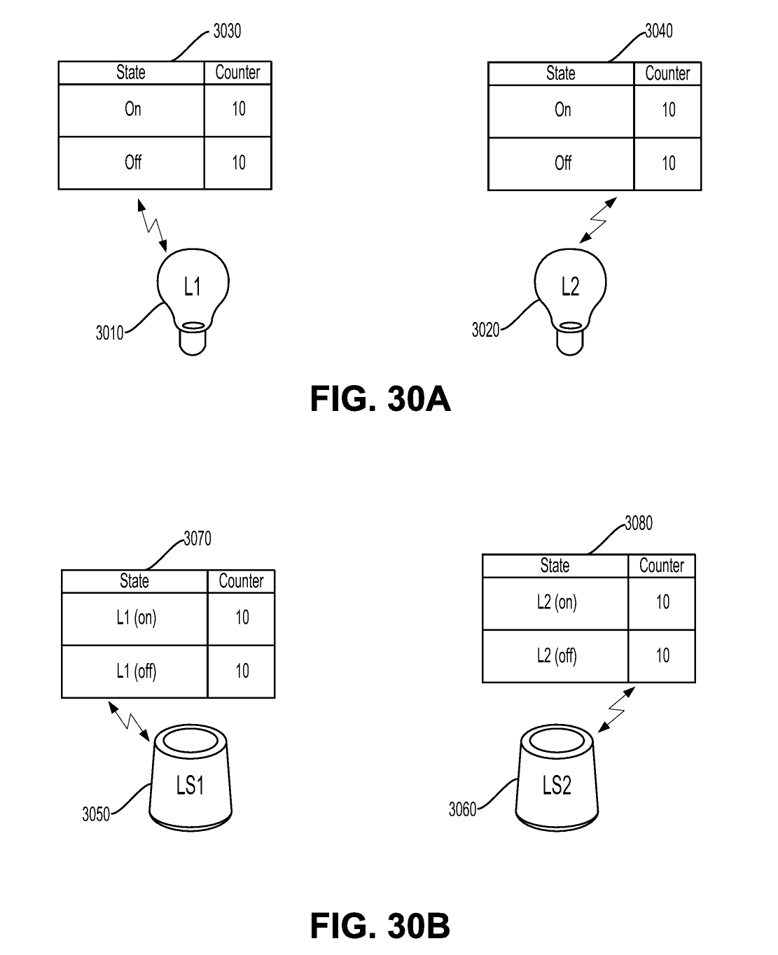

In some embodiments, counters can be used to identify recursive operations at a network device. FIGS. 30A and 30B show illustrations of a counter associated with a recursive operation, in accordance with some embodiments. These illustrations include examples of a state associated with a network device and a counter. In some embodiments, the state of the network device can include whether the network device is on or off, how the network device is situated within the network with respect to the other network devices in the network, or other information. Counters can be stored on any suitable computing device such as on the network device, a cloud-based device, a user-device (e.g., an access device 108 such as a mobile device), etc.

In some embodiments, the counter can include the number of iterations that a state has been activated for a particular network device. For example, if the network device (e.g., light “L1”) turns on, a counter assigned to the “on” state may increment by one (e.g., from 0 to 1). If the same network device turns off, a counter assigned to the “off” state may also increment by one. In some embodiments, a unique counter may correspond with each of the different states of a network device (e.g., one counter for an “on” state, one counter for an “off” state, one counter for a state where the light is at 50% brightness, etc.). In some embodiments, the counter may reset. For example, the counter may reset to zero after some threshold of time (e.g., every 5 seconds, 30 seconds, 60 seconds, etc.).

In some embodiments, when a counter meets or exceeds a threshold value, this may indicate a recursive operation of the corresponding network device. For example, the counter may begin at zero and increment to 10 in less than 2 seconds (e.g., through a recursive operation that instructs a light network device to toggle on and off). When the counter meets or exceeds a threshold value (e.g., 10), a notification may be provided. The notification can include an indication that the counter has met or exceeded the threshold value and/or information on the operation of the network device (e.g., a recursive operation that caused the network device to toggle to an “on” state 10 times in 2 seconds).

The notification may be provided (e.g., displayed) to the user on the access device. In some embodiments, in response to the counter threshold value being met or exceeded, the existing rules assigned to the network device and other network devices in the same network can be analyzed to identify which rules have resulted in the recursive operation. Such analysis can be performed as described above with respect to FIGS. 24-28, and the provided notification can include an indication of the recursive operation such as those illustrated in FIGS. 27-28.

In some embodiments, the operation of a network device may automatically stop in response to a counter meeting or exceeding a threshold. For example, when the light network device toggles on and off 10 times in 2 seconds, an existing rule associated with the network device (e.g., from the manufacturer, provided by the user, from a cloud-based device, etc.) may instruct the light network device to stop toggling once the number of state changes of the network device meets or exceeds the counter threshold. In some embodiments, the light network device may continue operating in response to other existing rules (e.g., dimming at a certain time, etc.) after the recursive operation has been terminated.

As illustrated in FIG. 30A, network device light “L1” 3010 and network device light “L2” 3020 are each associated with counters corresponding to an “on” state and an “off” state. An identification of the state of network devices and the corresponding counter values may be stored in a data stores 3030 and 3040, respectively. In some embodiments, when the light “L1” 3010 turns to an “on” state, the counter corresponding to this state may increment by one (e.g., from 9 to 10). Similarly, when the light “L1” 3010 turns to an “off” state, the counter corresponding to this state may increment by one (e.g., from 9 to 10). In some embodiments, when the value of the counter meets or exceeds a threshold (e.g., 10), a notification may be provided and/or the operation of the network device may stop following the existing rule that is causing the network device to toggle on and off.

In some embodiments, when the light “L2” 3020 turns to an “on” state, the counter corresponding to this state may increment by one (e.g., from 9 to 10). Similarly, when the light “L2” 3020 turns to an “off” state, the counter corresponding to this state may increment by one (e.g., from 9 to 10). In some embodiments, when the counter value meets or exceeds a threshold (e.g., 10), a notification may be provided and/or the operation of the network device may stop following the existing rule that is causing the network device to toggle on and off.

Counters may also be used when one network device instructs another network device to perform an operation. For example, a light sensor may be associated with an existing rule that instructs a light to turn on when motion is sensed. The state of the light may be stored in a data store associated with the light sensor to help keep track of whether the light has met or exceeded a threshold value of iterations associated with a changing state of the light.

As illustrated in FIG. 30B, network device light sensor “LS1” 3050 and network device light sensor “LS2” 3060 are each associated with an “on” state and an “off” state of a corresponding light, including light “L1” and light “L2”, respectively. An identification of the state of network devices and the corresponding counter values may be stored in a data stores 3070 and 3080, respectively. Light sensor “LS1” 3050 may be associated with an existing rule that instructs light “L1” to turn on and another existing rule that instructs light “L1” to turn off. In some embodiments, when the light sensor “LS1” 3050 instructs the light “L1” 3010 to turn to an “on” state, the counter corresponding to this state may increment by one (e.g., from 9 to 10). Similarly, when the light sensor “LS1” 3050 instructs the light “L1” 3010 turns to an “off” state, the counter corresponding to this state may increment by one (e.g., from 9 to 10). In some embodiments, when the value of the counter meets or exceeds a threshold (e.g., 10), a notification may be provided and/or the operation of the network device may stop following the existing rule that is causing the network device to toggle on and off.

Similarly, light sensor “LS2” 3060 may be associated with an existing rule that instructs light “L2” to turn on and another existing rule that instructs light “L2” to turn off. In some embodiments, when the light sensor “LS2” 3060 instructs the light “L2” 3020 to turn to an “on” state, the counter may increment by one (e.g., from 9 to 10). Similarly, when the light sensor “LS2” 3060 instructs the light “L2” 3020 turns to an “off” state, the counter may increment by one (e.g., from 9 to 10). In some embodiments, when the value of the counter meets or exceeds a threshold (e.g., 10), a notification may be provided and/or the operation of the network device may stop following the existing rule that is causing the network device to toggle on and off.

After the recursive operation and its cause are identified (e.g., or concurrently, in parallel, before, etc.), an indication can be provided. In some embodiments, the indication can include an identification of a relationship between the rules, input (e.g., rules, responses to notifications, etc.) that caused the recursive operation, and/or recommendations to modify, cancel, remove, or otherwise adjust the existing rules to avoid the recursive operation (e.g., as described above). Examples of some indications of the recursive operation are illustrated in FIGS. 27-28.

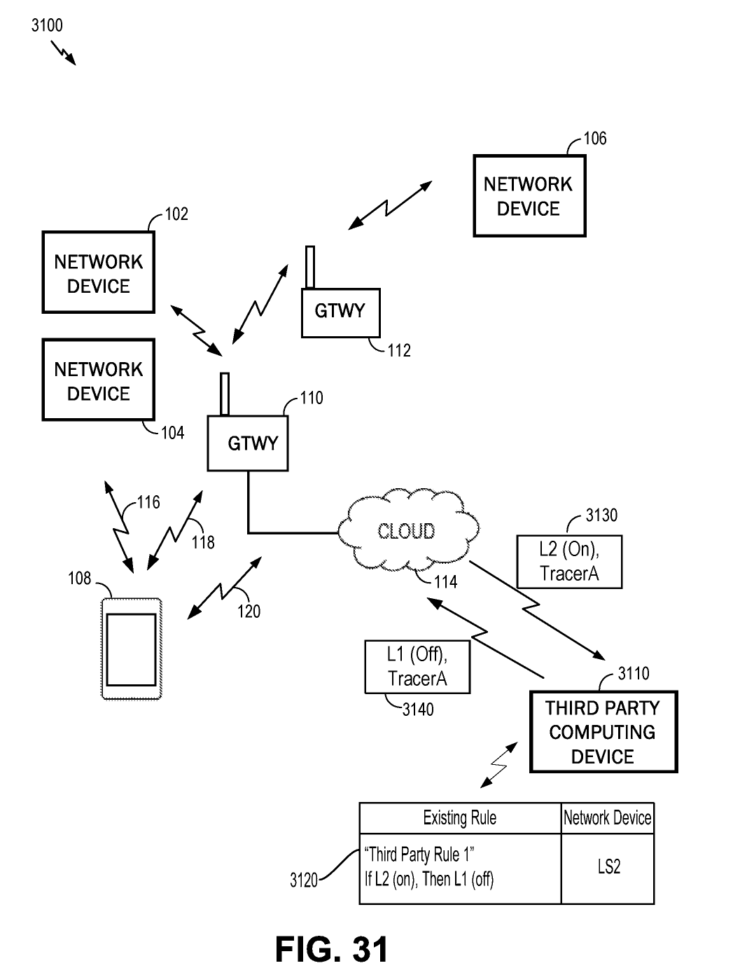

Other techniques are related to analyzing real-time operations of a network device in accordance with existing rules to identify whether operations of the network device include a recursive operation where, for example, one or more rules are executed at least in part by a third party computing device, as illustrated in FIG. 31.

FIG. 31 shows an illustration of a third party computing device associated with a recursive operation, in accordance with some embodiments. The local area network 3100 may be similar to the local area network 100 illustrated in FIG. 1, including network device 102, 104, 106, access device 108, gateways 110, 112, cloud network 114, and communication signals 116, 118, 120. The local area network 3100 may also be communicatively coupled to a third party computing device 3110 that stores or otherwise has access to an existing rule 3120 corresponding to operation of a network device within the local area network 3100. As illustrated in FIG. 31, the third party computing device 3110 may be configured to exchange communications with the cloud network 114, such as an outgoing communication 3130 (e.g., from the cloud network 114 to the third party computing device 3110), and an incoming communication 3140 (e.g., from the third party computing device 3110 to the cloud network 114). In some embodiments, the third party computing device 3110 may be configured to send and/or receive communications to/from any other suitable computing device included in the local area network 3100.

The network devices in the local area network 3100 may perform operations based in part on multiple rules, including one or more existing rules corresponding to operations of the network devices which can be stored locally at the network devices 102, 104, and 106, with the gateway 110 or 112, and/or at the cloud network 114. For example, a light switch network device can store one or more rules that cause a light network device (e.g., that corresponds with the light switch network device) to turn on when the one or more rules are executed. The operations may be in association with multiple rules corresponding to operations of the network device that are stored internally with these network devices.

The operations performed in the local area network 3100 may also be affected by external computing devices, including the third party computing device 3110. The third party computing device 3110 may be a computing device that is “outside” the local area network 3100 such that it is remotely located (in an operational and/or spatial sense) from network devices 102, 104, and 106, the gateway 110 or 112, and the cloud network 114. The third party computing device 3110 can implement existing rules (e.g., existing rule 3120) corresponding to operations of a network device in the local area network 3100. In some embodiments, such existing rules are stored locally at the third party computing device 3110 and, in some embodiments, not stored locally at the network devices or other computing devices in the local area network 3100.

The third party computing device 3110 may receive input relating to a change in state of a network device or other information relating to the local area network 3100 in the form of a communication transmitted by, for example, the cloud network 114. Upon receipt of such input, the third party computing device 3110 can analyze existing rules assigned to the network device (e.g., existing rule 3120) to determine whether a rule is triggered by the received input. If a rule is triggered, the third party computing device can provide an output to, for example, the cloud network 114, the output causing the rule to be executed such that a corresponding operation is performed by the network device to which the triggered rule is assigned. For example, the third party computing device 3110 may provide instructions based on an existing rule that alters the operation of the network device (e.g., turns the network device on or off). Thus, in some embodiments, the third party computing device 3110 changes operations of network devices in local area network 3100 by storing rules associated with network devices, receiving input (e.g., from the cloud network 114), and transmitting an output back to the local area network 3100 via the cloud network 114 that implements a rule triggered by a change in state of a network device or other information relating to the local area network 3100.

In some embodiments, when a recursive operation performed by a network device is detected (e.g., when a counter value is met or exceeded), the recursive operation may be due to multiple rules assigned to the network device, such that one or more of the rules is stored within the local area network 3100 (e.g., within the network device) and one or more of the rules is stored external to the local area network (e.g., at the third party computing device 3110). For example, referring back to the above illustration described with respect to FIGS. 24-28, “On/Off Rules 1-2” and “4-5” may be stored within the local area network 3100, whereas “On/Off Rule 3” is replaced by an equivalent “Third Party Rule 1” stored at (or otherwise accessible to) the third party computing device 3110.

When the recursive operation is detected, an analysis of just the existing rules stored within the local area network 3100 may not identify the cause of the recursive operation. Instead, the “Third Party Rule 1” may need to be identified and analyzed along with the rules stored within the local area network 3100 in order to identify all the rules that in the aggregate have caused the recursive operation at the network device.

In some embodiments, the relationship between rules stored within the local area network 3100 and rules stored at the third party computing device 3110, and thus the cause of the recursive operation, can be identified by use of a tracer identifier included in communications sent to and received from the third party computing device 3110. For example, when an input is provided by the cloud network 114 to the third party computing device 3110 (e.g., in the form of outgoing communication 3130), the input may include the change in state (e.g., that light “L2” is on) in addition to a tracer in the form of a globally unique identifier. Upon analyzing the input and determining that a rule assigned to the network device is triggered, the third party computing device 3110 may transmit an output to the cloud network 114 (e.g., in the form of incoming communication 3140), the output including an instruction to cause the network device to perform the operation defined by the triggered rule in addition to the same tracer identifier.

When a recursive operation is detected at a network device within the local area network 3100 (e.g., by detecting one or more counter threshold values being exceeded), existing rules stored within or otherwise accessible to local area network 3100 can be analyzed. In some embodiments, if the recursive relationship is not identified based only on such rules, communications exchanged with the third party computing device 3110 can also be analyzed in an effort to identify the cause of the recursive operation. For example, communications exchanged around the same time that the recursive operation occurred can be analyzed. Since an input provided to the third party computing device 3110 and the output received from the third party computing device 3110 include the same tracer identifier, the relationship between these communications can be determined. Thus, in the example illustrated in FIG. 31, it can be determined that an input provided to the third party computing device 3110 indicated that light “L2” is in the “on” state, and that the corresponding output received from the third party computing device 3110 indicated that the light “L1” is to be changed to the “off” state in response to the light “L2” being in the “on” state. This relationship can then be analyzed in conjunction with the rules stored within (or otherwise accessible to) the local area network 3100 (e.g., “On/Off Rules 1-2” and “4-5”), and the cause of the recursive operation (i.e., rules that are both internal and external to the local area network 3100) can be identified. This process of identifying a recursive operation caused by internal rules in conjunction with one or more rules stored externally at the third party computing device 3110 can be performed by the cloud network 114 or any other suitable computing device included in the local area network 3100.

In some embodiments, communication exchanged with the third party computing device 3110 can be used to identify that the recursive operation is in fact occurring. For example, similar to the counter values assigned to particular network devices (e.g., as described above in regards to FIG. 30A-30B), a counter may be used to keep track of instructions received from the third party computing device 3110. For example, the cloud network 114 or other computing device in the local area network 3100 can receive an incoming communication from the third party computing device 3110 such as incoming communication 3140 (e.g., turn light “L1” off). In response, a counter assigned to this change in state of the light “L1” can be incremented. As subsequent instructions to turn the light “L1” on are received from the third party computing device 3110, the counter can be incremented accordingly. When the counter value meets or exceeds a threshold value within a predetermined interval of time, this may indicate that a recursive operation is occurring at the light “L1”. In some embodiments, counters can be assigned to instructions received from the third party computing device 3110 that cause a change in operation of any suitable network device. When a recursive operation is identified based on a counter value meeting or exceeding a threshold value, the cause of the recursive operation (e.g., the relationship between both internal and external rules) can be identified as described above. In some embodiments, recursive operations may result from only execution of external rules and, in such embodiments, the cause of recursive operations can be identified as described above.

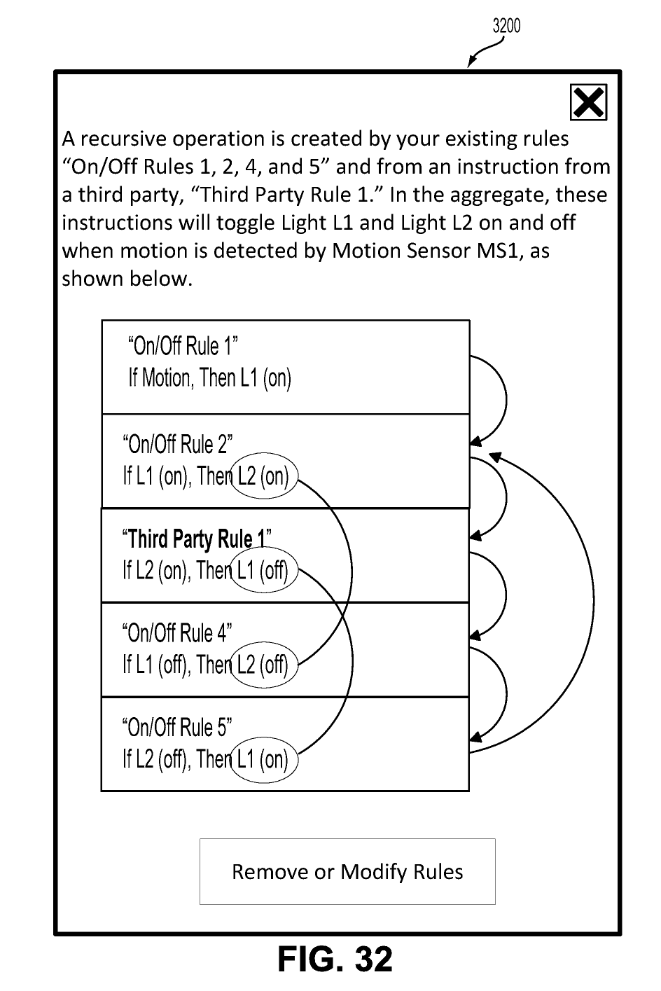

After the recursive operation and its cause are identified, an indication can be provided. In some embodiments, the indication can include an identification of a relationship between the rules, input (e.g., rules, responses to notifications, etc.) that caused the recursive operation, and/or recommendations to modify, cancel, remove, or otherwise adjust the existing rules to avoid the recursive operation (e.g., as described above). An example indication is illustrated in FIG. 32.

FIG. 32 shows an illustration of providing an indication of a recursive operation, in accordance with some embodiments. The indication can include information associated with the recursive operation, including a relationship between existing and/or third party rules, which rules are stored within the network and which rules are stored at the third party, and/or an indication of the states that are being toggled as a result of the recursive operation. The recursive operation can be identified by analyzing the existing rules and in addition to communications with the third party computing device 3110.

As illustrated in FIG. 32, the recursive operation can be associated with existing rules assigned by a user at the network device in conjunction with one or more rules executed at least in part by a third party computing device. For example, the rules generated by a user at the network devices can include a rule that causes motion sensor “MS1” to turn light “L1” on when motion is sensed (i.e., “On/Off Rule 1”), if light “L1” is on, then turn light “L2” on (i.e., “On/Off Rule 2”), if light “L1” is off, then turn light “L2” off (i.e., “On/Off Rule 4”), and if light “L2” is off, then turn light “L1” on (i.e., “On/Off Rule 5”). In contrast to FIGS. 24-29, On/Off Rule 3 may not be stored with the local area network including the network devices. Instead, the user may utilize a third party computing device to implement an equivalent rule. For example, the user may communicate with the third party computing device 3110 (e.g., via access device 108 such as a mobile device) to generate a rule indicating that if light “L2” is on, then light “L1” is turned off (i.e., “Third Party Rule 1”). When motion is sensed, an instruction from the third party computing device 3110 in combination with the other existing rules may be associated with a recursive operation as illustrated in FIG. 32 and described above.

An indication 3200 may be provided by a computing device after identifying the recursive operation. For example, the computing device may be a cloud-based device that receives the existing rule and/or instruction from the third party computing device 3110. The cloud-based device can perform the analysis, determine that a recursive operation exists, and transmit the indication of the recursive operation to an access device 108 (e.g., a mobile device). The indication of the recursive operation may be transmitted as a message, such as a text message or Short Message Service (SMS), email message, audible message, or other suitable message format. In some embodiments, the computing device can be an access device that analyzes the existing rules and the instructions from the third party computing device 3110, identifies the recursive operation, and provides (e.g., displays) the indication 3200 of the recursive operation.

The indication 3200 of the recursive operation may be displayed on an interface of a computing device (e.g., the access device 108). The indication can include content related to the recursive operation that involves one or more rules executed at least in part by the third party computing device 3110. As illustrated, the indication 3200 includes “A recursive operation is created by your existing rules ‘On/Off Rules 1, 2, 4, and 5’ and from an instruction from a third party, ‘Third Party Rule 1.’ In the aggregate, these instructions will toggle Light L1 and Light L2 on and off when motion is detected by Motion Sensor MS1, as shown below.” The indication 3200 can also include one or more illustrations or animations of the recursive operation to help illustrate the recursive operation for the user.

The indication 3200 can accept input that causes a rule to be modified or removed, and may also provide recommendations (e.g., based on historical interaction or interaction of other users of other network devices). For example, the user may respond to the message by selecting “remove or modify rules.” When “remove or modify rules” is selected, a second interface may be provided to a user that allows the user to modify or remove rules assigned to network devices in the local area network. In some examples, the interface may also direct the user to the third party computing device 3110 (e.g., through an application programming interface (API), etc.) to allow rules stored external to the local area network to be removed or modified.

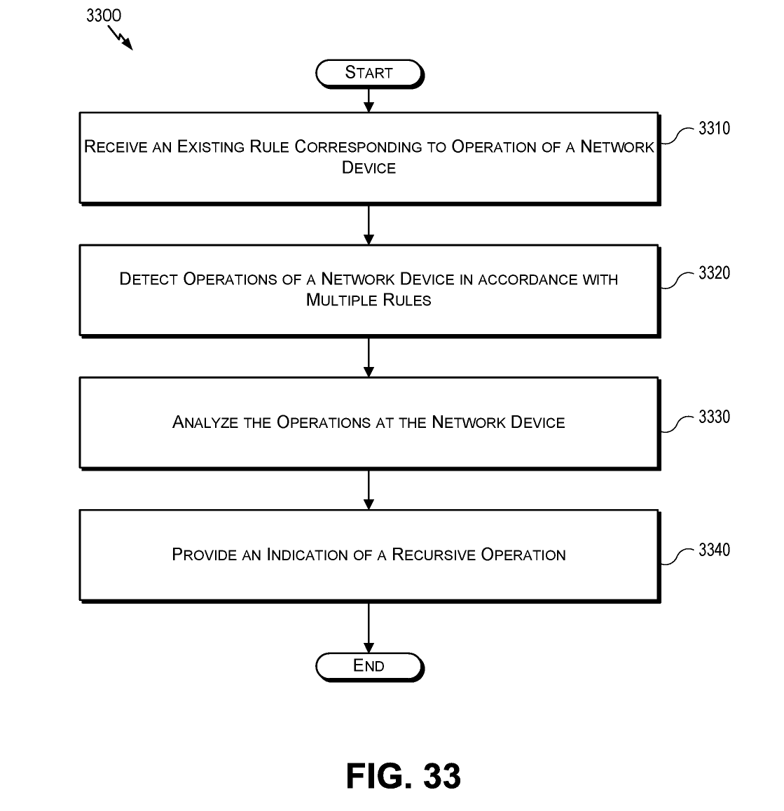

FIG. 33 is a flowchart illustrating a process for identifying and resolving recursive operations with a network device, in accordance with some embodiments. Specifically, the process 3300 provides a technique to identify that the operations of a network device include a recursive operation. The technique can be implemented by a computing device which may be a network device, a user device, or a cloud-based device.

Process 3300 is illustrated as a logical flow diagram, the operation of which represents operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, applications, objects, components, data structures, and the like that perform particular functions or implement particular data types. The order in which the operations are described is not intended to be construed as a limitation, and any number of the described operations can be combined in any order and/or in parallel to implement the processes.

Additionally, the process 3300 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium may be non-transitory.

At 3310, the process 3300 can include receiving multiple rules corresponding to operation of a network device. In some embodiments, the multiple rules can be received by a computing device or other network device. Exemplary network devices include, but are not limited to, an interior network devices (e.g., light switch, outlet, motion sensor, fan, garage door opener, sprinklers, heater, television, etc.), exterior motion sensors, exterior lighting (e.g., porch lights, walkway lights, security lights, etc.), garage door openers, sprinkler systems, and other network devices usable in a user's home, office, business or other location.

At 3320, the process 3300 can include detecting operations of the network device in accordance with the multiple rules. For example, the operations of the network device may cause the network device to change a status or state of the network device (e.g., on/off). In some embodiments, a data store (e.g., located at the network device, cloud network, etc.) can store a status of the network device. The computing device can also determine operations of devices on the network by accessing a local cache that can contain information it has previously received about devices known to exist on the network. The computing device can determine a status or state of the devices based on its local cache, information received from the cloud, or by direct communication with the devices within the local network.

At 3330, the process 3300 can include analyzing the operations at the network device. In some embodiments, the analysis may include identifying that the operations of the network device include a recursive operation. A recursive operation may include an operation of a network device where the operation repeats itself (e.g., in more than a threshold number of instances, within a threshold period of time, etc.). For example, a network device may toggle on and off in succession, causing a recursive operation. In another example, a first existing rule may turn on a light in the local area network, and execution of the first rule may trigger a second existing rule that may turn off the same light. Execution of the second rule may then trigger a third existing rule that causes the light to turn back on. When the first existing rule is activated, the light may be toggled on and off in succession, causing a recursive operation.

In some embodiments, the analysis may identify a tracer identifier corresponding to the operation of the network device. For example, the tracer identifier corresponding to an operation of the network device may be transmitted to a third party computing device, and the same tracer identifier can be returned along with instructions to change a state of the network device. As described above, a tracer identifier can be utilized in the context of rules that are executed at least in part by a third party computing device external to the local area network including the network device. The tracer identifier may relate to such a rule (e.g., “Third Party Rule 1”). Thus, in some embodiments, the recursive operation can include receiving the tracer identifier from the third party computing device after transmitting the tracer identifier to the third party computing device.

In some embodiments, the tracer identifier is globally unique. For example, once a network device initiates a change of state or other operation (e.g., if motion sensed by motion sensor “MS1” causes light “L1” on), a unique tracer identifier associated with the change of state can be transmitted to the third party computing device. In some embodiments, a cloud network (e.g., a cloud-based device in communication with the local area network) may generate the unique tracer identifier when a communication is transmitted to a third party computing device. Tracer identifiers can also be generated and transmitted by the network device or any other suitable computing device in (or associated with) the local area network. When the third party computing device returns a communication with the same unique tracer identifier, the cloud network may identify that the received communication is in response to the sent communication (e.g., which may identify an existing rule corresponding to operations of an in-network computing device).

In some embodiments, analyzing the operations of the network device includes analyzing operations of the network device in real time. For example, the recursive operation may be identified by a light toggling on and off. In another example, the recursive operation may be identified by detecting that the same operation has been performed a threshold number of times. For example, in some embodiments, identifying that the operation of the network device includes the recursive operation includes determining that a number of recursive operations exceeds a counter threshold. The counter may increment by one (or other suitable number) each time a change of state or other operation of the network device is detected. When the counter meets or exceeds the counter threshold, the recursive operation of the network device may be identified.

In some embodiments, the counter threshold is exceeded in a predetermined interval of time. For example, the predetermined interval of time may be 10 seconds (or 5 seconds, or some other interval of time before the operation of the network device is detected). The counter may increment by one each time an operation of the network device is detected. When the counter meets or exceeds counter threshold in a predetermined interval of time, the recursive operation of the network device may be identified. In some examples, the counter may be reset periodically (e.g., every 10 seconds, etc.) in accordance with the predetermined interval of time.

In some embodiments, the counter value decreases. For example, the counter value may start at 10 (or 5 or other pre-determined value). The counter may decrement by one each time an operation of the network device is detected. When the counter reaches zero (or some other predetermined value), the recursive operation of the network device may be identified.

At 3340, the process 3300 can include providing an indication of the recursive operation. For example, providing an indication of the recursive operation can include notifying the network device that the network device is associated with a recursive operation (e.g., so that the network device can stop operating in the recursive operation). In another example, providing the indication of the recursive operation can include notifying other network devices that a particular network device is involved with a recursive operation (e.g., so that the other network devices stop instructing the particular network device to perform the recursive operation).

In some embodiments, providing an indication of the recursive operation can include displaying the indication of the recursive operation. For example, an indication of the recursive operation can be displayed (e.g., on an access device such as a mobile device) to inform the user that a recursive operation is occurring (e.g., in real time or near real time). In some embodiments, the indication of the recursive operation can include an option to stop an operation of the network device to prevent the recursive operation and/or contact a third party computing device to stop providing instructions that cause the recursive operation.

In some embodiments, recommendations can be provided to prevent the recursive operation of the network device from being executed. For example, providing the indication of the recursive operation can include providing a recommendation corresponding to removal or modification of the rule (e.g., existing rule stored at the network, rule associated with a third party computing device, etc.) to prevent the recursive operation. In some embodiments, providing an indication of the recursive operation can initiate an automatic operation performed by the network device. Thus, in such embodiments, providing the indication of the recursive operation can include providing an indication that a rule has been automatically removed or modified to prevent the recursive operation.

In some embodiments, one or more actions (e.g., detections, transmissions of indications, changing/modifying/canceling rules, etc.) may be performed after the indication of the recursive operation is provided. Such actions may include input provided by the user to remove or modify a rule to prevent the recursive operation from being executed. For example, input can be received corresponding to removal or modification of the existing rule. When input corresponding to removal or modification is received, the removal or modification of the existing rule can be transmitted. In some embodiments, the removal or modification can be transmitted to the network device, a cloud-based device, third party computing device, or any other suitable computing device. Transmitted rule removals and modifications can be stored by the network device and/or other suitable devices in the local area network (e.g., including an associated cloud network), and may prevent future executions of the recursive operation of the network device.

In embodiments, some operations of the network devices may result in the generation of a notification, such as to alert a user to an operation, an action, or an event or condition surrounding the network device.

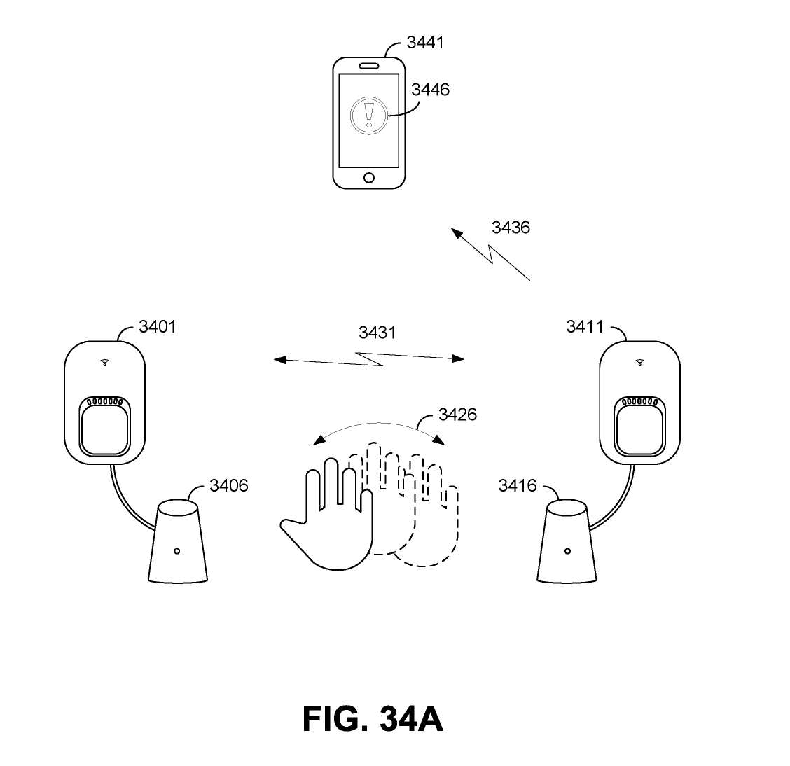

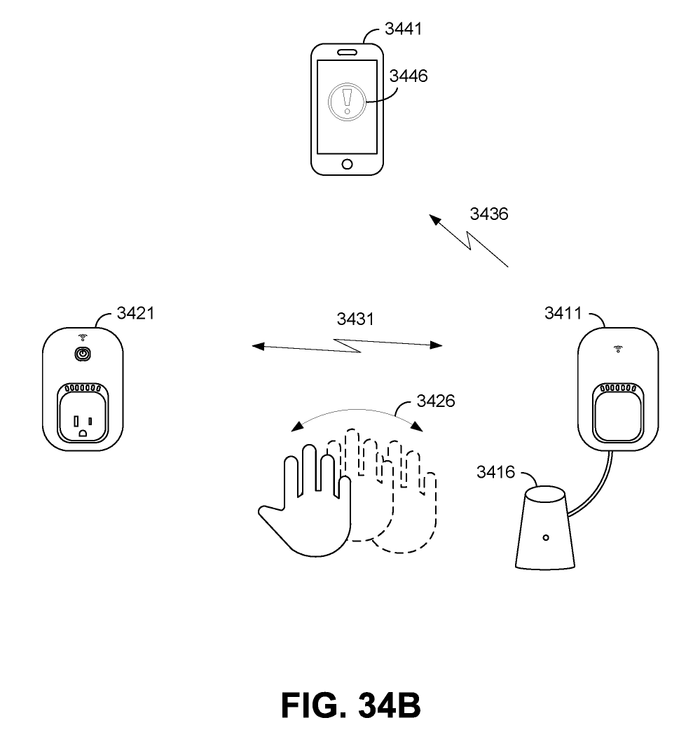

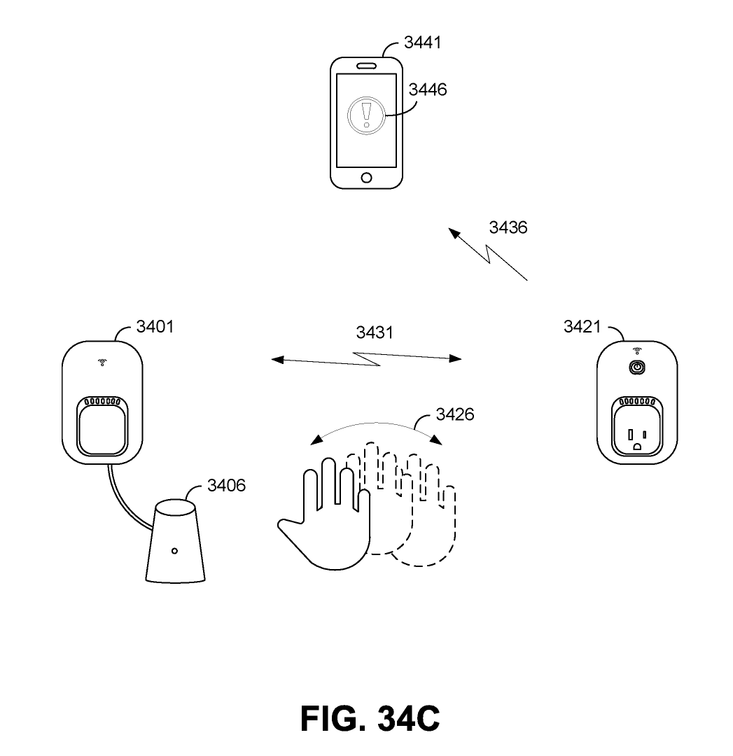

FIGS. 34A-34C provide schematic illustrations of detection of an event and generation of a notification. In FIGS. 34A-34C, network device 3401 is positioned in data communication with motion sensor 3406 and network device 3411 is positioned in data communication with motion sensor 3416, while network device 3421 is not directly in data communication with a motion sensor.

In FIG. 34A, both motion sensor 3406 and motion sensor 3416 detect motion 3426, here depicted as a hand waving. Network device 3401 and network device 3411 are shown in wireless communication with one another by wireless connection 3431. Other network configurations are contemplated, including wired networking, mixed wired/wireless networking, mesh networking, and/or communications relayed by an intermediate device, base station, access point, gateway, switch, hub, router or the like. Upon detection of the motion 3426, motion sensor 3406 sends a signal indicating detection of the motion 3426 to network device 3401. Similarly, upon detection of the motion 3426, motion sensor 3416 sends a signal indicating detection of the motion 3426 to network device 3411. These signals are optionally in the form of raw or processed sensor data. For certain embodiments, each of network device 3401 and network device 3411 are configured to transmit a notification of the detection of motion 3426, resulting in duplicate notifications.

For the embodiment shown in FIG. 34A, however, network device 3401 and network device 3411 transmit signals to one another indicating to the other device that motion has been detected. Network device 3401 and network device 3411 negotiate with one another over wireless connection 3431 such that only one of the network devices transmits the notification of the detection of motion 3426, so as not to generate duplicative notifications. In some embodiments, the notification is transmitted on the network to which network device 3401 and network device 3411 are connected. In other embodiments, the notification is transmitted to another network, such as a cloud network or a cellular network. In the embodiment shown, network device 3411 is selected for transmitting the notification, such as by wireless transmission 3436. Other transmission schemes are contemplated, including wired transmission and mixed wired/wireless transmission. Upon receipt of the notification by access device 3441, the access device 3441 generates a display of the notification, here depicted as an informational notification 3446.

In embodiments, various device metrics and other factors are used in the negotiation between network device 3401 and network device 3411 for determining which network device is selected for transmitting the notification. For example, network attributes of each network device, such as network speed, network strength, etc., are optionally compared to determine which network device to select for transmission of the notification. As another example, sensor attributes of each sensor that detected motion 3426 are optionally compared, such as a strength of the signal indicating motion 3426, a confidence in the signal indicating motion 3426, a time for detection of motion 3426, etc., to determine which network device to select for transmission of the notification.

Useful device metrics for comparison in determining which network device to select for transmitting a notification of an event include, but are not limited, to a wireless network signal strength, a processor load, a device uptime, a time and date stamp for sensing or detection of the event, a confidence level for the event, a power state, a battery state, a network connection speed, a network connection type, available network connection bandwidth, a number of network connections, a random number, a sensor signal level, a sensor noise level, a sensor type, a notification type, a susceptibility to an event, a reach level, a device reach level, a notification reach level, a user defined variable, a device identifier, a device location and any combination of these. In a simple embodiment, when two devices detect an event, the first device that detects the event (i.e., the device having the earliest detection timestamp) is selected for transmission of a notification of the event. In another embodiment, when two devices detect an event, each device generates a random number and the device that has the larger random number is selected for transmission of a notification of the event.

FIG. 34B illustrates an embodiment where only one device detects an event. Here network device 3411 receives a signal from motion sensor 3416 indicating detection of motion 3426. Similar to the embodiment shown in FIG. 34A, in this embodiment, network device 3411 negotiates with other devices on its local network that are capable of sending out a notification of the event, such as by communicating over wireless connection 3431 with network device 3421. In this case, network device 3411 is selected for transmitting a notification of detection of motion 3426. For example, network device transmits the notification, such as by wireless transmission 3436. Upon receipt of the notification by access device 3441, the access device 3441 generates a display of the notification, again depicted as an informational notification 3446. In some embodiments, the notification is received by another device on the network, such as network device 3421.

FIG. 34C illustrates another embodiment where only one device detects an event. Here network device 3401 receives a signal from motion sensor 3406 indicating detection of motion 3426. Similar to the embodiments shown in FIGS. 34A and 34B, in this embodiment, network device 3401 negotiates with other devices on its local network that are capable of sending out a notification of the event, such as by communicating over wireless connection 3431 with network device 3421. In this case, although network device 3421 did not detect motion 3426 or receive a signal directly from a sensor, network device 3421 is selected for transmitting a notification of detection of motion 3426. Here, network device 3421 receives a signal from network device 3401 indicating that motion 3426 was detected. Optionally, network device 3421 acknowledges the signal from network device 3401 indicating that motion 3426 was detected. In one embodiment, network device 3401 generates a notification of detection of motion 3426 by motion sensor 3406 and transmits the notification to network device 3421 over wireless connection 3431, such that network device 3421 can transmit the notification further, such as to access device 3441 by wireless transmission 3436. Upon receipt of the notification by access device 3441, the access device 3441 generates a display of the notification, again depicted as an informational notification 3446.

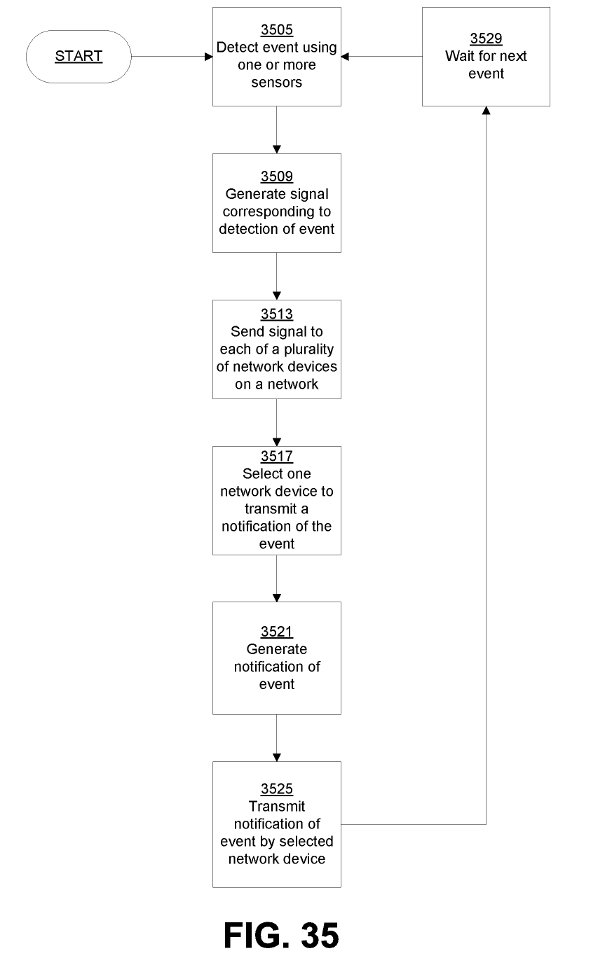

FIG. 35 provides a flow diagram giving an overview of a method for transmitting a notification of an event. Initially, the event is detected using one or more sensors at block 3505. A signal is generated corresponding to or indicating detection of the event at block 3509. The detection signal is sent to each of a plurality of network devices on a network at block 3513, such as to allow the plurality of network devices to exchange device metrics and determine which network device is selected for transmitting a notification of the event at block 3517. The notification of the event is generated at block 3521 and transmitted by the selected network device at block 3525, for example to an access device. Upon detection of the next event, at block 3529, the process is repeated.

In certain embodiments, the transmitted notification is not received. In these embodiments, it is desirable to retransmit the notification of the event. For certain embodiments, the device that transmits the notification of the event awaits confirmation of delivery of the notification. Upon receipt of such a confirmation, this information is, optionally, communicated to other devices on the network, such that sending of the notification is not repeated by the originally transmitting device or any other device.

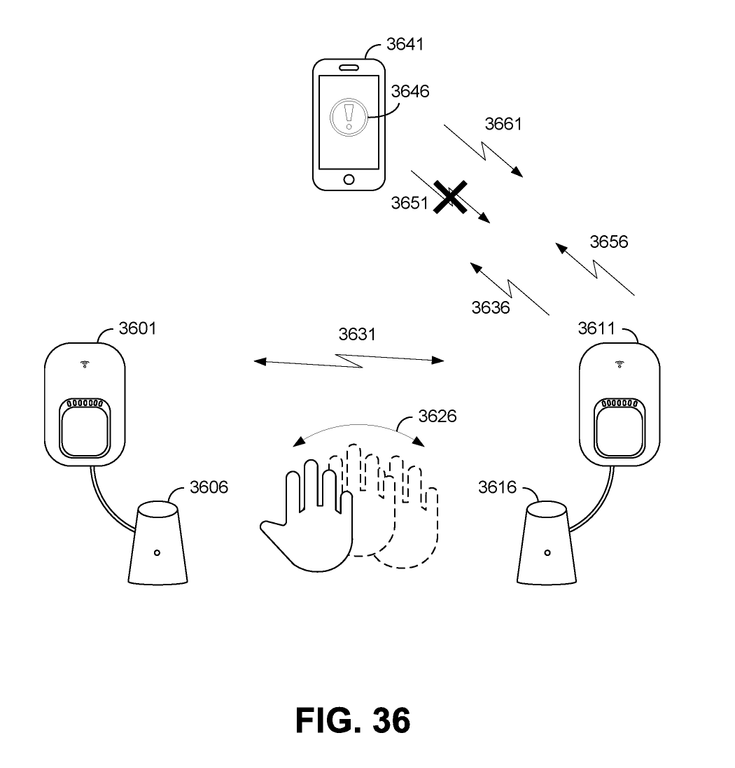

FIG. 36 provides an illustration depicting a retransmission of a notification of an event. Similar to FIG. 34A, in FIG. 36, network device 3601 is positioned in data communication with motion sensor 3606 and network device 3611 is positioned in data communication with motion sensor 3616. Here, both motion sensor 3606 and motion sensor 3616 detect motion 3626. Network device 3601 and network device 3611 are shown in wireless communication with one another by wireless connection 3631. Upon detection of the motion 3626, motion sensor 3606 sends a signal indicating detection of the motion 3626 to network device 3601, while upon detection of the motion 3626, motion sensor 3616 sends a signal indicating detection of the motion 3626 to network device 3611. Network device 3601 and network device 3611 may exchange information over network connection 3631 regarding the detection of motion 3626 and device metrics and other information needed to determine which device to select for transmitting a notification of motion 3626. Here, network device 3611 is selected for transmitting the notification of motion 3626 over wireless signal 3636. In the embodiment shown, communication 3651 is not received, which indicates that successful delivery of the notification of motion 3626 did not occur and/or was not acknowledged. Upon determining that the notification was not received or acknowledged, network device 3611 retransmits the notification via wireless transmission 3656. Upon receipt of the notification, access device 3641 transmits a signal 3661 indicating receipt of the notification. Optionally, access device 3641 then generates a display of the notification, here depicted as an informational notification 3646.

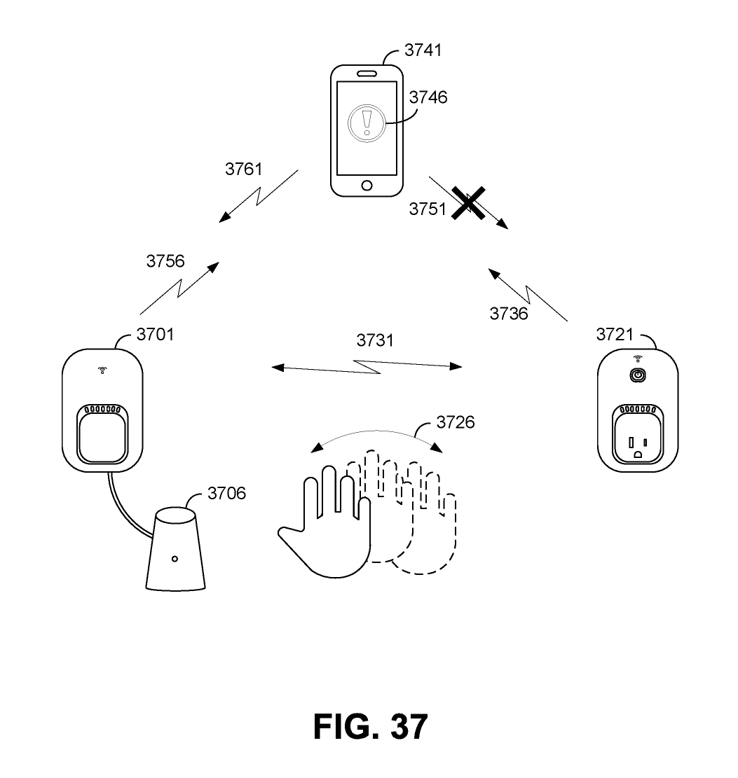

FIG. 37 similarly provides an illustration depicting a retransmission of a notification of an event. Here, network device 3701 is positioned in data communication with motion sensor 3706. Network device 3701 and network device 3721 are shown in wireless communication with one another by wireless connection 3731. Upon detection of the motion 3726, motion sensor 3706 sends a signal indicating detection of the motion 3726 to network device 3701. Network device 3701 then transmits a communication relating to the detection of motion 3726 over network connection 3731 to network device 3721. Other information is optionally exchanged, such as device metrics and other information needed to determine which device to select for transmitting a notification of motion 3726. Here, network device 3721 is selected for transmitting the notification of motion 3726 over wireless signal 3736. In the embodiment shown, communication 3751 is not received, which indicates that successful delivery of the notification of motion 3726 did not occur and/or was not acknowledged. Upon determining that the notification was not received or acknowledged, network device 3721 optionally relay this information over wireless connection 3731 to network device 3701. A second exchange of information, such as device metrics, optionally occurs to determine which device to select for retransmitting the notification. As shown in FIG. 37, network device 3701 is selected for retransmitting the notification via wireless transmission 3756. Upon receipt of the notification, access device 3741 transmits a signal 3761 indicating receipt of the notification. Optionally, access device 3741 then generates a display of the notification, here depicted as an informational notification 3746.

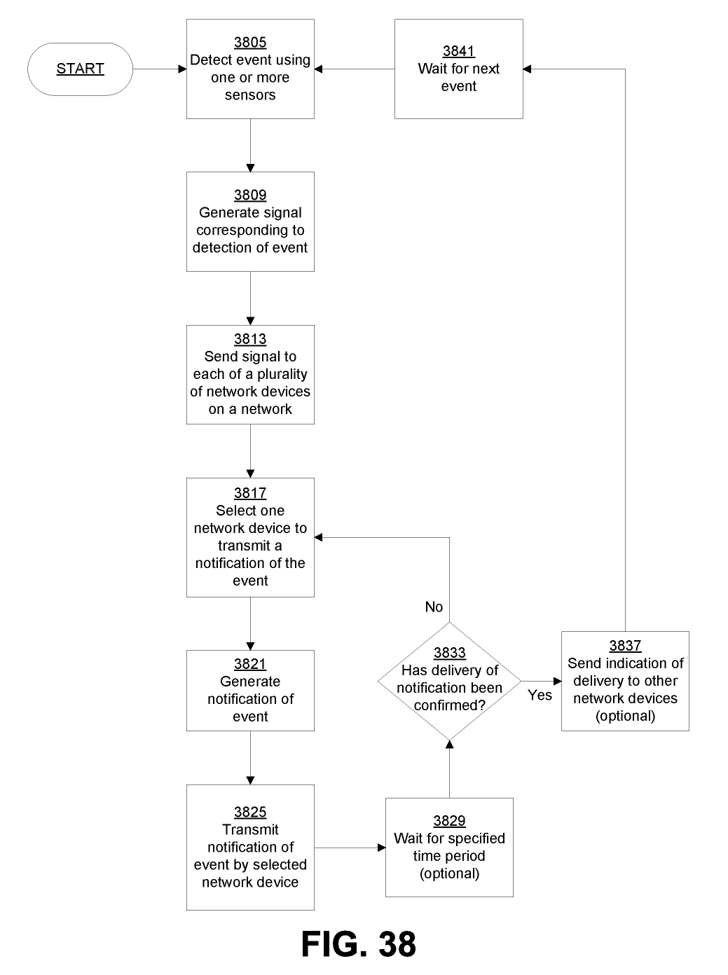

FIG. 38 provides an overview of a method, in accordance with some embodiments, for retransmitting a notification until confirmation of delivery of the notification is received. First, an event is detected using one or more sensors at block 3805. A signal corresponding to detection of the event is generated at block 3809 and sent to a plurality of network devices on a network at block 3813. Upon receiving the signal indicating detection of the event, the network devices optionally exchange information with one another to determine which device is selected for transmitting a notification of the event, such as to an access device off the network at block 3817. The notification of the event is generated at block 3821 and transmitted by the selected network device at block 3825. After transmission is complete, an optional waiting period is allowed to expire at block 3829, such as to allow time for delivery and receipt of a confirmation of the notification. If delivery of the notification is confirmed at block 3833, such as by receiving a signal indicating successful delivery, this indication is optionally forwarded to the other network devices on the network at block 3837, such as to inform the other network devices of the successful delivery and, therefore, lack of a need to retransmit the notification. The process is repeated upon the next detection of an event at block 3841. If it is determined that the notification has not been successfully delivered, such as by receiving no signal confirming delivery of the notification or by receiving a signal indicating that delivery of the notification was unsuccessful, the notification is retransmitted. For example, a new selection occurs for choosing which network device to retransmit the notification of the event at block 3817, and the same or a different network device can be selected.

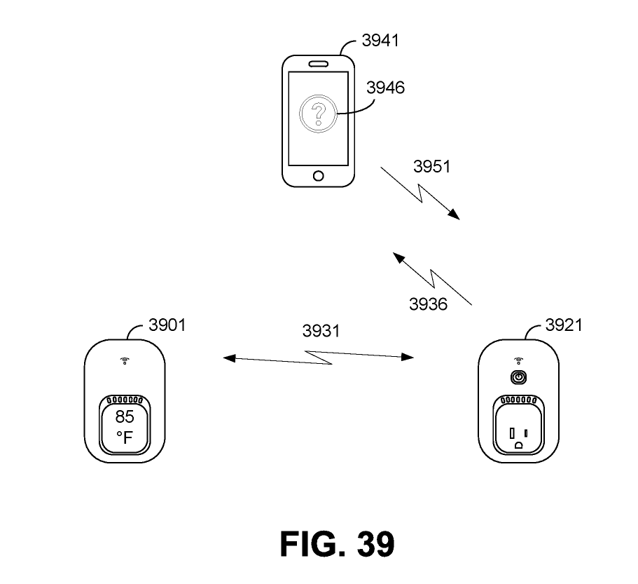

FIG. 39 provides an illustration depicting detection of a different event with transmission of a notification that generates a query. In this embodiment, network device 3901 includes a temperature sensor. Upon detection of a change in temperature, such as an increase in temperature above a threshold temperature or a decrease in temperature below a threshold temperature, network device 3901 generates a signal indicating the detection of the temperature change. This signal is transmitted to network device 3921 over wireless connection 3931. Network device 3921 optionally acknowledges the signal indicating detection of the temperature change, such as by transmitting an acknowledgment signal back to network device 3901 over wireless connection 3931. Additional information is optionally exchanged between network device 3901 and network device 3921, such as device metrics and other information which can facilitate the selection of one network device for transmitting a notification of the temperature change. Here, network device 3921 is selected for transmitting the notification of the temperature change, such as by wireless transmission 3936. In the embodiment shown, the notification may be of a type that generates a query 3946 upon receipt by access device 3941. For example the query 3946 could request input from a user to authorize a change to the HVAC system, such as to turn on or off a heater or air conditioner. Optionally, the query requests an acknowledgment of the notification, such as to confirm the notification has been viewed by a user.

In embodiments, various acknowledgments of a notification are contemplated. For example, in one embodiment, an acknowledgment includes dismissal of a notification, such as by providing input to an access device. In another embodiment, an acknowledgment includes displaying a notification. In another embodiment, an acknowledgment of a notification can be generated upon detection that a user viewed a display of the notification, such as by monitoring facial features detected by a video capture device to determine that a user has looked at a display on an access device.

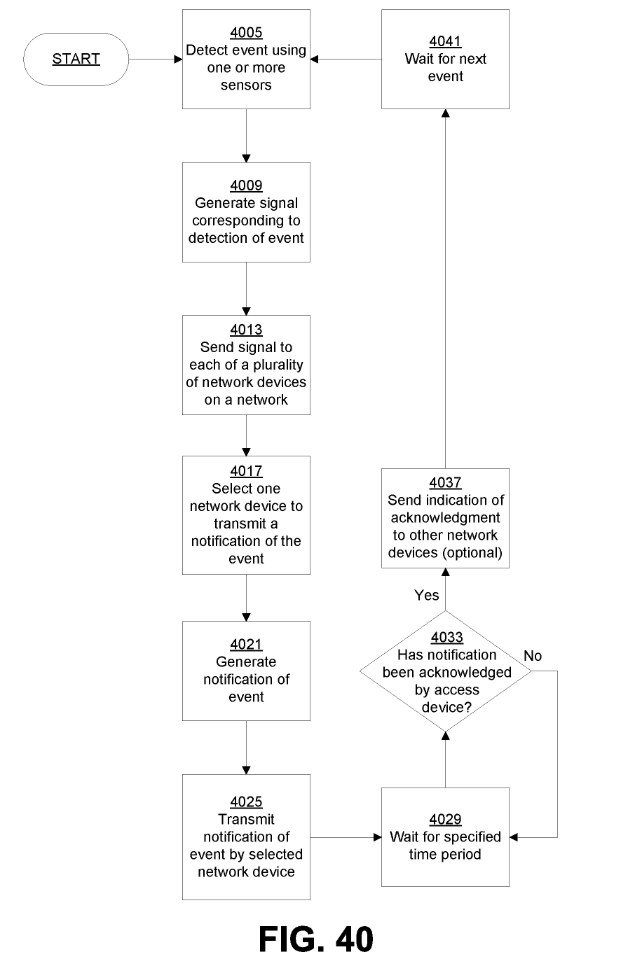

FIG. 40 provides an overview of a method embodiment where a notification requires acknowledgment. Initially, an event is detected using one or more sensors at block 4005. A signal corresponding to detection of the event is generated at block 4009 and sent to one or more network devices on a network at block 4013. Upon receiving the signal indicating detection of the event, the network devices optionally exchange information with one another to determine which device is selected for transmitting a notification of the event at block 4017, such as to an access device off the network. The notification of the event is generated at block 4021 and transmitted by the selected network device at block 4025. After transmission is complete, an optional waiting period is allowed to expire at block 4029, such as to allow time for delivery and acknowledgment of the notification. If acknowledgment of the notification is confirmed at block 4033, such as by receiving a signal indicating the notification has been displayed and/or viewed, this indication is optionally forwarded to the other network devices on the network at block 4037. The process is repeated upon the next detection of an event at block 4041. If it is determined that the notification has not been acknowledged at block 4033, such as by receiving no signal acknowledging the notification or by receiving a signal indicating that the notification has not yet been acknowledged, waiting period is allowed to pass again at block 4029, until it is determined that the notification is acknowledged.

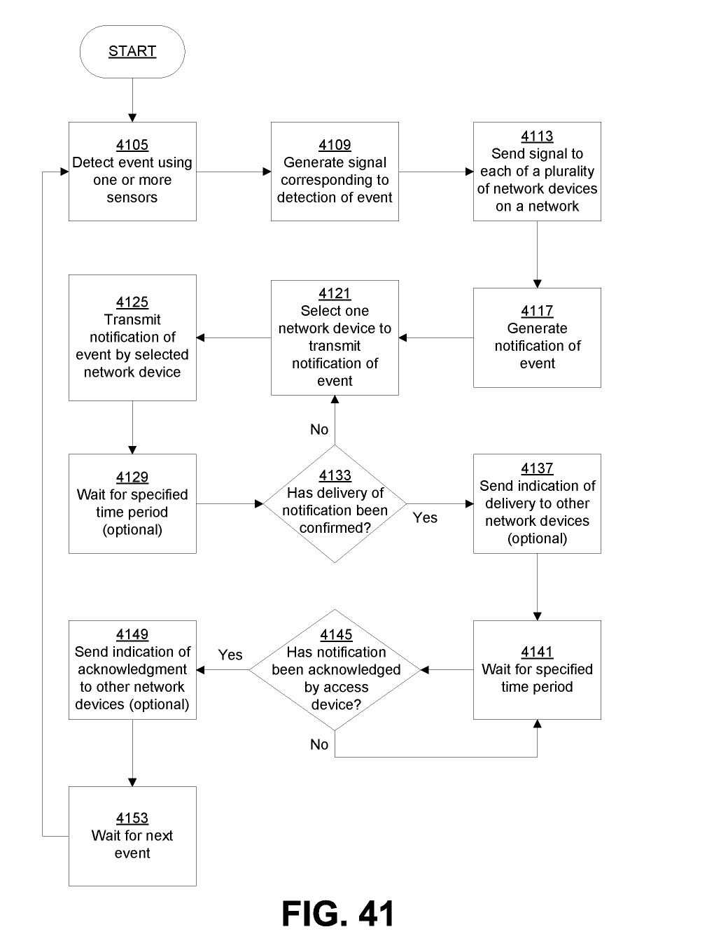

FIG. 41 provides an overview of a method embodiment where a notification is retransmitted until delivery of the notification is confirmed, where the notification requires acknowledgment. First, an event is detected using one or more sensors at block 4105. A signal corresponding to detection of the event is generated at block 4109 and sent to a plurality of network devices on a network at block 4113. In some embodiments, the signal is optionally generated within one network device and sent to only a single other network device on the network. Upon receiving the signal indicating detection of the event, the notification of the event is generated at block 4117. If necessary, the network devices exchange information with one another, and one network device is selected to transmit the notification of the event at block 4121, such as to cloud 114 and/or an access device off the network. The notification is then transmitted by the selected network device at block 4125. After transmission is complete, an optional waiting period is allowed to expire at block 4129, such as to allow time for delivery and receipt of a confirmation of the notification. If delivery of the notification is confirmed at block 4133, such as by receiving a signal indicating successful delivery, this indication is optionally forwarded to the other network devices on the network at block 4137, such as to inform the other network devices of the successful delivery and, therefore, lack of a need to retransmit the notification. If delivery of the notification is not confirmed, such as by receiving no confirmation of delivery or receiving a signal indicating the notification was not delivered, the notification is optionally retransmitted, such as by selecting a new network device to transmit notification of the event at block 4121 and retransmitting the notification of the event by the newly selected network device at block 4125. In this embodiment, the notification requires acknowledgment, so a waiting period is allowed to expire at block 4141, such as to allow time for acknowledgment of the notification. If acknowledgment of the notification is confirmed at block 4145, such as by receiving a signal indicating the notification has been displayed and/or viewed, this indication is optionally forwarded to the other network devices on the network at block 4149. The process is repeated upon the next detection of an event at block 4153. If it is determined that the notification has not been acknowledged at block 4145, such as by receiving no signal acknowledging the notification or by receiving a signal indicating that the notification has not yet been acknowledged, the waiting period is allowed to pass again at block 4141, until it is determined that the notification is acknowledged.

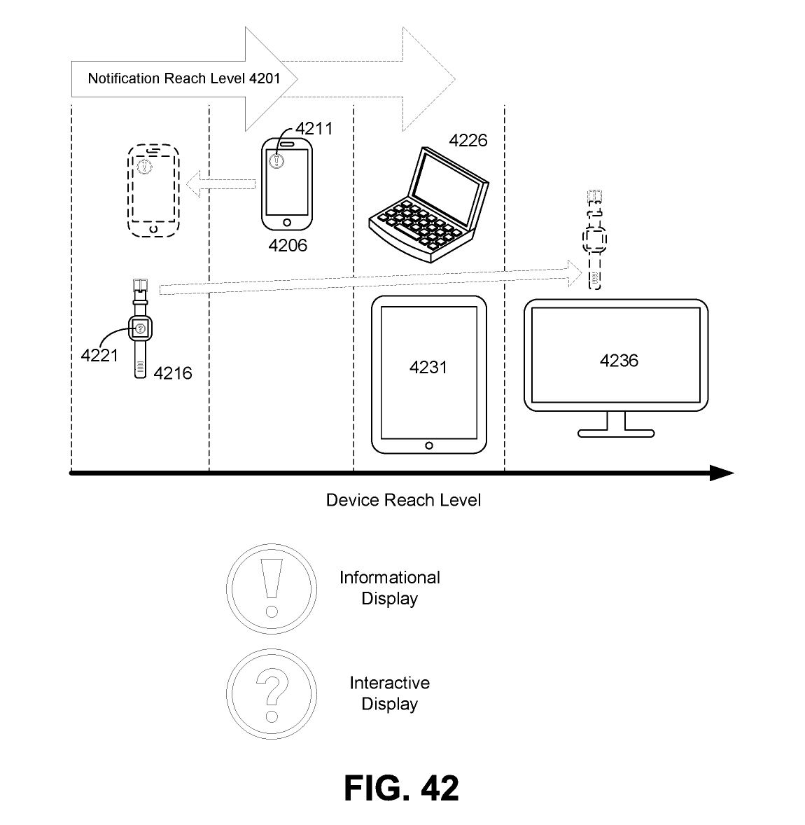

Various constraints are optionally placed on delivery and display of a notification. In one embodiment, the notification is assigned a notification reach level and access devices on which the notification is optionally displayed are each assigned a device reach level. FIG. 42 shows a schematic plot providing an overview of a reach level constraint on an event notification. This configuration allows notifications to be received by various access devices, but not necessarily displayed, such as if a user or rule indicates that such a display should not be generated. For example, in embodiments, a user may indicate that all notifications received should be displayed by an access device, such as a smart phone or a smart watch. In other embodiments, a user may indicate that some access devices should never or almost never display a received notification, such as television.

In the embodiment depicted in FIG. 42, the reach level 4201 of a notification is indicated in the figure by an arrow. For example, this reach level configuration generates a display of the notification by all devices having a device reach level equivalent to or less than the notification reach level. Other configurations are contemplated, including displaying a notification by all devices having a device reach level less than the notification reach level, displaying a notification by all devices having a device level greater than or equivalent to the notification reach level, displaying a notification by all devices having a reach level greater than the notification reach level, displaying a notification by all devices having device reach level equivalent to the notification reach level or displaying a notification by all devices having a device reach level within a specified range of the notification reach level. As depicted in FIG. 42, the notification reach level 4201 is initially at the second lowest reach level. Smartphone 4206 initially has a device reach level equivalent to the notification reach level 4201, such that smartphone 4206 displays an informational display 4211 of the notification. Smart watch 4216 initially has a device reach level below the notification reach level 4201, so it also generates a display 4221 of the notification, such as an interactive display of the notification. Laptop 4226, tablet 4231 and television 4236 all have device reach levels above the notification reach level, so they do not generate a display of the notification.

Optionally, device reach levels are permitted to change, such as by a defined schedule or by a location determination or some other triggering event. In FIG. 42, the reach level of smartphone 4206 changes to a lower device reach level, such as when it is determined that smartphone 4206 connects to a home wireless network or has GPS coordinates within a specified range of a location, such as a user's home. In another embodiment depicted in FIG. 42, the reach level of smart watch 4216 changes to the highest device reach level, such as may occur according to a schedule, such as to minimize the notifications displayed by smart watch 4216 between certain times.

Optionally, notification reach levels are permitted to change. For example, in one embodiment a notification reach level is changed if no access device has a device reach level within a specified range of the notification reach level. In another embodiment, a notification reach level changes if the notification is not displayed or acknowledged by an access device within a specified time period. Optionally, a notification reach level is changed upon the determination that a notification is more important or less important than the initial notification reach level would indicate, such that devices with a reach level that would not initially display the notification would generate a display of the notification upon the change to the notification reach level.

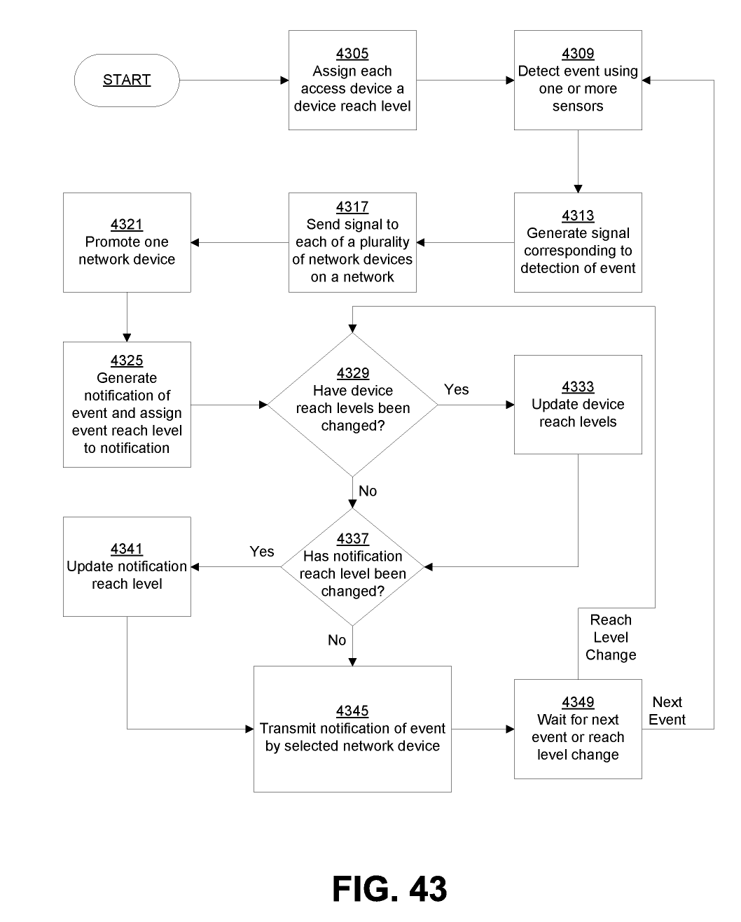

FIG. 43 provides an overview of a method embodiment in which reach levels are used to determine which devices should generate a display of a notification of an event. Initially, each of one or more access devices is assigned a device reach level at block 4305. An event is detected using one or more sensors at block 4309, generating a signal corresponding to detection of the event at block 4313. The signal is then sent to each of a plurality of network devices on a network at block 4317. One of the network devices is selected for transmitting a notification of the event at block 4321. The notification of the event is then generated and assigned an event reach level at block 4325. If any device reach level has been changed at block 4329, the device reach levels are updated at block 4333. If the event reach level has been changed at block 4341, it is updated. The notification is then transmitted by the selected network device at block 4345. In one embodiment, upon receipt by a device having a device reach level within a specified range of the notification reach level, a display of the notification is generated. In one embodiment, the notification is only transmitted to access devices having a device reach level within a specified range of the notification reach level. As with the previously described embodiments, certain notifications can require an acknowledgment or delivery confirmation, and associated steps are optionally added to the method depicted in FIG. 43 to accommodate this. If the notification reach level or a device reach level is changed after transmitting the notification, the notification is optionally retransmitted at block 4349.

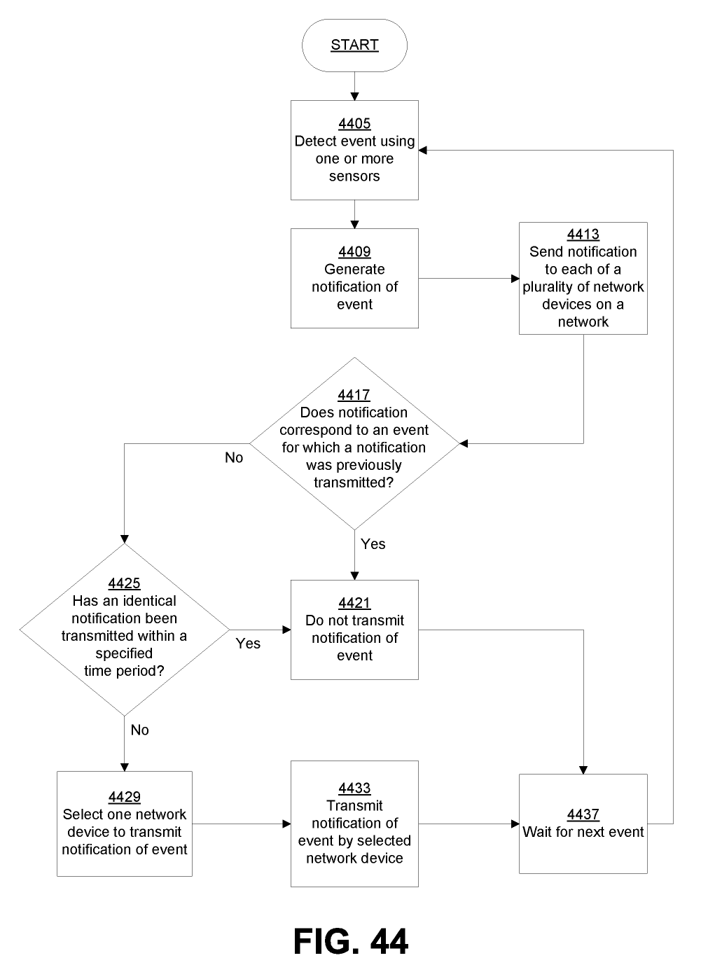

FIG. 44 provides an overview of a method embodiment for minimizing the repeating of transmitting, generating or displaying notifications. Initially, an event is detected using one or more sensors at block 4405. A notification of the event is generated at block 4409 and sent to each of a plurality of network devices on a network at block 4413. If the notification correspond to an event for which a notification was previously transmitted at block 4417, the notification is not transmitted again at block 4421. If the notification does not correspond to an event for which a notification was previously transmitted, it is not transmitted, at block 4421, if an identical notification was transmitted within a specified time period at block 4425. If the notification does not correspond to an event for which a notification was previously transmitted and an identical notification was not transmitted within a specified time period, one network device is selected to transmit the notification of the event at block 4429 and then the notification is transmitted by the selected network device at block 4433. The next event is awaited at block 4437 and the process is repeated.

These circumstances minimize the sending of repeated notifications that are identical or refer to the same event. For example, in one embodiment, two motion detectors can detect the same motion event and attempt to transmit two separate notifications and the method embodiment depicted in FIG. 44 could prevent the repeated transmission of notifications referring to the same event. In another embodiment, a motion detector could detect repeated motion, which may be separate events for which generation of repeated notifications may be redundant or undesirable. For these circumstances, the method embodiment depicted in FIG. 44 could prevent the transmission of redundant notifications.

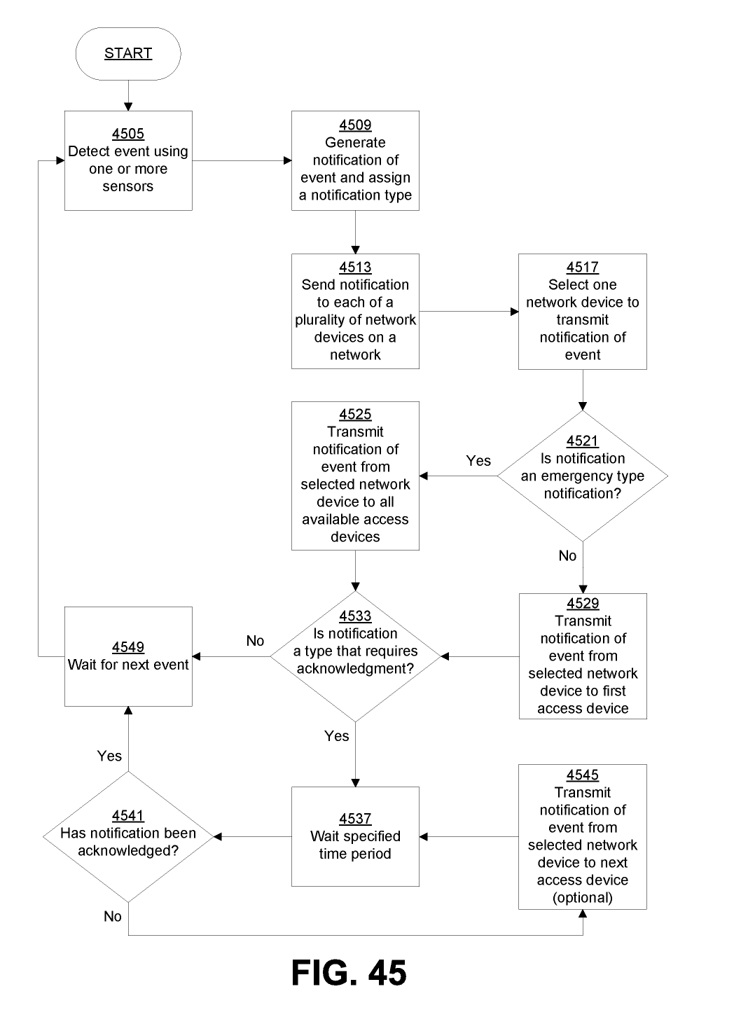

FIG. 45 provides an overview of a method embodiment where a notification type dictates a required response to the notification. Initially, an event is detected, such as by one or more sensors at block 4505. A notification of the event is generated and a notification type is assigned to the notification at block 4509. The notification is then sent to each of a plurality of network devices on a network at block 4513. One of the network devices is selected to transmit a notification of the event at block 4517. If the notification type indicates the notification is an emergency type notification, the notification is transmitted to all available access devices at block 4525. If the notification is not an emergency type notification, the notification is transmitted to the first access device slated to receive the notification at block 4529. If the notification is a type that requires acknowledgment, as determined at block 4533, a specified time period is, optionally, allowed to elapse at block 4537, such as to permit time for delivery of the notification, for generating a display of the notification and for generating and receiving an acknowledgement of the notification. If the notification is not a type that requires acknowledgment, as determined at block 4533, or if the notification has been acknowledged at block 4541, the method awaits the next event at block 4549. If the notification is not acknowledged by the end of the specified time period, the notification is optionally transmitted to the next access device slated for receiving the notification at block 4545. In this way, notifications can reach additional access devices if they are not acknowledged.

Substantial variations may be made in accordance with specific requirements. For example, customized hardware might also be used, and/or particular elements might be implemented in hardware, software (including portable software, such as applets, etc.), or both. Further, connection to other access or computing devices such as network input/output devices may be employed.

Substantial variations may be made in accordance with specific requirements. For example, particular elements might be implemented in hardware, software (including portable software, such as applets, etc.), or both. Further, connection to other access or computing devices such as network input/output devices may be employed.

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive.

In the foregoing description, for the purposes of illustration, method operations were described in a particular order. It should be appreciated that in alternate embodiments, the operations may be performed in a different order than that described. It should also be appreciated that the methods described above may be performed by hardware components or may be embodied in sequences of machine-executable instructions, which may be used to cause a machine, such as a special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

While illustrative embodiments of the application have been described in detail herein, it is to be understood that the inventive concepts may be otherwise variously embodied and employed, and that the appended claims are intended to be construed to include such variations, except as limited by the prior art.

1. A system, comprising:
one or more data processors; and
a non-transitory computer-readable storage medium containing instructions which when executed on the one or more data processors, cause the one or more processors to perform operations including:
receiving an existing rule corresponding to operation of a network device;
detecting input corresponding to a new rule corresponding to operation of the network device;
analyzing the existing rule and the new rule, wherein analyzing includes determining that a conflict exists between the existing rule and the new rule; and
providing an indication of the conflict between the existing rule and the new rule.

2. The system of claim 1, wherein the existing rule is received from the network device.

3. The system of claim 1, wherein providing the indication of the conflict includes displaying the indication of the conflict.

4. The system of claim 1, wherein the operations further include:
after providing the indication of the conflict, detecting input corresponding to a selection or modification of the existing rule or the new rule; and
transmitting the selection or modification to the network device.

5. The system of claim 1, wherein the operations further include:
transmitting the existing rule and the new rule to a cloud-based device, wherein when the existing rule and the new rule are received by a cloud-based device, the cloud-based device wherein the cloud-based device performs the analysis of the existing rule and the new rule and determines that the conflict exists.

6. The system of claim 1, wherein the conflict between the existing rule and the new rule corresponds to an interaction between the network device and another network device in a shared network.

7. A computer-program product tangibly embodied in a non-transitory machine-readable storage medium, including instructions configured to cause a data processing apparatus to:
receive an existing rule corresponding to operation of a network device;
detect input corresponding to a new rule corresponding to operation of the network device;
analyze the existing rule and the new rule, wherein analyzing includes determining that a conflict exists between the existing rule and the new rule; and
provide an indication of the conflict between the existing rule and the new rule.

8. The computer-program product of claim 7, wherein the instructions are further configured to cause the data processing apparatus to:
transmit the existing rule and the new rule to a cloud-based device, wherein when the existing rule and the new rule are received by a cloud-based device, the cloud-based device wherein the cloud-based device performs the analysis of the existing rule and the new rule and determines that the conflict exists.

9. The computer-program product of claim 7, wherein the conflict between the existing rule and new rule corresponds to a conflicting state of the network device.

10. The computer-program product of claim 7, wherein analyzing the existing rule and new rule includes analyzing rules corresponding to operation of other network devices in other networks.

11. The computer-program product of claim 7, wherein the computing device is a network device, a user device, or a cloud-based device.

12. A computer-implemented method, comprising:
receiving, by a computing device, an existing rule corresponding to operation of a network device;
detecting input corresponding to a new rule corresponding to operation of the network device;
analyzing the existing rule and the new rule, wherein analyzing includes determining that a conflict exists between the existing rule and the new rule; and
providing an indication of the conflict between the existing rule and the new rule.

13. The computer-implemented method of claim 12, wherein the existing rule is received from the network device.

14. The computer-implemented method of claim 12, wherein providing the indication of the conflict includes displaying the indication of the conflict.

15. The computer-implemented method of claim 12 further comprising:
after providing the indication of the conflict, detecting input corresponding to a selection or modification of the existing rule or the new rule; and
transmitting the selection or modification to the network device.

16. The computer-implemented method of claim 12 further comprising:
transmitting the existing rule and the new rule to a cloud-based device, wherein when the existing rule and the new rule are received by a cloud-based device, the cloud-based device wherein the cloud-based device performs the analysis of the existing rule and the new rule and determines that the conflict exists.

17. The computer-implemented method of claim 12, wherein the conflict between the existing rule and the new rule corresponds to an interaction between the network device and another network device in a shared network.

18. The computer-implemented method of claim 12, wherein the conflict between the existing rule and new rule corresponds to a conflicting state of the network device.

19. The computer-implemented method of claim 12, wherein analyzing the existing rule and new rule includes analyzing rules corresponding to operation of other network devices in other networks.

20. The computer-implemented method of claim 12, wherein the computing device is a network device, a user device, or a cloud-based device.

21.-135. (canceled)
